(19) United States
(12) Patent Application Publication
(10) Pub. No.: US 2019/0186747 A1
(43) Pub. Date: Jun. 20, 2019

(54) Jet engine with plasma-assisted afterburner having Ring of Resonators and Resonator with Fuel Conduit in Dielectric

(71) Applicant: Plasma Igniter, LLC, Bruceton Mills, WV (US)

(72) Inventors: Andrew D. Lowery, Morgantown, WV (US); James E. Smith, Bruceton Mills, WV (US)

(73) Assignee: Plasma Igniter, LLC, Bruceton Mills, WV (US)

(21) Appl. No.: 15/848,570

(22) Filed: Dec. 20, 2017

(51) Int. Cl. F23R 3/28; F02K 3/10; F02M 27/06; F02C 7/266; F02C 7/22; H05H 1/24; H05H 1/46; H01P 7/04; H01P 7/06

(52) U.S. Cl. CPC F23R 3/28; H05H 2001/4645; F02M 27/06; F02C 7/266; F02C 7/222; H05H 1/2406; H05H 1/46; H01P 7/04; H01P 7/06; F23R 2900/00009; F05D 2220/323; F05D 2260/99; H05H 2001/2412; H05H 2001/2431; F02K 3/10

(57) ABSTRACT

A system includes an afterburner including an afterburner duct that defines an afterburner channel. The afterburner receives input gas from a jet engine into the channel and outputs an exhaust gas resulting from combustion of fuel. The system includes multiple resonators electromagnetically coupled to at least one radio-frequency power source. Each resonator has a resonant wavelength, first and second conductors, and a dielectric between those conductors. Each resonator is configured such that, when that resonator is excited by the power source with a signal having a wavelength proximate to an odd-integer multiple of one-quarter of that resonator's resonant wavelength, that resonator provides within the afterburner electromagnetic waves and/or a plasma corona proximate to that resonator. A resonator also includes a fuel conduit having a fuel outlet configured to output fuel for mixing with the input gas, and at least a portion of that resonator is arranged proximate to the dielectric.

### CROSS-REFERENCE TO RELATED APPLICATIONS

The present application hereby incorporates by reference U.S. Pat. Nos. 5,361,737; 7,721,697; 8,783,220; 8,887,683; 9,551,315; 9,624,898; and 9,638,157. The present application also hereby incorporates by reference U.S. Patent Application Pub. Nos. 2009/0194051; 2011/0146607; 2011/0175691; 2014/0283780; 2014/0283781; 2014/0327357; 2015/0287574; 2017/0082083; 2017/0085060; 2017/0175697; and 2017/0175698. In addition, the present application hereby incorporates by reference International Patent Application Pub. Nos. WO 2011/112786; WO 2011/127298; WO 2015/157294; and WO 2015/176073. Further, the present application hereby incorporates by reference the following U.S. Patent Applications, each filed on the same date as the present application: “Plasma-Distributing Structure in a Resonator System” (identified by attorney docket number 17-1501); “Magnetic Direction of a Plasma Corona Provided Proximate to a Resonator” (identified by attorney docket number 17-1502); “Fuel Injection Using a Dielectric of a Resonator” (identified by attorney docket number 17-1505); “Jet Engine Including Resonator-based Diagnostics” (identified by attorney docket number 17-1506); “Power-generation Turbine Including Resonator-based Diagnostics” (identified by attorney docket number 17-1507); “Electromagnetic Wave Modification of Fuel in a Jet Engine” (identified by attorney docket number 17-1508); “Electromagnetic Wave Modification of Fuel in a Power-generation Turbine” (identified by attorney docket number 17-1509); “Jet Engine with Plasma-assisted Combustion” (identified by attorney docket number 17-1510); “Jet Engine with Fuel Injection Using a Conductor of a Resonator” (identified by attorney docket number 17-1511); “Jet Engine with Fuel Injection Using a Dielectric of a Resonator” (identified by attorney docket number 17-1512); “Jet Engine with Fuel Injection Using a Conductor of At Least One of Multiple Resonators” (identified by attorney docket number 17-1513); “Jet Engine with Fuel Injection Using a Dielectric of At Least One of Multiple Resonators” (identified by attorney docket number 17-1514); “Plasma-Distributing Structure in a Jet Engine” (identified by attorney docket number 17-1515); “Power-generation Gas Turbine with Plasma-assisted Combustion” (identified by attorney docket number 17-1516); “Power-generation Gas Turbine with Fuel Injection Using a Conductor of a Resonator” (identified by attorney docket number 17-1517); “Power-generation Gas Turbine with Fuel Injection Using a Dielectric of a Resonator” (identified by attorney docket number 17-1518); “Power-generation Gas Turbine with Plasma-assisted Combustion Using Multiple Resonators” (identified by attorney docket number 17-1519); “Power-generation Gas Turbine with Fuel Injection Using a Conductor of At Least One of Multiple Resonators” (identified by attorney docket number 17-1520); “Power-generation Gas Turbine with Fuel Injection Using a Dielectric of At Least One of Multiple Resonators” (identified by attorney docket number 17-1521); “Plasma-Distributing Structure in a Power Generation Turbine” (identified by attorney docket number 17-1522); “Jet Engine with Plasma-assisted Combustion and Directed Flame Path” (identified by attorney docket number 17-1523); “Jet Engine with Plasma-assisted Combustion Using Multiple Resonators and a Directed Flame Path” (identified by attorney docket number 17-1524); “Plasma-Distributing Structure and Directed Flame Path in a Jet Engine” (identified by attorney docket number 17-1525); “Power-generation Gas Turbine with Plasma-assisted Combustion and Directed Flame Path” (identified by attorney docket number 17-1526); “Power-generation Gas Turbine with Plasma-assisted Combustion Using Multiple Resonators and a Directed Flame Path” (identified by attorney docket number 17-1527); “Plasma-Distributing Structure and Directed Flame Path in a Power Generation Turbine” (identified by attorney docket number 17-1528); “Jet engine with plasma-assisted afterburner” (identified by attorney docket number 17-1529); “Jet engine with plasma-assisted afterburner having Resonator with Fuel Conduit” (identified by attorney docket number 17-1530); “Jet engine with plasma-assisted afterburner having Resonator with Fuel Conduit in Dielectric” (identified by attorney docket number 17-1531); “Jet engine with plasma-assisted afterburner having Ring of Resonators” (identified by attorney docket number 17-1532); “Jet engine with plasma-assisted afterburner having Ring of Resonators and Resonator with Fuel Conduit” (identified by attorney docket number 17-1533); and “Plasma-Distributing Structure in an Afterburner of a Jet Engine” (identified by attorney docket number 17-1535).

### BACKGROUND

Resonators are devices and/or systems that can produce a large response for a given input when excited at a resonance frequency. Resonators are used in various applications, including acoustics, optics, photonics, electromagnetics, chemistry, particle physics, etc. For example, electromagnetic resonators can be used as antennas or as energy transmission devices. Further, resonators can concentrate a large amount of energy in a relatively small location (for example, as in the electromagnetic waves radiated by a laser).

Aircraft, including jets, can be used to transport cargo and/or passengers from one location to another at high velocities. By providing thrust using a jet engine or a propeller, aircraft can generate lift based on Bernoulli's principle. One way of powering a jet engine or a propeller includes combusting hydrocarbon fuel.

### SUMMARY

In a first implementation, a system is provided. The system has an afterburner including an afterburner duct that defines an afterburner channel. The afterburner is configured to receive input gas from a turbine of a jet engine into the afterburner channel and to output an exhaust gas resulting from combustion of fuel within the afterburner channel. The system includes a plurality of resonators configured to be electromagnetically coupled to at least one radio-frequency power source. Each resonator has a resonant wavelength and includes: (i) a first conductor, (ii) a second conductor, and (iii) a dielectric between the first conductor of that resonator and the second conductor of that resonator. Furthermore, each resonator is configured such that, when that resonator is excited by the at least one radio-frequency power source with a signal having a wavelength proximate to an odd-integer multiple of one-quarter (¼) of the resonant wavelength of that resonator, that resonator provides within the afterburner at least one of electromagnetic waves or a plasma corona proximate to that resonator. Furthermore still, a first resonator of the plurality of resonators additionally includes a fuel conduit having (1) a first fuel outlet that is configured to output fuel for mixing with the input gas from the turbine of the jet engine, and (2) at least a portion of the fuel conduit arranged proximate to the dielectric.

In a second implementation, a method is provided. The method includes receiving input gas from a turbine of a jet engine into an afterburner channel defined by an afterburner duct of an afterburner. The method also includes outputting fuel into the afterburner channel for mixing with the input gas from the turbine of the jet engine. The method further includes exciting a plurality of resonators electromagnetically coupled to at least one radio-frequency power source. Each resonator has a resonant wavelength and includes: a first conductor, a second conductor, and a dielectric between the first conductor of that resonator and the second conductor of that resonator. A first resonator of the plurality of resonators further includes a fuel conduit having (1) a first fuel outlet that is configured to output fuel for mixing with the input gas from the turbine of the jet engine, and (2) at least a portion of the fuel conduit arranged proximate to the dielectric. Still further, the method includes, in response to exciting each resonator of the plurality of resonators, providing within the afterburner at least one of electromagnetic waves or a plasma corona proximate to that resonator. Further still, the method includes outputting, from the afterburner channel, an exhaust gas resulting from combustion of the fuel within the afterburner channel.

Other implementations will become apparent to those of ordinary skill in the art by reading the following detailed description, with reference where appropriate to the accompanying drawings.

### BRIEF DESCRIPTION OF THE FIGURES

FIG. 1A illustrates a cross-sectional view of an internal combustion engine.

FIG. 1B illustrates an isometric view of an example quarter-wave coaxial cavity resonator (QWCCR) structure, according to example implementations.

FIG. 1C illustrates a cutaway side view of a QWCCR structure, according to example implementations.

FIG. 1D illustrates a cross-sectional view of a QWCCR structure, according to example implementations.

FIG. 1E is a cross-sectional illustration of an electromagnetic mode in a QWCCR structure, according to example implementations.

FIG. 1F is a cross-sectional illustration of an electromagnetic mode in a QWCCR structure, according to example implementations.

FIG. 1G is a plot of a quarter-wave resonance condition of a QWCCR structure, according to example implementations.

FIG. 2 illustrates a system that includes a coaxial resonator, according to example implementations.

FIG. 3A illustrates a system that includes a coaxial resonator, according to example implementations.

FIG. 3B illustrates a system that includes a coaxial resonator, according to example implementations.

FIG. 4A illustrates a system that includes a coaxial resonator, according to example implementations.

FIG. 4B illustrates a controller, according to example implementations.

FIG. 5A illustrates a cutaway side view of a QWCCR structure connected to a fuel pump and a fuel tank, according to example implementations.

FIG. 5B illustrates a cutaway side view of a coaxial resonator, according to example implementations.

FIG. 5C illustrates a cutaway side view of a coaxial resonator, according to example implementations.

FIG. 5D illustrates a cross-sectional view of a coaxial resonator, according to example implementations.

FIG. 5E illustrates multiple cross-sectional view of a coaxial resonator, according to example implementations.

FIG. 5F illustrates a cutaway side view of a coaxial resonator, according to example implementations.

FIG. 5G illustrates a cross-sectional view of a coaxial resonator, according to example implementations.

FIG. 6 illustrates a cross-sectional view of an example coaxial resonator connected to a direct-current (DC) power source through an additional resonator assembly acting as a radio-frequency (RF) attenuator, according to example implementations.

FIG. 7 illustrates a cross-sectional view of an example coaxial resonator connected to a DC power source through an additional resonator assembly acting as an RF attenuator, according to example implementations.

FIG. 8 illustrates an aircraft having a jet engine, according to example implementations.

FIG. 9 illustrates a jet engine, according to example implementations.

FIG. 10A illustrates a combustor, according to example implementations.

FIG. 10B illustrates a combustor, according to example implementations.

FIG. 10C illustrates a combustor, according to example implementations.

FIG. 10D illustrates a combustor, according to example implementations.

FIG. 10E illustrates a combustor, according to example implementations.

FIG. 10F illustrates a combustor, according to example implementations.

FIG. 11 illustrates a partial view of a combustor, according to example implementations.

FIG. 12 illustrates air flow paths through a combustor, according to example implementations.

FIG. 13 illustrates a jet engine including an afterburner, according to example implementations.

FIG. 14 illustrates a jet engine including an afterburner, according to example implementations.

FIG. 15A is a perspective view of an afterburner duct and casing, according to example implementations.

FIG. 15B is a perspective view of an afterburner duct and casing, according to example implementations.

FIG. 16A is an elevation view of an afterburner duct and casing, according to example implementations.

FIG. 16B is a cross-sectional view of the afterburner duct and casing shown in FIG. 16A.

FIG. 17A illustrates a torch igniter, according to example implementations.

FIG. 17B illustrates a torch igniter, according to example implementations.

FIG. 18 illustrates a system of an afterburner, according to example implementations.

FIG. 19A is a cross-sectional view of a fueling section of an afterburner, according to example implementations.

FIG. 19B is a cross-sectional view of the fueling section shown in FIG. 19A.

FIG. 19C is a cross-sectional view of a fueling section of an afterburner, according to example implementations.

FIG. 19D is a cross-sectional view of the fueling section shown in FIG. 19C.

FIG. 20A is a cross-sectional view of a resonator section of an afterburner, according to example implementations.

FIG. 20B is a cross-sectional view of the resonator section shown in FIG. 20A.

FIG. 20C is a cross-sectional view of a resonator section of an afterburner, according to example implementations.

FIG. 20D is a cross-sectional view of the resonator section shown in FIG. 20C.

FIG. 21A is a cross-sectional view of a resonator section of an afterburner, according to example implementations.

FIG. 21B is a cross-sectional view of the resonator section shown in FIG. 21A.

FIG. 21C is a cross-sectional view of a resonator section of an afterburner, according to example implementations.

FIG. 21D is a cross-sectional view of the resonator section shown in FIG. 21C.

FIG. 22A is a cross-sectional view of a resonator section of an afterburner, according to example implementations.

FIG. 22B is a cross-sectional view of the resonator section shown in FIG. 22A.

FIG. 22C is a cross-sectional view of a resonator section of an afterburner, according to example implementations.

FIG. 22D is a cross-sectional view of the resonator section shown in FIG. 22C.

FIG. 23A is a cross-sectional view of a resonator section of an afterburner, according to example implementations.

FIG. 23B is a cross-sectional view of the resonator section shown in FIG. 23A.

FIG. 23C is a cross-sectional view of a resonator section of an afterburner, according to example implementations.

FIG. 23D is a cross-sectional view of the resonator section shown in FIG. 23C.

FIG. 24A is a cross-sectional view of a resonator section of an afterburner, according to example implementations.

FIG. 24B is a cross-sectional view of the resonator section shown in FIG. 24A.

FIG. 24C is a cross-sectional view of a resonator section of an afterburner, according to example implementations.

FIG. 24D is a cross-sectional view of the resonator section shown in FIG. 24C.

FIG. 25A is a cross-sectional view of a resonator section of an afterburner, according to example implementations.

FIG. 25B is a cross-sectional view of the resonator section shown in FIG. 25A.

FIG. 25C is a cross-sectional view of a resonator section of an afterburner, according to example implementations.

FIG. 25D is a cross-sectional view of the resonator section shown in FIG. 25C.

FIG. 26A is a cross-sectional view of a resonator section of an afterburner, according to example implementations.

FIG. 26B is a cross-sectional view of the resonator section shown in FIG. 26A.

FIG. 26C is a cross-sectional view of a resonator section of an afterburner, according to example implementations.

FIG. 26D is a cross-sectional view of the resonator section shown in FIG. 26C.

FIG. 27A is a cross-sectional view of a resonator section of an afterburner, according to example implementations.

FIG. 27B is a cross-sectional view of the resonator section shown in FIG. 27A.

FIG. 27C is a cross-sectional view of a resonator section of an afterburner, according to example implementations.

FIG. 27D is a cross-sectional view of the resonator section shown in FIG. 27C.

FIG. 28 is a cutaway side view of a portion of a resonator section and other afterburner components, according to example implementations.

FIG. 29 illustrates a strut, according to example implementations.

FIG. 30 illustrates a strut, according to example implementations.

FIG. 31 illustrates a strut, according to example implementations.

FIG. 32 is a flow chart depicting operations of a representative method, according to example implementations.

### DETAILED DESCRIPTION

Example methods, devices, and systems are presently disclosed. It should be understood that the word “example” is used in the present disclosure to mean “serving as an instance or illustration.” Any implementation or feature presently disclosed as being an “example” is not necessarily to be construed as preferred or advantageous over other implementations or features. Other implementations can be utilized, and other changes can be made, without departing from the scope of the subject matter presented in the present disclosure.

Thus, the example implementations presently disclosed are not meant to be limiting. Components presently disclosed and illustrated in the figures can be arranged, substituted, combined, separated, and designed in a wide variety of different configurations, all of which are contemplated in the present disclosure.

Further, unless context suggests otherwise, the features illustrated in each of the figures can be used in combination with one another. Thus, the figures should be generally viewed as components of one or more overall implementations, with the understanding that not all illustrated features are necessary for each implementation.

In the context of this disclosure, various terms can refer to locations where, as a result of a particular configuration, and under certain conditions of operation, a voltage component can be measured as close to non-existent. For example, “voltage short” can refer to any location where a voltage component can be close to non-existent under certain conditions. Similar terms can equally refer to this location of close-to-zero voltage (for example, “virtual short circuit,” “virtual short location,” or “voltage null”). In examples, “virtual short” can be used to indicate locations where the close-to-zero voltage is a result of a standing wave crossing zero. “Voltage null” can be used to refer to locations of close-to-zero voltage for a reason other than as result of a standing wave crossing zero (for example, voltage attenuation or cancellation). Moreover, in the context of this disclosure, each of these terms that can refer to locations of close-to-zero voltage are meant to be non-limiting.

In an effort to provide technical context for the present disclosure, the information in this section can broadly describe various components of the implementations presently disclosed. However, such information is provided solely for the benefit of the reader and, as such, does not expressly limit the claimed subject matter. Further, components shown in the figures are shown for illustrative purposes only. As such, the illustrations are not to be construed as limiting. As is understood, components can be added, removed, or rearranged without departing from the scope of this disclosure.

### I. Overview

A resonator can be configured to provide a plasma corona and/or electromagnetic waves in response to being excited by a radio-frequency power source. This present disclosure describes such a resonator with respect to an afterburner. The afterburner can be configured to connect to a turbine of a jet engine and/or can be part of a jet engine. The afterburner can further be configured to be disconnected from a jet engine to perform service to the jet engine and/or the afterburner.

In an example implementation, a plurality of resonators or some portion of the plurality of resonators can be disposed within an afterburner channel. The plurality of resonators can be arranged as a ring of resonators. In some implementations, the resonators of a ring of resonators can be attached to a bracket and/or to a duct that defines the afterburner channel. The resonators can be configured to provide the plasma corona within the afterburner channel while a gas from the turbine, mixed with fuel, is flowing through the afterburner channel. The plasma corona provided by the resonators may ignite the fuel and initiate further combustion of fuel within the afterburner channel. In an example implementation, the electromagnetic waves may reform fuel within or output from a fuel supply line. In another example implementation, the resonator or some portion of the resonator can be disposed within a treatment chamber for pretreating fuel with the electromagnetic waves. In some of those implementations, the treatment chamber is disposed within the afterburner channel, while in some other implementations; the treatment chamber is disposed outside of the afterburner channel, such as on a casing of the afterburner.

At least one resonator of the plurality of resonators can each include two conductors, which could be separated by a dielectric insulator such as a ceramic material. The resonator can have a resonant wavelength and can provide excitation energy and a plasma corona to enhance combustion in the afterburner. In some implementations, the resonator can also be configured to provide fuel into a combustion environment, such as the afterburner channel, or other type of environment in which fuel may be desired.

In an example implementation, the resonator can provide fuel using a fuel conduit arranged proximate to the dielectric insulator. For instance, the dielectric insulator can include one or more fuel conduits, through which fuel can pass. These conduits can terminate at one or more fuel outlets out of which the fuel can be expelled into the environment and/or into another portion of the resonator.

Using a resonator configured in this manner in an afterburner can be advantageous in a variety of ways. For example, the resonator can be used as a substitute or supplement for a separate fuel injector component, possibly even eliminating a need for such a component. As another example, using a fuel conduit that is arranged proximate to a dielectric insulator to provide fuel can expose the fuel to resonator-generated electromagnetic waves, which can result in a reformation of the fuel before the resonator provides the fuel into the afterburner channel and/or ignites the fuel. And in addition, outlets of the fuel conduit can be oriented towards the location where the resonator will excite a plasma corona, thereby providing the fuel proximate to the ignition source (particularly, toward/through the plasma corona), which can improve the resulting combustion.

Furthermore, in some implementations, a resonator configured in this manner can be used together with additional resonators within the afterburner channel, such as multiple resonators arranged as a ring of resonators. Optionally, one or more of the additional resonators can also be configured such that fuel passes through a dielectric respectively of each of one or more of the additional resonators and is exposed to electromagnetic waves. Advantageously, when multiple resonators are configured such that fuel passes through a dielectric of each of the resonators, a greater amount of fuel can be reformed before entering the afterburner channel as opposed to an amount of fuel that can be reformed when only a single resonator includes a fuel conduit. Additionally or alternatively, one or more of the additional resonators can be controlled so as to provide a plasma corona. When multiple resonators are controlled so as to provide multiple plasma coronas within an afterburner channel, fuel introduced into the afterburner channel may combust at multiple ignition points, thereby increasing the probability of fuel being combusted before exiting the afterburner channel. Increasing the probability of fuel being combusted may improve various operating characteristics of the afterburner, including fuel efficiency and emissions, for example.

Furthermore still, in some implementations, one or more of the plurality of resonators can assume a dual role. For instance, providing the at least one plasma corona can include causing a given resonator of the plurality of resonators to provide a plasma corona. Moreover, in that implementation, the given resonator can be excited prior to formation of the plasma corona, such that the given resonator provides electromagnetic waves for pre-treating fuel that is input through the given resonator and/or fuel that is within the afterburner channel.

Similarly, in some implementations, a first set of resonators of a plurality of resonators can provide plasma coronas and a second set of resonators of the plurality of resonators need not provide respective plasma coronas. The first set of resonators could include one or more resonators of the plurality of resonators, and the second set of resonators could include one or more other resonators of the plurality of resonators. With this arrangement, after initiating combustion, rather than providing plasma coronas, the second set of resonators could instead enhance an already present combustion process by providing electromagnetic waves that can reform fuel that is being input to the afterburner channel and/or already in the afterburner channel. In one example, the resonators of the second set of resonators could be controlled so as to initially provide plasma coronas and then, after initiating combustion, to stop providing plasma coronas. Alternatively, resonators of the second set of resonators might never provide plasma coronas, but only provide electromagnetic waves for pre-treating or reforming fuel.

Additionally, the resonator in the afterburner channel can be one of multiple resonators disposed in the afterburner channel. Each of those resonators can be configured to provide electromagnetic waves and/or a plasma corona. In some implementations, the multiple resonators can be disposed within the afterburner channel and separated from each other so that the electromagnetic waves provided by those resonators are able to influence fuel within a large zone in the afterburner channel, such as a cross-section of the afterburner channel in which the resonators are disposed. The electromagnetic waves within that zone can provide a large electric field within the afterburner channel such that a fuel flow rate within the afterburner channel can increase as compared to when the resonators are not providing the electromagnetic waves. Additionally or alternatively, the multiple resonators spread throughout the zone of the afterburner channel can provide the plasma corona though a large portion of the zone to increase combustion efficiency within the afterburner.

### II. Example Combustion

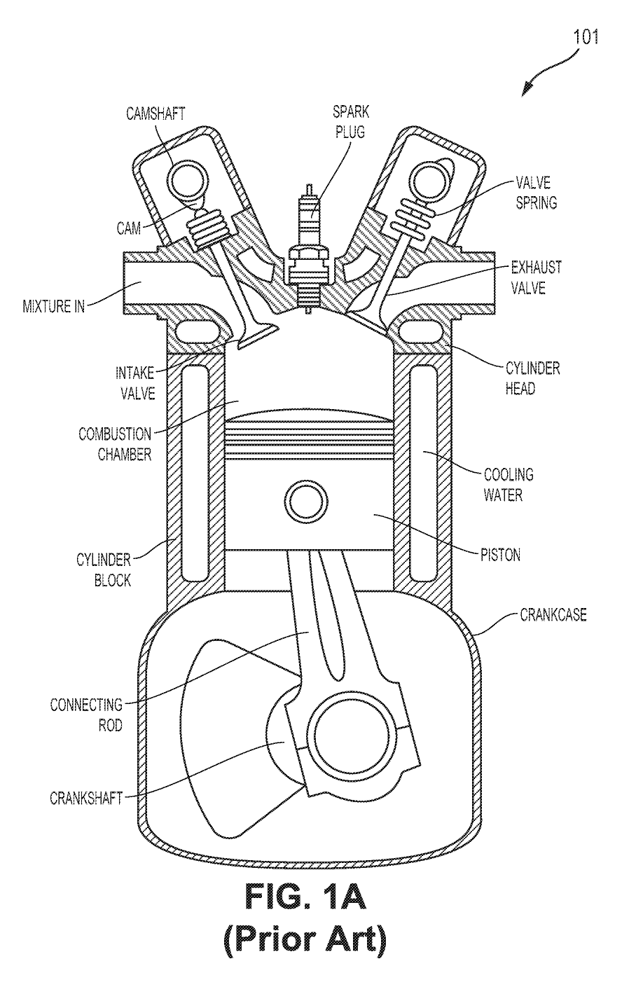

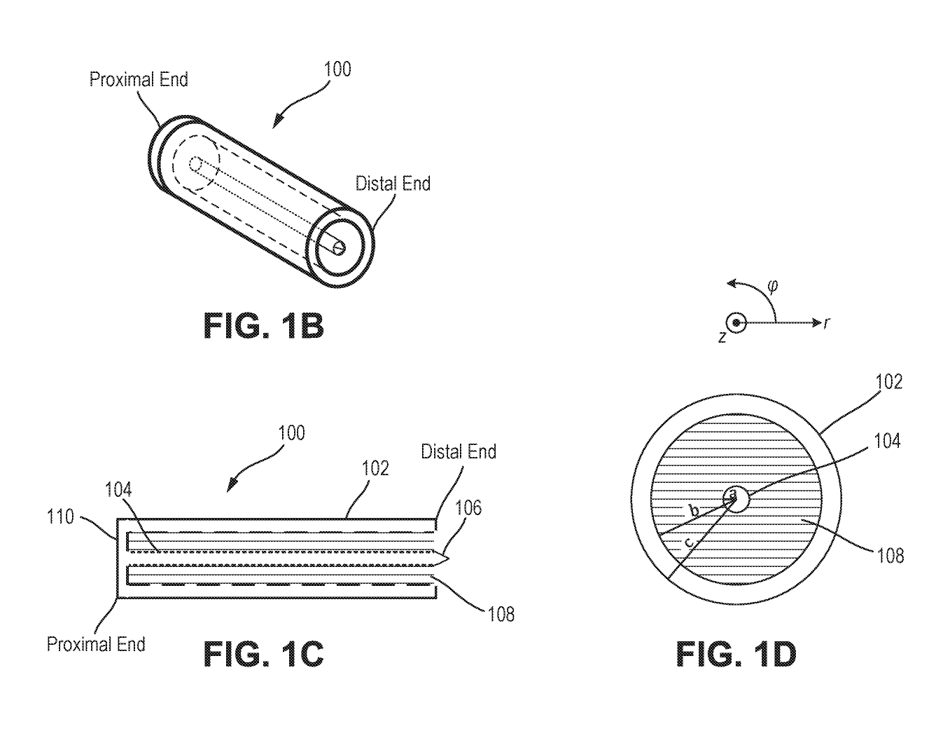

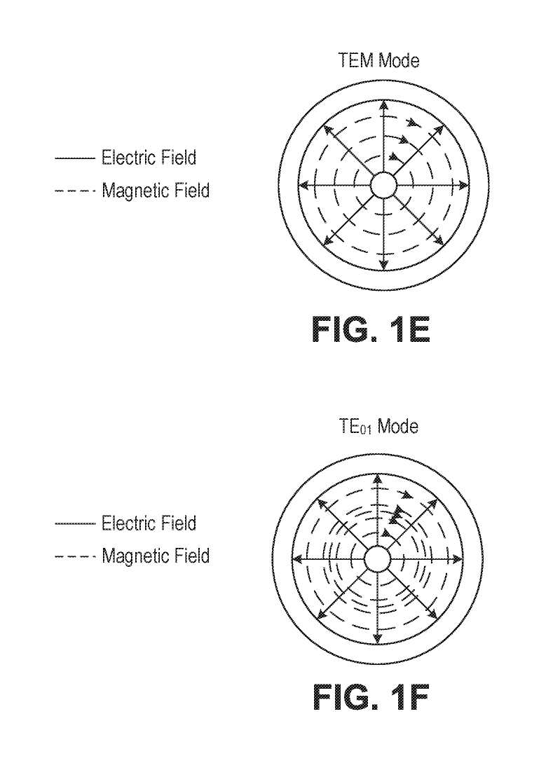

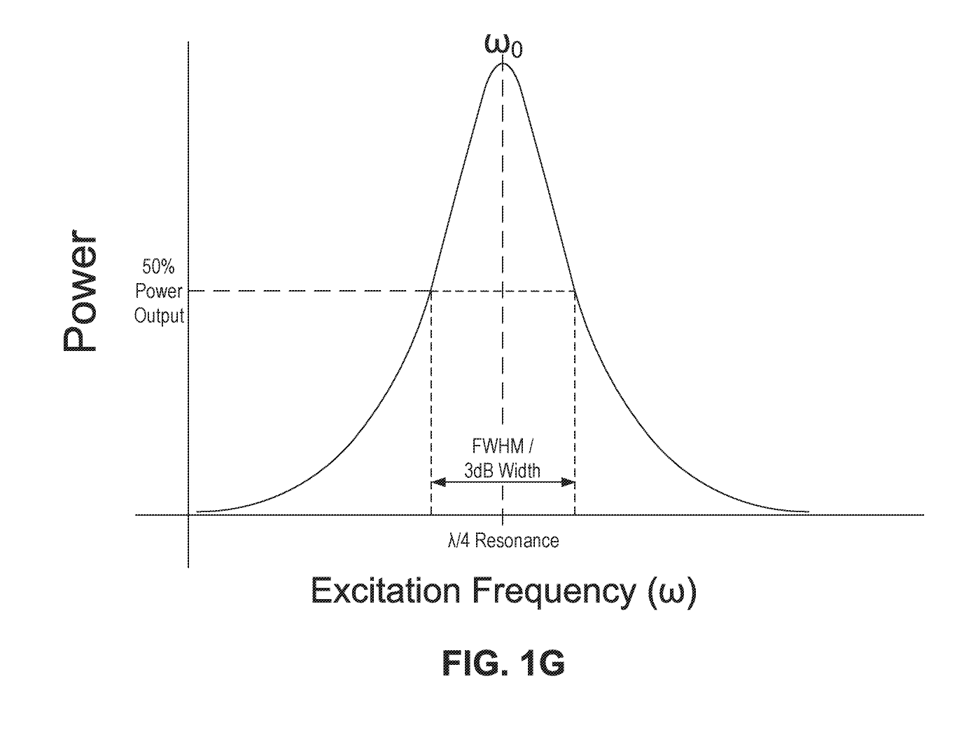

Igniters can be used to ignite a mixture of air and fuel (for example, within a combustion chamber of an internal combustion engine 101, such as that illustrated in cross-section in FIG. 1A). For example, igniters can be configured as gap spark igniters, similar to an automotive spark plug. However, gap spark igniters might not be desirable in some applications and/or under some conditions. For example, a gap spark igniter might not be capable of igniting and initiating combustion of fuel mixtures that have fuel-to-air ratios below a certain threshold. Further, lean mixtures of fuel and air might have significant environmental and economic benefits by making combustion (for example, within a combustor or an afterburner) more efficient, and thus, using a gap spark igniter might preclude achieving such benefits. In addition, higher thermal efficiencies can be achieved by operating at higher power densities and pressures. However, using more energetic or powerful gap spark igniters reduces overall ignition efficiency because the higher energy levels can be detrimental to the gap spark igniter's lifetime. Higher energy levels might also contribute to the formation of undesirable pollutants and can reduce overall engine efficiency.

While gap spark igniters are described above, other types of igniters can generally include glow plugs (for example, in diesel-fueled internal combustion engines), open flame sources (for example, cigarette lighters, friction spark devices, etc.), and other heat sources.

A variety of fuels (for example, hydrocarbon fuels) can be combusted to yield energy within an internal combustion engine, within a power-generation turbine, within a jet engine, or within various other applications. For example, kerosene (also known as paraffin or lamp oil), gasoline (also known as petrol), fractional distillates of petroleum fuel oil (for example, diesel fuel), crude oil, Fischer-Tropsch synthesized paraffinic kerosene, natural gas, and coal are all hydrocarbon fuels that, when combusted, liberate energy stored within chemical bonds of the fuel. Jet fuel, specifically, can be classified by its “jet propellant” (JP) number. The “jet propellant” (JP) number can correspond to a classification system utilized by the United States military. For example, JP-1 can be a pure kerosene fuel, JP-4 can be a 50% kerosene and 50% gasoline blend, JP-9 can be another kerosene-based fuel, JP-9 can be a gas turbine fuel (for example, including tetrahydrodimethylcyclopentadiene) specifically used in missile applications, and JP-10 can be a fuel similar to JP-9 that includes endo-tetrahydrodicyclopentadiene, exo-tetrahydrodicyclopentadiene, and adamantane. Other forms of jet fuel include zip fuel (for example, high-energy fuel that contains boron), SYNTROLEUM® FT-fuel, other kerosene-type fuels (for example, Jet A fuel and Jet A−1 fuel), and naphtha-type fuels (for example, Jet B fuel). It is understood that other fuels can be combusted as well. Further, the fuel type used can depend upon the application. For example, jet engines, internal combustion engines, and power-generation turbines may each burn different types of fuels.

When fuel (for example, hydrocarbon fuel) interacts with electromagnetic radiation, the fuel can change chemical composition. For example, when hydrocarbon fuel interacts with (for example, is irradiated by) microwaves, some of the hydrogen atoms can be ionized and/or one or more hydrogen atoms can be liberated from a hydrocarbon chain. The processes of liberating hydrogen within fuel, ionizing hydrogen within fuel, or otherwise changing the chemical composition of fuel are collectively referred to in the present disclosure as “reforming” the fuel. Reforming the fuel can include exciting the hydrocarbon fuel at one or more of its natural resonant frequencies (for example, acoustic and/or electromagnetic resonant frequencies) to break one or more of the carbon-hydrogen (or other) bonds within the hydrocarbon chain. When hydrogen within a hydrocarbon fuel becomes ionized and/or is liberated from the hydrocarbon chain, the resulting hydrocarbon fuel can require less energy to burn. Thus, a leaner fuel/air mixture that includes reformed fuel can achieve the same output power (for example, within a combustion chamber of a jet engine or a power-generation turbine) as compared to a more rich fuel/air mixture that includes non-reformed fuel, since the reformed fuel can combust more quickly and thoroughly. Analogously, when comparing equal fuel-to-air ratios, less input energy can be required to combust a mixture that includes reformed fuel when compared to a mixture that includes non-reformed fuel.

In addition to reforming fuels, electromagnetic radiation can alter an energy state of fuel and/or of a fuel mixture. In an example implementation, altering the energy state of fuel can include exciting electrons within the valence band of the hydrocarbon chain to higher energy levels. In such scenarios, raising the energy state can also include reorienting polar molecules (for example, water and/or polar hydrocarbon chains) within a fuel/air mixture due to electromagnetic fields applying a torque on polar molecules. Reorienting polar molecules can result in molecular motion, thereby increasing an effective temperature and/or kinetic energy of the molecule, which raises the energy state of fuel. By raising the energy state of fuel, the activation energy for combustion of the fuel can be reduced. When the activation energy for combustion is reduced, the energy supplied by the ignition source can also be decreased, thereby conserving energy during ignition.

Presently disclosed are ignition systems with resonators (for example, QWCCR structures) that use both RF power and DC power. The presently disclosed RF ignition systems provide an alternative to other types of igniters. For example, the QWCCR structure can be used as an igniter (for example, in place of an automotive gap spark plug) in the internal combustion engine 101. Such RF ignition systems can excite plasma (for example, within a corona). If an igniter is configured as one of the RF ignition systems presently disclosed, then more efficient, leaner, cleaner combustion can be achieved. Such increased combustion efficiency can be achieved at decreased air pressures and temperatures when compared with a gap spark igniter (for example, if the RF ignition system is used in a jet engine). Further, such increased combustion efficiency can be achieved at higher air pressures and temperatures when compared with a gap spark igniter. It is understood throughout this disclosure that where reference is made to “RF” or to microwaves, in alternate implementations, other wavelengths of electromagnetic waves outside of the RF range can be used alternatively or in addition to RF electromagnetic waves.

As described above, RF ignition systems can excite plasma. Plasma is one of the four fundamental states of matter (in addition to solid, liquid, and gas). Further, plasmas are mixtures of positively charged gas ions and negatively charged electrons. Because plasmas are mixtures of charged particles, plasmas have associated intrinsic electric fields. In addition, when the charged particles in the mixture move, plasmas also produce magnetic fields (for example, according to Ampere's law). Given the electromagnetic nature of plasmas, plasmas interact with, and can be manipulated by, external electric and magnetic fields. For example, placing a ferromagnetic material (for example, iron, cobalt, nickel, neodymium, samarium-cobalt, etc.) near a plasma can cause the plasma to be attracted to or repelled from the ferromagnetic material (for example, causing the plasma to move).

Plasmas can be formed in a variety of ways. One way of forming a plasma can include heating gases to a sufficiently high temperature (for example, depending on ambient pressure). Additionally or alternatively, forming a plasma can include exposing gases to a sufficiently strong electromagnetic field. Lightning is an environmental phenomenon involving plasma. One application of plasma can include neon signs. Further, because plasma is responsive to applied electromagnetic fields, plasma can be directed according to specific patterns. Hence, plasmas can also be used in technologies such as plasma televisions or plasma etching.

Plasmas can be characterized according to their temperature and electron density. For example, one type of plasma can be a “microwave-generated plasma” (for example, ranging from 5 eV to 15 eV in energy). Such a plasma can be generated by a QWCCR structure, for example.

### III. Example Resonator

An example implementation of a QWCCR structure 100 is illustrated in FIGS. 1B-1D. As illustrated, the QWCCR structure 100 can include an outer conductor 102, an inner conductor 104 with an associated electrode 106, a base conductor 110, and a dielectric 108. Also as illustrated, the QWCCR structure 100 can be shaped as concentric circular cylinders. The inner conductor 104 can have radius ‘a’, the outer conductor 102 can have inner radius ‘b’, and the outer conductor 102 can have outer radius ‘c’, as illustrated in cross-section in FIG. 1D. In alternate implementations, the QWCCR structure 100 can have other shapes (for example, concentric ellipsoidal cylinders or concentric, enclosed, elongated volumes with square or rectangular cross-sections). The inner conductor 104, the outer conductor 102 (or just the inner surface of the outer conductor 102), the electrode 106, and the base conductor 110 can be made of various conductive materials (for example, steel, gold, silver, platinum, nickel, or alloys thereof). Further, in some implementations, the inner conductor 104, the outer conductor 102, and the base conductor 110 can be made of the same conductive materials, while in other implementations, the inner conductor 104, the outer conductor 102, and the base conductor 110 can be made of different conductive materials. Additionally, in some implementations, the inner conductor 104, the outer conductor 102, and/or the base conductor 110 can include a dielectric material coated in a conductor (for example, a metal-plated ceramic). In such implementations, the conductive coating can be thicker than a skin-depth of the conductor at a given excitation frequency of the QWCCR structure 100 such that electricity is conducted throughout the conductive coating.

As illustrated, an electrode 106 can be disposed at a distal end of the inner conductor 104. The electrode 106 can be made of a conductive material as described above (for example, the same conductive material as the inner conductor 104). For example, the electrode 106 can be machined with the inner conductor 104 as a single piece. In some implementations, as illustrated, the base conductor 110, the outer conductor 102, the inner conductor 104, and the electrode can be shorted together. For example, the base conductor 110 can short the outer conductor 102 to the inner conductor 104, in some implementations. When shorted together, these components can be directly electrically coupled to one another such that each of these components is at the same electric potential.

Further, in implementations where the base conductor 110, the outer conductor 102, and the inner conductor 104 (including the electrode 106) are shorted together, the base conductor 110, the outer conductor 102, and the inner conductor 104 (including the electrode 106) can be machined as a single piece. In addition, the electrode 106 can include a concentrator (for example, a tip, a point, or an edge), which can concentrate and enhance the electric field at one or more locations. Such an enhanced electric field can create conditions that promote the excitation of a plasma corona near the concentrator (for example, through a breakdown of a dielectric, such as air, that surrounds the concentrator). The concentrator can be a patterned or shaped portion of the electrode 106, for example. The electrode 106, including the concentrator, can be electromagnetically coupled to the inner conductor 104. In the present disclosure and claims, the electrode 106 and/or the concentrator can be described as being “configured to electromagnetically couple to” the inner conductor 104. This language is to be interpreted broadly as meaning that the electrode 106 and/or the concentrator: are presently electromagnetically coupled to the inner conductor 104, are always electromagnetically coupled to the inner conductor 104, can be selectively electromagnetically coupled to the inner conductor 104 (for example, using a switch), are only electromagnetically coupled to the inner conductor 104 when a power source is connected to the inner conductor 104, and/or are able to be electromagnetically coupled to the inner conductor 104 if one or more components are repositioned relative to one another. For example, the electrode 106 can be “configured to electromagnetically couple to” the inner conductor 104 if the electrode 106 is machined as a single piece with the inner conductor 104, if the electrode 106 is connected to the inner conductor 104 using a wire or other conducting mechanism, or if the electrode 106 is disposed sufficiently close to the inner conductor 104 such that the electrode 106 electromagnetically couples to one or more evanescent waves excited by the inner conductor 104 when the inner conductor 104 is connected to a power source.

As illustrated in FIG. 1C, the electrode 106 and/or a concentrator of the electrode 106 can extend beyond the distal end of the outer conductor 102 and/or the distal end of the dielectric 108. In alternate implementations, the electrode 106 and/or a concentrator of the electrode 106 can be flush with the distal end of the outer conductor 102 and/or the distal end of the dielectric 108. In alternate implementations, the electrode 106 and/or a concentrator of the electrode 106 can be shorter than the outer conductor 102, such that no portion of the electrode 106 and/or concentrator is flush with the distal end of the outer conductor 102 and no portion extends beyond the distal end of the outer conductor 102. The QWCCR structure 100 can be excited at resonance, in some implementations. The resonance can generate a standing voltage quarter-wave within the QWCCR structure 100. If the concentrator, the distal end of the outer conductor 102, and the distal end of the dielectric 108 are each flush with one another, the electromagnetic field can quickly collapse outside of the QWCCR structure 100, thereby concentrating the majority of the electromagnetic energy at the concentrator. In still other implementations, the distal end of the outer conductor 102 and/or the distal end of the dielectric 108 can extend beyond the electrode 106 and/or a concentrator of the electrode 106. The electrode 106 can effectively modify the physical length of the inner conductor 104, which can modify the resonance conditions of the QWCCR structure 100 (for example, can modify the electrical length of the QWCCR structure 100). Various resonance conditions can thus be achieved across a variety of QWCCR structures 100 by varying the geometry of the electrode 106 and/or a concentrator of the electrode 106.

Further, as illustrated in FIG. 1C, the base conductor 110 can be electrically coupled to the outer conductor 102 and the inner conductor 104. In alternate implementations, the inner conductor 104 can be electrically insulated from the outer conductor 102 (rather than shorted together through the base conductor 110).

Plasmas (for example, plasma coronas generated by the QWCCR structure 100) can be used to ignite mixtures of air and fuel (for example, hydrocarbon fuel for use in a combustion process). Plasma-assisted ignition (for example, using a QWCCR structure 100) is fundamentally different from ignition using a gap spark plug. For example, efficient electron-impact excitation, dissociation of molecules, and ionization of atoms, which might not occur in ignition using gap spark plugs, can occur in plasma-assisted ignition. Further, in plasmas, an external electric field can accelerate the electrons and/or ions. Thus, using electric fields, energy within the plasma (for example, thermal energy) can be directed to specific locations (for example, within a combustion chamber).

There are a variety of mechanisms by which plasma can impart the energy necessary to ignite mixtures of air and fuel. For example, electrons can impart energy to molecules during collisions. However, this singular energy exchange might be relatively minor (for example, because an electron's mass is orders of magnitude less than a molecule's mass). So long as the rate at which electrons are imparting energy to the molecules is higher than the rate at which molecules are undergoing relaxation, a population distribution of the molecules (for example, a population distribution that differs from an initial Boltzmann distribution of the molecules) can arise. The molecules having higher energy, along with the dissociation and ionization processes, can emit ultraviolet (UV) radiation (for example, when undergoing relaxation) that affects mixtures of fuel and air. Further, gas heating and an increase in system reactivity can increase the likelihood of ignition and flame propagation. In addition, when the average electron energy within a plasma (for example, within a combustion chamber) exceeds 10 eV, gas ionization can be the predominant mechanism by which plasma is formed (over electron-impact excitation and dissociation of molecules).

Plasma-assisted ignition can have a variety of benefits over ignition using a gap spark plug. For example, in plasma-assisted ignition, a plasma corona that is generated can be physically larger (for example, in length, width, radius, and/or overall volumetric extent) than a typical spark from a gap spark plug. This can allow a more lean fuel mixture (also known as lower fuel-to-air ratio) to be burned once combustion occurs as compared with alternative ignition, for example. Also, because a larger energy can be energized in plasma-assisted ignition, stoichiometric ratio fuels can be combusted more fully, thereby creating fewer regulated pollutants (for example, creating less NOₓ to be expelled as exhaust) and/or leaving less unspent fuel.

Dielectric breakdown of air or another dielectric material near the electrode 106 of the QWCCR structure 100 can be a mechanism by which a plasma corona is excited near the concentrator of the QWCCR structure 100. Factors that impact the breakdown of a dielectric, such as dielectric breakdown of air, include free-electron population, electron diffusion, electron drift, electron attachment, and electron recombination. Free electrons in the free-electron population can collide with neutral particles or ions during ionization events. Such collisions can create additional free electrons, thereby increasing the likelihood of dielectric breakdown. Oppositely, electron diffusion and attachment can each be mechanisms by which free electrons recombine and are lost, thereby reducing the likelihood of dielectric breakdown.

As presently described, a plasma corona can be provided “proximate to” a distal end of the QWCCR structure 100, the electrode 106, and/or a concentrator of the QWCCR structure 100. In other words, the plasma corona could be described as being provided “nearby” or “at” a distal end of the QWCCR structure 100, the electrode 106, and/or a concentrator of the QWCCR structure 100. Further, this terminology is not to be viewed as limiting. For example, while the plasma corona is provided “proximate to” the QWCCR structure 100, this does not limit the plasma corona from extending away from the QWCCR structure 100 and/or from being moved to other locations that are farther from the QWCCR structure 100 after being provided “proximate to” the QWCCR structure 100.

When used to describe a relationship between a plasma corona and a distal end of the QWCCR structure 100, a relationship between a plasma corona and the electrode 106, a relationship between a plasma corona and a concentrator of the electrode 106, or similar relationships, the term “proximate” can describe the physical separation between the plasma corona and the other component. In various implementations, the physical separation can include different ranges. For example, a plasma corona provided “proximate to” the concentrator can be separated from the concentrator (in other words, can “stand off from” the concentrator) by less than 1.0 nanometer, by 1.0 nanometer to 10.0 nanometers, by 10.0 nanometers to 100.0 nanometers, by 100.0 nanometers to 1.0 micrometer, by 1.0 micrometer to 10.0 micrometers, by 10.0 micrometers to 100.0 micrometers, or by 100.0 micrometers to 1.0 millimeter. Additionally or alternatively, a plasma corona provided “proximate to” the concentrator can be separated from the concentrator by 0.01 times a width of the plasma corona to 0.1 times a width of the plasma corona, by 0.1 times a width of the plasma corona to 1.0 times the width of the plasma corona, or by 1.0 times a width of the plasma corona to 10.0 times a width of the plasma corona. Even further, a plasma corona provided “proximate to” the concentrator can be separated from the concentrator by 0.01 times a radius of the concentrator to 0.1 times a radius of the concentrator, by 0.1 times a radius of the concentrator to 1.0 times a radius of the concentrator, or by 1.0 times a radius of the concentrator to 10.0 times a radius of the concentrator.

It is understood that in various implementations, the plasma corona can emit light entirely within the visible spectrum, partially within the visible spectrum and partially outside the visible spectrum, or completely outside the visible spectrum. In other words, even if the plasma corona is “invisible” to the human eye and/or to optics that only sense light within the visible spectrum, it is not necessarily the case that the plasma corona is not being provided.

### IV. Mathematical Description of Example Resonator

In order for dielectric breakdown to occur, an electric field within the dielectric must be greater than or equal to an electric field breakdown threshold. An electric field generated by an alternating current (AC) source can be described by a root-mean-square (rms) value for electric field (Eᵣₘₛ). The rms value for electric field (Eᵣₘₛ) can be calculated according the following equation:

$${E}_{rms} = \sqrt{\frac{1}{{T}_{2} - {T}_{1}} {\int }_{{T}_{1}}^{{T}_{2}} {E}^{2} dt }$$

where T₂−T₁ represents the period over which the electric field is oscillating (for example, corresponding to the period of the AC source generating the electric field). As described mathematically above, the rms value for electric field (Eᵣₘₛ) represents the quadratic mean of the electric field. Using the rms value for electric field, an effective electric field (E_{eff}) can be calculated that is approximately frequency independent (for example, by removing phase lag effects from the oscillating electric field):

$${E}_{eff}^{2} = {E}_{rms}^{2} \frac{{v}_{c}^{2}}{{ω}^{2} + {v}_{c}^{2}}$$

where ω represents the angular frequency of the electric field (for example,

$$ω = \frac{2 π}{{T}_{2} - {T}_{1}} )$$

and ν_{c} represents the effective momentum collision frequency of the electrons and neutral particles. The angular frequency (ω) of the electric field can correspond to the frequency of an excitation source used to excite the electric field (for example, the QWCCR structure 100). Using this effective electric field (E_{eff}), DC breakdown voltages for various gases (and potentially other dielectrics) can be related to AC breakdown values for uniform electric fields. For air, ν_{c}≈5·10⁹×p, where p represents the pressure (in torr). At atmospheric pressure (for example, around 760 torr) or above and excitation frequencies of below 1 THz, the effective momentum collision frequency of the electrons and neutral particles (ν_{c}) will dominate the denominator of the fractional coefficient of Eᵣₘₛ². Therefore, an approximation of the rms breakdown field (E_{b}) can be used. The rms breakdown field (E_{b}), in V/cm, of a uniform microwave field in the collision regime can be given by:

$${E}_{b} = 30 \cdot 297 ( \frac{p}{T} )$$

where T is the temperature in Kelvin.

An analytical description of the electromagnetics of the QWCCR structure 100 follows.

If fringing electromagnetic fields are assumed to be small, the lowest quarter-wave resonance in a coaxial cavity is a transverse electromagnetic mode (TEM mode) (as opposed to a transverse electric mode (TE mode) or a transverse magnetic mode (TM mode)). The TEM mode is the dominant mode in a coaxial cavity and has no cutoff frequency (ω_{c}). In the TEM mode (as illustrated in FIG. 1E), because neither the electric field nor the magnetic field have any components in the z-direction (coordinate system illustrated in FIG. 1D), the electric and magnetic fields can be written, respectively, as:

$$H = {H}_{ϕ} {\hat{a}}_{ϕ} = \frac{{I}_{0}}{2 π r} cos ( β z ) {\hat{a}}_{ϕ}$$

$$E = {E}_{r} {\hat{a}}_{r} = \frac{{V}_{0}}{2 π r} sin ( β z ) {\hat{a}}_{r}$$

where H is a phasor representing the magnetic field vector, E is a phasor representing the electric field vector, â_{φ} represents a unit vector in the φ direction (labeled in FIG. 1D), âᵣ represents a unit vector in the r direction (labeled in FIG. 1D), β represents the wave number (canonically defined as

$$β = \frac{2 π}{λ} ,$$

where λ is the wavelength), I₀ represents the maximum current in the cavity, V₀ represents the maximum voltage in the cavity, and z represents a distance along the QWCCR structure 100 in the z direction (labeled in FIG. 1D).

In various implementations, various electromagnetic modes of the QWCCR structure 100 can be excited in order to achieve various electromagnetic properties. In some implementations, for instance, a single electromagnetic mode can be excited, whereas in alternate implementations, a plurality of electromagnetic modes can be excited. For example, in some implementations, the TE₀₁ mode (as illustrated in FIG. 1F) can be excited.

Quality factor (Q) can be defined as:

$$Q = \frac{ω \cdot U}{{P}_{L}} \to U = \frac{{P}_{L} \cdot Q}{ω}$$

where ω is the angular frequency, U is the time-average energy, and P_{L} is the time-average power loss. Quality factor (Q) can be used to measure goodness of a resonator cavity. Other formulations of goodness measurement can also be used (for example, based on full-width, half-max (FWHM) or a 3 decibel (dB) bandwidth of cavity resonance). In some implementations, the quality factor (Q) can be maximized when the ratio of the inner radius of the outer conductor ‘b’ to the radius of the inner conductor ‘a’ is approximately equal to 4. However, it will be understood that many other ways to adjust and/or maximize quality factor (Q) are possible and contemplated in the present disclosure.

At resonance, the stored energy of the QWCCR structure 100 oscillates between electrical energy (Uₑ) (within the electric field) and magnetic energy (Uₘ) (within the magnetic field). Time-average stored energy in the QWCCR structure 100 can be calculated using the following:

$$U = {U}_{m} + {U}_{e} = \frac{1}{4} {\int }_{vol} μ {\vert H \vert}^{2} + ɛ {\vert E \vert}^{2}$$

where μ is magnetic permeability and ε is dielectric permittivity. By inserting the values for electric field and magnetic field from above, and integrating over the entire volume of the QWCCR structure 100, the following expression can be obtained:

$$U = \frac{ln ( \frac{b}{a} ) \cdot λ}{64 π} ( μ \cdot {I}_{0}^{2} + ɛ \cdot {V}_{0}^{2} )$$

where b represents the inner radius of the outer conductor 102 of the QWCCR structure 100 (as illustrated in FIG. 1D), a represents the radius of the inner conductor 104 of the QWCCR structure 100 (as illustrated in FIG. 1D), and λ represents the wavelength of the source (for example, AC source) used to excite the QWCCR structure 100. Because the magnetic energy at maximum is the same as the electric energy at maximum, μ·I₀² can be replaced with ε·V₀², thus resulting in:

$$U = \frac{ln ( \frac{b}{a} ) \cdot λ}{32 π} ( ɛ \cdot {V}_{0}^{2} )$$

Now, by equating the two above expressions for U, the following relationship can be expressed:

$$\frac{{P}_{L} \cdot Q}{ω} = \frac{ln ( \frac{b}{a} ) \cdot λ}{32 π} ( ɛ \cdot {V}_{0}^{2} ) \to {V}_{0} = \sqrt{\frac{32 π \cdot Q \cdot {P}_{L}}{ω \cdot ɛ \cdot ln ( \frac{b}{a} ) \cdot λ}}$$

Further, in recognizing that

$$ω = 2 π f = \frac{2 π c}{λ} ,$$

where c is the speed of light;

$$c = \sqrt{\frac{1}{μ \cdot ɛ}} ; and η = \sqrt{\frac{μ}{ɛ}} ,$$

where η is the impedance of the dielectric between the inner conductor 104 and the outer conductor 102 of the QWCCR structure 100, the following relationship for the peak potential (V₀) can be identified:

$${V}_{0} = 4 \sqrt{\frac{η \cdot Q \cdot {P}_{L}}{ln ( \frac{b}{a} )}}$$

Given that electric field decays as the distance from the peak potential (V₀) increases, the largest value of electric field corresponding to the peak potential (V₀) occurs exactly at the surface of the inner conductor (for example, at radius a, as illustrated in FIG. 1D). Using the above equation for phasor electric field (E), the peak value of electric field (Eₐ) can be expressed as:

$${E}_{a} = \frac{{V}_{0}}{2 π a} = \frac{2}{π a} \sqrt{\frac{η \cdot Q \cdot {P}_{L}}{ln ( \frac{b}{a} )}}$$

If the above peak value of electric field (Eₐ) meets or exceeds the above-described rms breakdown field (E_{b}), a dielectric breakdown can occur. For example, a dielectric breakdown of the air surrounding the tip of the QWCCR structure 100 can result in a plasma corona being excited. As indicated in the above equation for peak electric field (Eₐ), the smaller the radius a of the inner conductor 104, the smaller the inner radius b of outer conductor 102, the higher the quality factor (Q) of the QWCCR structure 100, and the larger the time-average power loss (P_{L}), the more likely it is that breakdown can occur (for example, because the peak value of electric field (Eₐ) is larger). A larger excitation power can correspond to a larger time-average power loss (P_{L}) in the QWCCR structure 100, for example.

The power loss (P_{L}) can include ohmic losses (P_{σ}) on conductive surfaces (for example, the surface of the outer conductor 102, the surface of the inner conductor 104, and/or the surface of the base conductor 110, as illustrated in FIG. 1C), dielectric losses (P_{σ}_{ₑ}) in the dielectric 108, and radiation losses (P_{rad}) from a radiating end of the QWCCR structure 100 (for example, the distal end of the QWCCR structure 100). Each of the conductors can have a corresponding surface resistance (R_{S}). The surface resistance (R_{S}) can be the same for one or more of the conductors if the corresponding conductors are made of the same conductive materials. The corresponding surface resistance for each conductor can be expressed as R_{S}=

$$\sqrt{\frac{ω \cdot {μ}_{c}}{2 \cdot {σ}_{c}}} ,$$

where μ_{c} is the magnetic permeability of the respective conductor and σ_{c} is the conductivity of the respective conductor. The power lost by each conductor can be calculated according to the following:

$${P}_{σ} = \frac{1}{2} {\int }_{A} {R}_{S} {\vert {H}_{//} \vert}^{2}$$

where H_{//} is the magnetic field parallel to the surface of the conductor. Thus, the total power loss in all conductors can be represented by:

$${P}_{σ} = {P}_{inner} + {P}_{outer} + {P}_{base} = \frac{{R}_{S} \cdot {I}_{0}^{2}}{4 π} [ \frac{λ}{8 \cdot a} + \frac{λ}{8 \cdot b} + ln ( \frac{b}{a} ) ]$$

Further, if the dielectric 108 is an isotropic, low-loss dielectric, the dielectric 108 can be characterized by its dielectric constant (E) and its loss tangent (tan(δₑ)), where the loss tangent (tan(δₑ)) represents conductivity and alternating molecular dipole losses. Using dielectric constant (ε) and loss tangent (tan(δₑ)), an effective dielectric conductivity (σₑ) can be approximately defined as:

σₑ≈ω·ε·tan(δₑ)

Based on the above, the power dissipated in the dielectric can be calculated according to the following:

$${P}_{{σ}_{e}} = \frac{1}{2} {\int }_{vol} {σ}_{e} {\vert E \vert}^{2} = \frac{{σ}_{e} \cdot η \cdot {I}_{0}^{2}}{4 π} ( \frac{ln ( \frac{b}{a} ) \cdot λ}{8} )$$

In order to combine all quality factors of the QWCCR structure 100 into a total internal quality factor (Qᵢₙₜ), the following relationship can be used:

$${Q}_{int} = \frac{1}{( {Q}_{inner}^{- 1} + {Q}_{outer}^{- 1} + {Q}_{base}^{- 1} + {Q}_{{σ}_{e}}^{- 1} )}$$

where Qᵢₙₙₑᵣ⁻¹, Qₒᵤₜₑᵣ⁻¹, Q_{base}⁻¹, and Q_{σ}_{ₑ}⁻¹ are the quality factors of the inner conductor 104, the outer conductor 102, the base conductor 110, and the dielectric 108, respectively. Using the above expression for quality factor (Q) in terms of time-average power loss (P_{L}), angular frequency (ω), and time-average energy (U), the following expression for internal quality factor (Qᵢₙₜ) can be determined:

$${Q}_{int} = {( \frac{{R}_{s}}{2 \cdot π \cdot η} [ \frac{( \frac{b}{a} + 1 )}{\frac{b}{a} \cdot ln ( \frac{b}{a} )} + 8 ] + tan ( {δ}_{e} ) )}^{- 1}$$

Based on the definitions of the individual quality factors above, the individual contribution of the outer conductor quality factor (Qₒᵤₜₑᵣ) to the internal quality factor (Qᵢₙₜ) can be greater than the individual contribution of the inner conductor quality factor (Qᵢₙₙₑᵣ). Thus, to increase the internal quality factor (Qᵢₙₜ), a material with higher conductivity can be used for the inner conductor 104 than is used for the outer conductor 102. Further, the base conductor 110 quality factor (Q_{base}) and the dielectric 108 quality factor (Q_{σ}_{ₑ}) can be unaffected by the geometry of the QWCCR structure 100 (both in terms of

$$\frac{b}{a}$$

and in terms of

$$\frac{b}{λ} ) .$$

The QWCCR structure 100 can also radiate electromagnetic waves (for example, from a distal, non-closed end opposite the base conductor 110). For example, if the QWCCR structure 100 is being excited by an RF power source (for example, a signal generator oscillating at radio frequencies), the QWCCR structure 100 can radiate microwaves from a distal end (for example, from an aperture of the distal end) of the QWCCR structure 100. Such radiation can lead to power losses, which can be approximated using admittance. Assuming that the transverse dimensions of the QWCCR structure 100 are significantly smaller than the wavelength (λ) being used to excite the QWCCR structure 100 (in other words, a<<λ and b<<λ), the real part (Gᵣ) and imaginary part (Bᵣ) of admittance can be represented by:

$${G}_{r} \approx \frac{4 \cdot {π}^{5} \cdot {[ {( \frac{( \frac{b}{λ} )}{( \frac{b}{a} )} )}^{2} - {( \frac{b}{λ} )}^{2} ]}^{2}}{3 \cdot η \cdot {ln}^{2} ( \frac{b}{a} )}$$

$${B}_{r} \approx \frac{16 \cdot π \cdot ( \frac{( \frac{b}{λ} )}{( \frac{b}{a} )} - ( \frac{b}{λ} ) )}{η \cdot {ln}^{2} ( \frac{b}{a} )} \cdot [ E ( \frac{2 \sqrt{( \frac{b}{a} )}}{1 + ( \frac{b}{a} )} ) - 1 ]$$

where E(x) is the complete elliptical integral of the second kind. Namely:

$$E ( x ) = {\int }_{0}^{\frac{π}{2}} \sqrt{1 - {x}^{2} \cdot {sin}^{2} ( θ )} \cdot d θ$$

Further, the line integral of the electric field from the inner conductor 104 to the outer conductor 102 can be used to determine the potential difference (V_{ab}) across the shunt admittance corresponding to the electromagnetic waves radiated.

$${V}_{ab} {\vert}_{β z = \frac{π}{4}} = {\int }_{a \to b} {E}_{r} = \frac{{V}_{0} ln ( \frac{b}{a} )}{2 π}$$

Using the potential difference (V_{ab}) across the shunt admittance corresponding to the electromagnetic waves radiated, the power going to radiation (P_{rad}) can be represented by:

$${P}_{rad} = \frac{1}{2} {G}_{r} {V}_{ab}^{2} = \frac{{V}_{0} {{{π}^{3} ( \frac{b}{λ} )}^{4} [ {( \frac{b}{a} )}^{2} - 1 ]}^{2}}{6 {η ( \frac{b}{a} )}^{4}}$$

In addition, using the potential difference (V_{ab}) across the shunt admittance corresponding to the electromagnetic waves radiated, the energy stored during radiation (U_{rad}) can be represented by:

$${U}_{rad} = \frac{1}{4} ( \frac{{B}_{r}}{ω} ) {V}_{ab}^{2} = \frac{{ɛV}_{0}^{2} λ ( \frac{b}{λ} ) [ {( \frac{b}{a} )}^{- 1} + 1 ]}{2 {π}^{2}} [ E ( \frac{2 \sqrt{\frac{b}{a}}}{1 + \frac{b}{a}} ) - 1 ]$$

Based on the above, the overall quality factor of the QWCCR structure 100 (Q_{QWCCR}) can be described by the following:

$${Q}_{QWCCR} = \frac{ω ( U + {U}_{rad} )}{{P}_{inner} + {P}_{outer} + {P}_{base} + {P}_{{σ}_{e}} + {P}_{rad}}$$

If the energy stored during radiation (U_{rad}) is small compared with the energy stored in the interior of the QWCCR structure 100 (U), the radiation power (P_{rad}) can be treated similarly to the other losses. Further, the energy stored during radiation (U_{rad}) can be neglected in the above equation:

$$Q \approx \frac{ω ( U )}{{P}_{inner} + {P}_{outer} + {P}_{base} + {P}_{{σ}_{e}} + {P}_{rad}}$$

Still further, the quality factor of the radiation component (Q_{rad}) can be described using the above relationship for quality factors:

$${Q}_{rad} = \frac{ω U}{{P}_{rad}} = \frac{3 {( \frac{b}{λ} )}^{4} ln ( \frac{b}{a} )}{8 {{{π}^{3} ( \frac{b}{λ} )}^{4} [ {( \frac{b}{a} )}^{2} - 1 ]}^{2}}$$

Even further, using the above-referenced quality factors, the total quality factor of the QWCCR structure 100 (Q_{QWCCR}) can be approximated by:

$${Q}_{QWCCR} \approx {( \frac{8 {{{π}^{3} ( \frac{b}{λ} )}^{4} [ {( \frac{b}{a} )}^{2} - 1 ]}^{2}}{3 {( \frac{b}{a} )}^{4} ln ( \frac{b}{a} )} + \frac{{R}_{S}}{2 πη} [ \frac{( ( \frac{b}{a} ) + 1 )}{( \frac{b}{λ} ) ln ( \frac{b}{a} )} + 8 ] + tan ( {δ}_{e} ) )}^{- 1}$$

Based on the above relationships, it can be shown that one method of minimizing losses due to radiation of electromagnetic waves by the QWCCR structure 100 is to minimize the inner radius b of the outer conductor 102 with respect to the excitation wavelength (λ). Another way of minimizing losses due to radiation of electromagnetic waves is to select an inner radius b of the outer conductor 102 that is close in dimension to the radius a of the inner conductor 104.

Various physical quantities and dimensions of the QWCCR structure 100 can be adjusted to modify performance of the QWCCR structure 100. For example, physical quantities and dimensions can be modified to maximize and/or optimize the total quality factor of the QWCCR structure 100 (Q_{QWCCR}). In some implementations, different dielectrics can be inserted into the QWCCR structure 100. In one implementation, the dielectric 108 can include a composite of multiple dielectric materials. For example, a half of the dielectric 108 near a proximal end of the QWCCR structure 100 can include alumina ceramic while a half of the dielectric 108 near a distal end of the QWCCR structure 100 can include air. The resonant frequency can be based on the dimensions and the fabrication materials of the QWCCR structure 100. Hence, modification of the dielectric 108 can modify a resonant frequency of the QWCCR structure 100. In some implementations, the resonant frequency can be 2.45 GHz based on the dimensions of the QWCCR structure 100. In other implementations, the resonant frequency of the QWCCR structure 100 could be within an inclusive range between 1 GHz to 100 GHz. In still other implementations, the resonant frequency of the QWCCR structure 100 could be within an inclusive range of 100 MHz to 1 GHz or an inclusive range of 100 GHz to 300 GHz. However, other resonant frequencies are contemplated within the context of the present disclosure.

An RF power source exciting the QWCCR structure 100 can generate a standing electromagnetic wave within the QWCCR structure 100. In some implementations, the resonant frequency of the QWCCR structure 100 can be designed to match the frequency of an RF power source that is exciting the QWCCR structure 100 (for example, to maximize power transferred to the QWCCR structure 100). For example, if a desired excitation frequency corresponds to a wavelength of λ₀, dimensions of the QWCCR structure 100 can be modified such that the electrical length of the QWCCR structure 100 is an odd-integer multiple of quarter wavelengths (for example, ¼λ₀, ¾λ₀, 5/4λ₀, 7/4λ₀, 9/4λ₀, 11/4λ₀, 13/4λ₀, etc.). The electrical length is a measure of the length of a resonator in terms of the wavelength of an electromagnetic wave used to excite the resonator. The QWCCR structure 100 can be designed for a given resonant frequency based on the dimensions of the QWCCR structure 100 (for example, adjusting dimensions of the inner conductor 104, the outer conductor 102, or the dielectric 108) or the materials of the QWCCR structure 100 (for example, adjusting materials of the inner conductor 104, the outer conductor 102, or the dielectric 108).

In other implementations, the resonant frequency of the QWCCR structure 100 can be designed or adjusted such that its resonant frequency does not match the frequency of an RF power source that is exciting the QWCCR structure 100 (for example, to reduce power transferred to the QWCCR structure 100). Analogously, the frequency of an RF power source can be de-tuned relative to the resonant frequency of a QWCCR structure 100 that is being excited by the RF power source. Additionally or alternatively, the physical quantities and dimensions of the QWCCR structure 100 can be modified to enhance the amount of energy radiated (for example, from the distal end) in the form of electromagnetic waves (for example, microwaves) from the QWCCR structure 100. As an example, one or more elements of the QWCCR structure 100 could be movable or otherwise adjustable so as to modify the resonant properties of the QWCCR structure 100. Enhancing the amount of energy radiated might be done at the expense of maximizing the electric field at a concentrator of the electrode 106 at the distal end of the inner conductor 104. For example, some implementations can include slots or openings in the outer conductor 102 to increase the amount of radiated energy despite possibly reducing a quality factor of the QWCCR structure 100.

In still other implementations, the physical quantities and dimensions of the QWCCR structure 100 can be designed in such a way so as to enhance the intensity of an electric field at a concentrator of the electrode 106 of the QWCCR structure 100. Enhancing the electric field at a concentrator of the electrode 106 of the QWCCR structure 100 can result in an increase in plasma corona excitation (for example, an increase in dielectric breakdown near the concentrator), when the QWCCR structure 100 is excited with sufficiently high RF power/current. To increase electric field at a concentrator of the electrode 106 of the QWCCR structure 100, a radius of the concentrator can be minimized (for example, configured as a very sharp structure, such as a tip). Additionally or alternatively, to increase the electric field at a tip of the QWCCR structure 100 (for example, thereby increasing the intensity and/or size of an excited plasma corona), the intrinsic impedance (η) of the dielectric 108 can be increased, the power used to excite the QWCCR structure 100 can be increased, and the total quality factor of the QWCCR structure 100 (Q_{QWCCR}) can be increased (for example, by increasing the volume energy storage (U) of the cavity or by minimizing the surface and radiation losses).

Further, the shunt capacitance (C) of a circular coaxial cavity (for example, in farads/meter, and neglecting fringing fields) can be expressed as follows:

$$C = \frac{2 {πɛ}_{o} {ɛ}_{r}}{ln ( \frac{b}{a} )}$$

where ε₀ represents the permittivity of free space, εᵣ represents the relative dielectric constant of the dielectric 108 between the inner conductor 104 and the outer conductor 102, b is the inner radius of the outer conductor 102, and a is the radius of the inner conductor 104 (as illustrated in FIG. 1D).

Similarly, the shunt inductance (L) of a circular coaxial cavity (for example, in henrys/meter) can be expressed as follows:

$$L = \frac{{μ}_{0} {μ}_{r}}{2 π} ln ( \frac{b}{a} )$$

where μ₀ represents the permeability of free space, μᵣ represents the relative permeability of the dielectric 108 between the inner conductor 104 and the outer conductor 102, b is the inner radius of the outer conductor 102, and a is the radius of the inner conductor 104 (as illustrated in FIG. 1D).

Based on the above, the complex impedance (Z) of a circular coaxial cavity (for example, in ohms, Ω) can be expressed as follows:

$$Z = \sqrt{\frac{R + j ω L}{G + j ω C}}$$

where G represents the conductance per unit length of the dielectric between the inner conductor and the outer conductor, R represents the resistance per unit length of the QWCCR structure 100, j represents the imaginary unit (for example, \sqrt{−1}), ω represents the frequency at which the QWCCR structure 100 is being excited, L represents the shunt inductance of the QWCCR structure 100, and C represents the shunt capacitance of the QWCCR structure 100.

At very high frequencies (for example, GHz frequencies) the complex impedance (Z) can be approximated by:

$${Z}_{0} = \sqrt{\frac{L}{C}}$$

where Z₀ represents the characteristic impedance of the QWCCR structure 100 (in other words, the complex impedance (Z) of the QWCCR structure 100 at high frequencies).

As described above, the shunt inductance (L) and the shunt capacitance (C) of the QWCCR structure 100 depend on the relative permeability (μᵣ) and the relative dielectric constant (εᵣ), respectively, of the dielectric 108 between the inner conductor 104 and the outer conductor 102. Thus, any modification to either the relative permeability (μᵣ) or the relative dielectric constant (Eᵣ) of the dielectric 108 between the inner conductor 104 and the outer conductor 102 can result in a modification of the characteristic impedance (Z₀) of the QWCCR structure 100. Such modifications to impedance can be measured using an impedance measurement device (for example, an oscilloscope, a spectrum analyzer, and/or an AC volt meter).

The above characteristic impedance (Z₀) represents an impedance calculated by neglecting fringing fields. In some applications and implementations, the fringing fields can be non-negligible (for example, the fringing fields can significantly impact the impedance of the QWCCR structure 100). Further, in such implementations, the composition of the materials surrounding the QWCCR structure 100 can affect the characteristic impedance (Z₀) of the QWCCR structure 100. Measurements of such changes to characteristic impedance (Z₀) can provide information regarding the environment (for example, a combustion chamber) surrounding the QWCCR structure 100 (for example, the temperature, pressure, or atomic composition of the environment). A change in the characteristic impedance (Z₀) can coincide with a change in the cutoff frequency, resonant frequency, short-circuit condition, open-circuit condition, lumped-circuit model, mode distribution, etc. of the QWCCR structure 100.

FIG. 1G illustrates a quarter-wave resonance condition of the QWCCR structure 100. The y-axis of the plot corresponds to a power of electromagnetic waves radiated from a distal end of the QWCCR structure 100 and the x-axis corresponds to an excitation frequency (ω) (for example, from a radio-frequency power source that is electromagnetically coupled to the QWCCR structure 100) used to excite the QWCCR structure 100. As illustrated, the shape of the curve can be a Lorentzian.

As illustrated in FIG. 1G the curve has a maximum power at a quarter-wave (λ/4) resonance. This resonance can correspond to excitation frequency (ω) that has an associated excitation wavelength that is four times the length of the QWCCR structure 100. In other words, at the resonant frequency (ω₀) the QWCCR structure 100 is being excited by a standing wave, where one-quarter of the length of the standing wave is equal to the length of the QWCCR structure 100. Although not illustrated, it is understood that the QWCCR structure 100 could experience additional resonances (for example, at odd-integer multiples of the resonant wavelength: ¾λ₀, 5/4λ₀, 7/4λ₀, 9/4λ₀, 11/4λ₀, 13/4λ₀, etc.). Each of the additional resonances could look similar to the resonance illustrated in FIG. 1G (for example, could have a Lorentzian shape).

As illustrated, the power of the electromagnetic waves radiated from the distal end of the QWCCR structure 100 decreases exponentially the further the excitation frequency (ω) is from the resonant frequency (ω₀). However, the power of the electromagnetic waves is not necessarily zero as soon as you move away from resonance. Hence, it is understood that even when excited near the quarter-wave resonance condition (in other words, proximate to the quarter-wave resonance condition), rather than exactly at the resonance condition, the QWCCR structure 100 can still radiate electromagnetic waves with non-zero power and/or provide a plasma corona, depending on arrangement.

When the QWCCR structure 100 is being excited such that it provides a plasma corona proximate to the distal end (for example, at the electrode 106), a plot with a shape similar to that of FIG. 1G could be provided. In such a scenario, a plot of voltage at the electrode 106 versus excitation frequency (ω) could include a Gaussian shape, rather than a Lorentzian shape. In other words, the voltage at the electrode 106 may reach a peak when excited by a resonant frequency. The voltage at the electrode 106 may fall off exponentially according to a Gaussian shape as the excitation frequency moves away from the resonant frequency. It will be understood that the Gaussian and Lorentzian shapes presently described may be based on one or more characteristics of the QWCCR structure 100, such as its shape, quality factor, bias conditions, or other factors.

It is understood that when the term “proximate” is used to describe a relationship between a wavelength of a signal (for example, a signal used to excite the QWCCR structure 100) and a resonant wavelength of a resonator (for example, the QWCCR structure 100), the term “proximate” can describe a difference in length. For example, if the wavelength of the signal is “proximate to an odd-integer multiple of one-quarter of the resonant wavelength,” the wavelength of the signal can be equal to, within 0.001% of, within 0.01% of, within 0.1% of, within 1.0% of, within 5.0% of, within 10.0% of, within 15.0% of, within 20.0% of, and/or within 25.0% of one-quarter of the resonant wavelength. Additionally or alternatively, if the wavelength of the signal is “proximate to an odd-integer multiple of one-quarter of the resonant wavelength,” the wavelength of the signal can be within 0.1 nm, within 1.0 nm, within 10.0 nm, within 0.1 micrometers, within 1.0 micrometers, within 10.0 micrometers, within 0.1 millimeters, within 1.0 millimeters, and/or within 1.0 centimeters of one-quarter of the resonant wavelength, depending on context (for example, depending on the resonant wavelength). Still further, if the wavelength of the signal is “proximate to an odd-integer multiple of one-quarter of the resonant wavelength,” the wavelength of the signal can be a multiple of one-quarter of the resonant wavelength that is an odd number plus or minus 0.5, an odd number plus or minus 0.1, an odd number plus or minus 0.01, an odd number plus or minus 0.001, and/or an odd number plus or minus 0.0001.

The quality factor of the QWCCR structure 100 (Q_{QWCCR}), described above, can be used to describe the width and/or the sharpness of the resonance (in other words, how quickly the power drops off as you excite the QWCCR structure 100 further and further from the resonance condition). For example, a square root of the quality factor can correspond to the voltage modification experienced at the electrode 106 of the QWCCR structure 100 when the QWCRR structure 100 is excited at the quarter-wave resonant condition. Additionally, the quality factor may be equal to the resonant frequency (ω₀) divided by full width at half maximum (FWHM). The FWHM is equal to the width of the curve in terms of frequency between the two points on the curve where the power is equal to 50% of the maximum power, as illustrated. The 50% power maximum point can also be referred to as the −3 decibel (dB) point, because it is the point at which the maximum voltage at the distal end of the QWCCR structure 100 decreases by 3 dB (or 29.29% for voltage) and the maximum power radiated by the QWCCR structure 100 decreases by 3 dB (or 50% for power). In various implementations, the FWHM of the QWCCR structure 100 could have various values. For example, the FWHM could be between 5 MHz and 10 MHz, between 10 MHz and 20 MHz, between 20 MHz and 40 MHz, between 40 MHz and 60 MHz, between 60 MHz and 80 MHz, or between 80 MHz and 100 MHz. Other FWHM values are also possible.

Further, the quality factor of the QWCCR structure 100 (Q_{QWCCR}) can also take various values in various implementations. For example, the quality factor could be between 25 and 50, between 50 and 75, between 75 and 100, between 100 and 125, between 125 and 150, between 150 and 175, between 175 and 200, between 200 and 300, between 300 and 400, between 400 and 500, between 500 and 600, between 600 and 700, between 700 and 800, between 800 and 900, between 900 and 1000, or between 1000 and 1100. Other quality factor values are also possible.

It is understood that, in alternate implementations, alternate structures (for example, alternate quarter-wave structures) can be used to emit electromagnetic radiation and/or excite plasma coronas (for example, other structures that concentrate electric field at specific locations using points or tips with sufficiently small radii). For example, other quarter-wave resonant structures, such as a coaxial-cavity resonator (sometimes referred to as a “coaxial resonator”), a dielectric resonator, a crystal resonator, a ceramic resonator, a surface-acoustic-wave resonator, an yttrium-iron-garnet resonator, a rectangular-waveguide cavity resonator, a parallel-plate resonator, a gap-coupled microstrip resonator, etc. can be used to excite a plasma corona.

Further, it is understood that wherever in this disclosure the terms “resonator,” “QWCCR,” “QWCCR structure,” and “coaxial resonator,” are used, any of the structures enumerated in the preceding paragraph could be used, assuming appropriate modifications are made to a corresponding system. In addition, the terms “resonator,” “QWCCR,” “QWCCR structure,” and “coaxial resonator” are not to be construed as inclusive or all-encompassing, but rather as examples of a particular structure that could be included in a particular implementation. Still further, when a “QWCCR structure” is described, the QWCCR structure can correspond to a coaxial resonator, a coaxial resonator with an additional base conductor, a coaxial resonator excited by a signal with a wavelength that corresponds to an odd-integer multiple of one-quarter (¼) of a length of the coaxial resonator, and other structures, in various implementations.

Additionally, whenever any “QWCCR,” “QWCCR structure,” “coaxial resonator,” “resonator,” or any of the specific resonators in this disclosure or in the claims are described as being “configured such that, when the resonator is excited by the radio-frequency power source with a signal having a wavelength proximate to an odd-integer multiple of one-quarter (¼) of the resonant wavelength, the resonator provides at least one of a plasma corona or electromagnetic waves,” some or all of the following are contemplated, depending on context. First, the corresponding resonator could be configured to provide a plasma corona when excited by the radio-frequency power source with a signal having a wavelength proximate to an odd-integer multiple of one-quarter (¼) of a resonant wavelength of the resonator. Second, the corresponding resonator could be configured to provide electromagnetic waves when excited by the radio-frequency power source with a signal having a wavelength proximate to an odd-integer multiple of one-quarter (¼) of a resonant wavelength of the resonator. Third, the corresponding resonator could be configured to provide, when excited by the radio-frequency power source with a signal having a wavelength proximate to an odd-integer multiple of one-quarter (¼) of a resonant wavelength of the resonator, both a plasma corona and electromagnetic waves.

### V. Example Resonator Systems

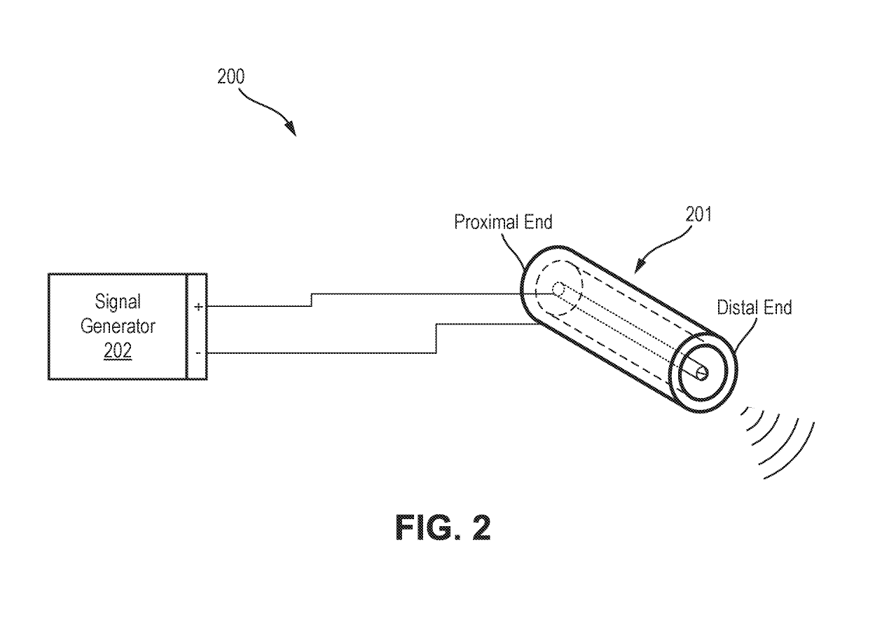

In some implementations, the coaxial resonator 201 can be used as an antenna (for example, instead of or in addition to generating a plasma corona). As an antenna, the coaxial resonator 201 can radiate electromagnetic waves. The electromagnetic waves can consequently influence charged particles. As illustrated in the system 200 of FIG. 2, such electromagnetic waves can be radiated when the coaxial resonator 201 is excited by a signal generator 202. For example, the signal generator 202 can be coupled to the coaxial resonator 201 in order to excite the coaxial resonator 201 (for example, to excite a plasma corona and to produce electromagnetic waves). Such a coupling can include inductive coupling (for example, using an induction feed loop), parallel capacitive coupling (for example, using a parallel plate capacitor), or non-parallel capacitive coupling (for example, using an electric field applied opposite a non-zero voltage conductor end). Further, the electrical distance between the signal generator 202 and the coaxial resonator 201 can be optimized (for example, minimized or adjusted based on wavelength of an RF signal) in order to minimize the amount of energy lost to heating and/or to maximize a quality factor. Further, in some implementations, the coaxial resonator 201 can radiate acoustic waves when excited (for example, at resonance). The acoustic waves produced can induce motion in nearby particles, for example.

The signal generator 202 can be a device that produces periodic waveforms (for example, using an oscillator circuit). In various implementations, the signal generator 202 can produce a sinusoidal waveform, a square waveform, a triangular waveform, a pulsed waveform, or a sawtooth waveform. Further, the signal generator 202 can produce waveforms with various frequencies (for example, frequencies between 1 Hz and 1 THz). The electromagnetic waves radiated from the coaxial resonator 201 can be based on the waveform produced by the signal generator 202. For example, if the waveforms produced by the signal generator 202 are sinusoidal waves having frequencies between 300 MHz and 300 GHz (for example, between 1 GHz and 100 GHz), the electromagnetic waves radiated by coaxial resonator 201 can be microwaves. In various implementations, the signal generator 202 can, itself, be powered by an AC power source or a DC power source.

Depending on the signal used by the signal generator 202 to excite the coaxial resonator 201, the coaxial resonator 201 can additionally excite one or more plasma coronas. For example, if a large enough voltage is used to excite the coaxial resonator 201, a plasma corona can be excited at the distal end of the electrode 106 (for example, at a concentrator of the electrode 106). In some implementations, a voltage step-up device can be electrically coupled between the signal generator 202 and the coaxial resonator 201. In such scenarios, the voltage step-up device can be operable to increase an amplitude of the AC voltage used to excite the coaxial resonator 201.

In some implementations, the signal generator 202 can include one or more of the following: an internal power supply; an oscillator (for example, an RF oscillator, a surface acoustic wave resonator, or an yttrium-iron-garnet resonator); and an amplifier. The oscillator can generate a time-varying current and/or voltage (for example, using an oscillator circuit). The internal power supply can provide power to the oscillator. In some implementations, the internal power supply can include, for example, a DC battery (for example, a marine battery, an automotive battery, an aircraft battery, etc.), an alternator, a generator, a solar cell, and/or a fuel cell. In other implementations, the internal power supply can include a rectified AC power supply (for example, an electrical connection to a wall socket passed through a rectifier). The amplifier can magnify the power that is output by the oscillator (for example, to provide sufficient power to the coaxial resonator 201 to excite plasma coronas). For example, the amplifier can multiply the current and/or the voltage output by the oscillator. Additionally, in some implementations, the signal generator 202 can include a dedicated controller that executes instructions to control the signal generator 202.

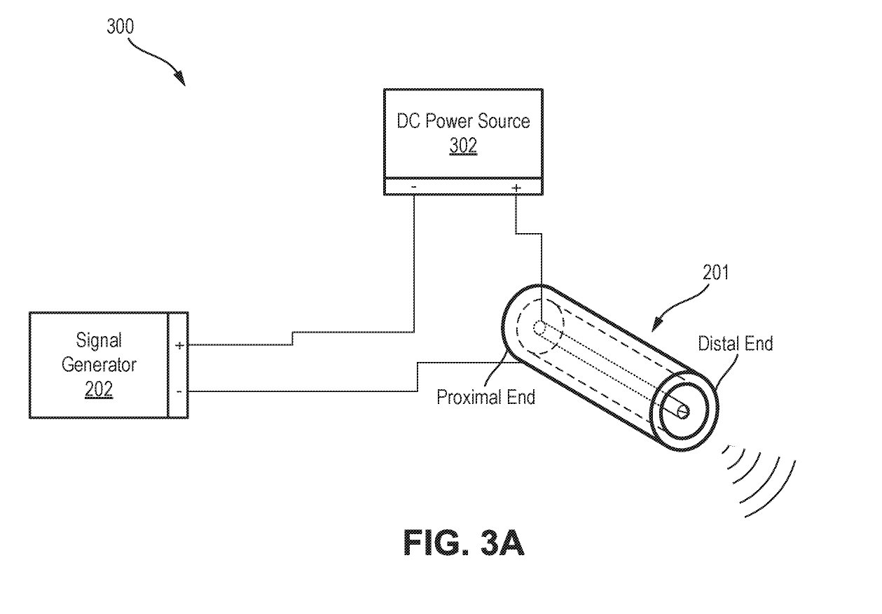

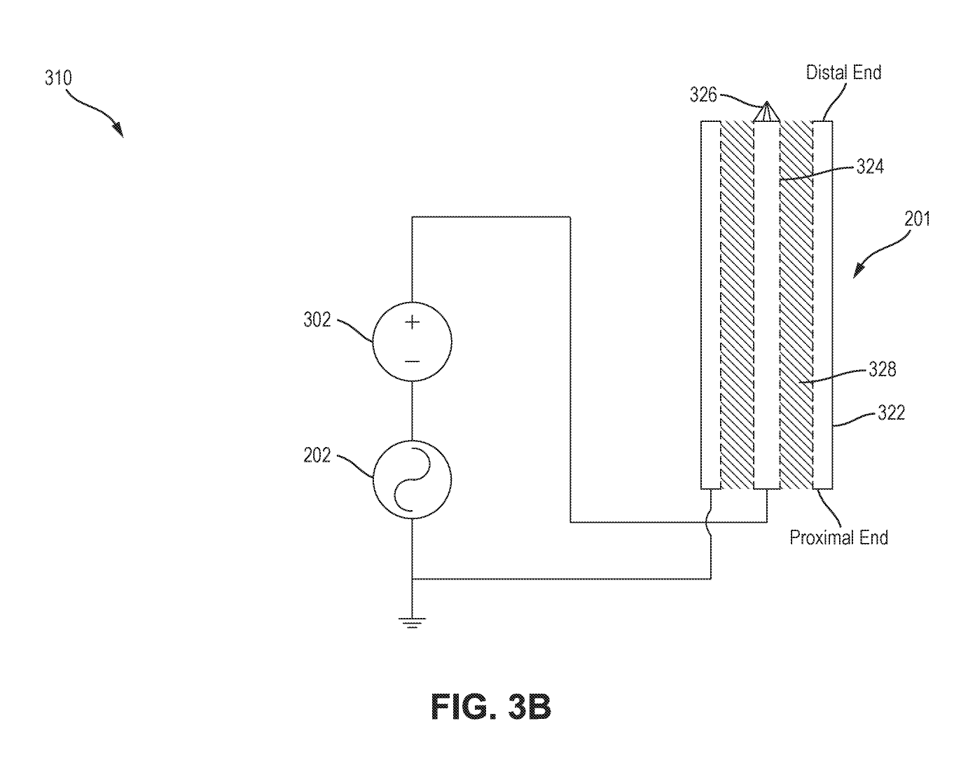

Additionally or alternatively, as illustrated in the system 300 of FIG. 3A, the coaxial resonator 201 can be electrically coupled (for example, using a wired connection or wirelessly) to a DC power source 302. Further, in some implementations, an RF cancellation resonator (not shown) can prevent RF power (for example, from the signal generator 202) from reaching, and potentially interfering with, the DC power source 302. The RF cancellation resonator can include resistive elements, lumped-element inductors, and/or a frequency cancellation circuit.

In some implementations, the DC power source 302 can include a dedicated controller that executes instructions to control the DC power source 302. The DC power source 302 can provide a bias signal (for example, corresponding to a DC bias condition) for the coaxial resonator 201. For example, a DC voltage difference between the inner conductor 104 and the outer conductor 102 of the coaxial resonator 201 in FIG. 3A can be established by the DC power source 302 by increasing the DC voltage of the inner conductor 104 and/or decreasing the DC voltage of the outer conductor 102 (given the orientation of the positive terminal and negative terminal of the DC power source 302). In other implementations, a DC voltage difference between the inner conductor 104 and the outer conductor 102 can be established by the DC power source 302 by decreasing the DC voltage of the inner conductor 104 and/or increasing the DC voltage of the outer conductor 102 (if the orientation of the positive terminal and negative terminal of the DC power source 302 in FIG. 3A were reversed). The bias signal (for example, the voltage of the bias signal and/or the current of the bias signal) output by the DC power source 302 can be adjustable.

By providing the coaxial resonator 201 with a bias signal, an increased voltage can be presented at a concentrator of the electrode 106, thereby yielding an increased electric field at the concentrator of the electrode 106. The total electric field at the concentrator can thus be a sum of the electric field from the bias signal of the DC power source 302 and the electric field from the signal generator 202 exciting the coaxial resonator 201 at a resonance condition (for example, exciting the coaxial resonator 201 at a quarter-wave resonance condition so the electric field of the signal from the signal generator 202 reaches a maximum at the distal end of the coaxial resonator 201). Because of this increased total electric field, an excitation of a plasma corona near the concentrator can be more probable.

As an alternative, rather than using a bias signal, the signal generator 202 can simply excite the coaxial resonator 201 using a higher voltage. However, this might use considerably more power than providing a bias signal and augmenting that bias signal with an AC voltage oscillation.

In some implementations, the DC power source 302 can be switchable (for example, can generate the bias signal when switched on and not generate the bias signal when switched off). As such, the DC power source 302 can be switched on when a plasma corona output is desired from coaxial resonator 201 and can be switched off when a plasma corona output is not desired from coaxial resonator 201. For example, the DC power source 302 can be switched on during an ignition sequence (for example, a sequence where fuel is being ignited within a combustion chamber to begin combustion), but switched off during a reforming sequence (for example, a sequence in which electromagnetic radiation is being used to chemically modify fuel). Further, in some implementations, the electric field at the concentrator of the electrode 106 used to initiate the plasma corona can be larger than the electric field at the concentrator used to sustain the plasma corona. Hence, in some implementations, the DC power source 302 can be switched on in order to excite the plasma corona, but switched off while the plasma corona is maintained by the signal from the signal generator 202.

In alternate implementations, the system 200 of FIG. 2 and/or the system 300 of FIG. 3A can include a plurality of coaxial resonators 201. If the system 200 of FIG. 2 includes a plurality of coaxial resonators 201, the plurality of coaxial resonators 201 can each be electrically coupled to the same signal generator (for example, such that each of the plurality of coaxial resonators 201 is excited by the same signal), can each be electrically coupled to a respective signal generator (for example, such that each of the plurality of coaxial resonators 201 is independently excited, thereby allowing for unique excitation frequency, power, etc. for each of the plurality of coaxial resonators 201), or one set of the plurality of coaxial resonators 201 can be connected to a common signal generator and another set of the plurality of coaxial resonators 201 can be connected to one or more other signal generators, which could be similar or different from signal generator 202. In implementations of the system 300 that include a plurality of coaxial resonators 201, each of the coaxial resonators 201 can be attached to a respective DC power source (for example, multiple instances of DC power source 302) and a common signal generator (for example, such that a bias signal can be independently switchable and/or adjustable for each coaxial resonator 201, while maintaining a common excitation waveform across all coaxial resonators 201 in the system 300), different signal generators and a common DC power source (for example, such that a bias signal can be jointly switchable across all coaxial resonators 201 in the system 300, while maintaining an independent excitation waveform for each coaxial resonator 201), or different DC power sources and different signal generators (for example, such that the bias signal is independently switchable for each coaxial resonator 201, while maintaining an independent excitation waveform for each coaxial resonator 201).

FIG. 3B illustrates a circuit diagram of the system 300 of FIG. 3A, which includes the signal generator 202, the DC power source 302, and the coaxial resonator 201 (illustrated in vertical cross-section). As illustrated, similar to the QWCCR structure 100, the coaxial resonator 201 includes an outer conductor 322, an inner conductor 324 (including an electrode 326), and a dielectric 328. In addition, when the DC power source 302 is switched off, the circuit illustrated in FIG. 3B may not be an open-circuit. Instead, the signal generator 202 can simply be shorted to the inner conductor 324 when the DC power source 302 is switched off. As illustrated, the outer conductor 322 can be electrically coupled to ground. Further, the signal generator 202 and the DC power source 302 can be connected in series, with their negative terminals connected to ground. The positive terminals of the signal generator 202 and the DC power source 302 can be electrically coupled to the inner conductor 324. Consequently, the electrode 326 can also be electrically coupled to the positive terminals through an electrical coupling between the inner conductor 324 and the electrode 326.

In alternate implementations, the negative terminals of the signal generator 202 and the DC power source 302 can instead be connected to the inner conductor 324 and the positive terminals can be connected to the outer conductor 322. In this way, the signal generator 202 and the DC power source 302 can instead apply a negative voltage (relative to ground) to the electrode 326 and/or inner conductor 324, rather than a positive voltage (relative to ground). Further, in some implementations, the negative terminals of the DC power source 302 and the signal generator 202 and/or the inner conductor 324 might not be grounded.

As stated above, the DC power source 302 can be switchable. In this way a positive bias signal or a negative bias signal can be selectively applied to the inner conductor 324 and/or the electrode 326 relative to the outer conductor 322. When the DC power source 302 is switched on, a bias condition can be present, and when the DC power source 302 is switched off, a bias condition might not be present. A bias signal provided by the DC power source 302 can increase the electric potential, and thus the electric field, at the electrode 326 (for example, at a concentrator of the electrode 106, such as a tip, edge, or blade). By increasing the electric field at the electrode 326, dielectric breakdown and potentially plasma excitation can be more prevalent. Thus, by switching on the DC power source 302, the amount of plasma excited at a plasma corona can be enhanced.

In some implementations, the voltage of the DC power source 302 can range from +1 kV to +100 kV. Alternatively, the voltage of the DC power source 302 can range from −1 kV to −100 kV. Even further, the voltage of the DC power source 302 can be adjustable in some implementations. Furthermore, the voltage of the DC power source 302 can be pulsed, ramped, etc. For example, the voltage can be adjusted by a controller connected to the DC power source 302. In such implementations, the voltage of the DC power source 302 can be adjusted by the controller according to sensor data (for example, sensor data corresponding to temperature, pressure, fuel composition, etc.).

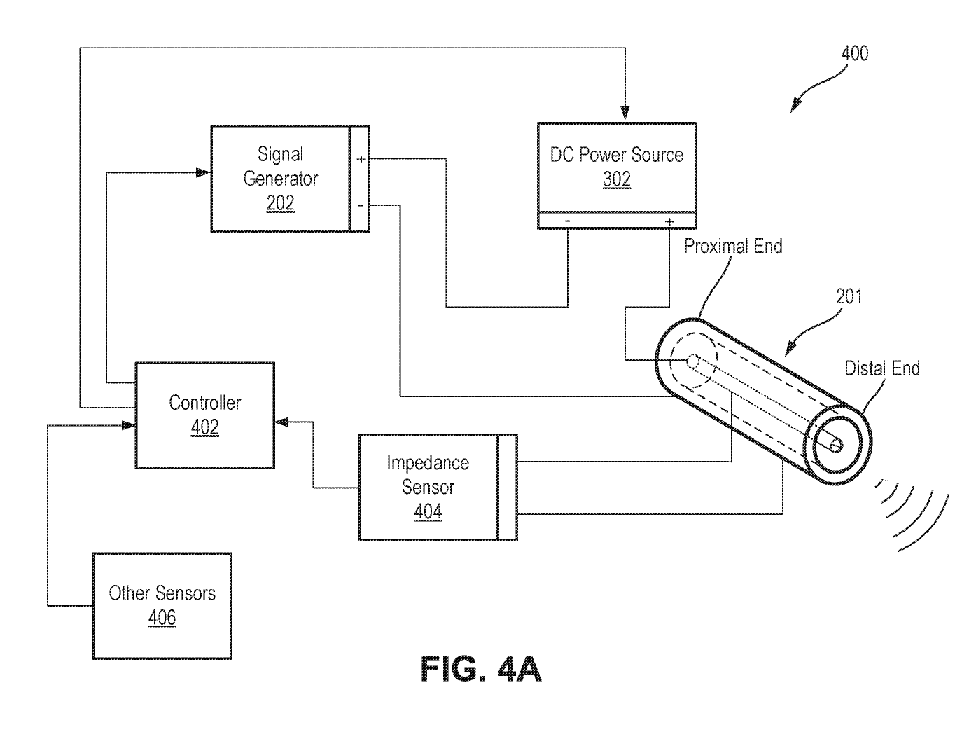

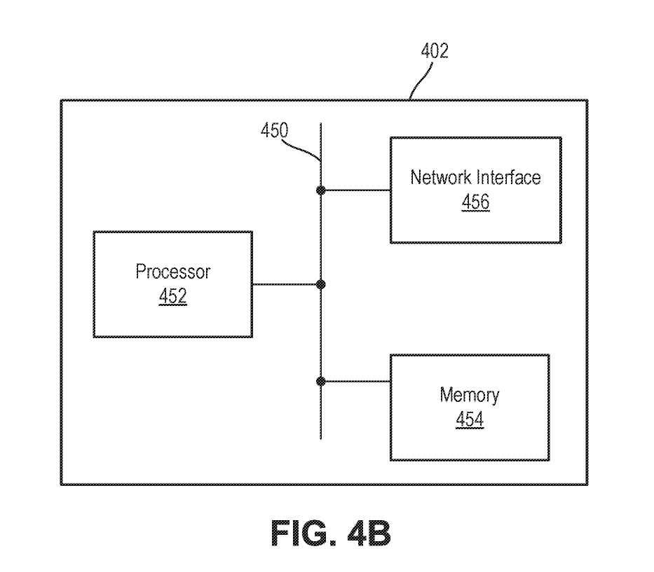

As illustrated in FIG. 4A, an example system 400 can include a controller 402. In various implementations, the controller 402 can include a variety of components. For example, the controller 402 can include a desktop computing device, a laptop computing device, a server computing device (for example, a cloud server), a mobile computing device, a microcontroller (for example, embedded within a control system of a power-generation turbine, an automobile, or an aircraft), and/or a microprocessor. As illustrated, the controller 402 can be communicatively coupled to the signal generator 202, the DC power source 302, an impedance sensor 404, and one or more other sensors 406. Through the communicative couplings, the controller 402 can receive signals/data from various components of the system 400 and control/provide data to various components of the system 400. For example, the controller 402 can switch the DC power source 302 in order to provide a time-modulated bias signal to the coaxial resonator 201 (for example, during an ignition sequence within a combustion chamber adjacent to, coupled to, or surrounding the coaxial resonator 201).

Further, a “communicative coupling,” as presently disclosed, is understood to cover a broad variety of connections between components, based on context. “Communicative couplings” can include direct and/or indirect couplings between components in various implementations. In some implementations, for example, a “communicative coupling” can include an electrical coupling between two (or more) components (for example, a physical connection between the two (or more) components that allows for electrical interaction, such as a direct wired connection used to read a sensor value from a sensor). Additionally or alternatively, a “communicative coupling” can include an electromagnetic coupling between two (or more) components (for example, a connection between the two (or more) components that allows for electromagnetic interaction, such as a wireless interaction based on optical coupling, inductive coupling, capacitive coupling, or coupling though evanescent electric and/or magnetic fields). In addition, a “communicative coupling” can include a connection (for example, over the public internet) in which one or more of the coupled components can transmit signals/data to and/or receive signals/data from one or more of the other coupled components. In various implementations, the “communicative coupling” can be unidirectional (in other words, one component sends signals and another component receives the signals) or bidirectional (in other words, both components send and receive signals). Other directionality combinations are also possible for communicative couplings involving more than two components. One example of a communicative coupling could be the controller 402 communicatively coupled to the coaxial resonator 201, where the controller 402 reads a voltage and/or current value from the resonator directly. Another example of a communicative coupling could be the controller 402 communicating with a remote server over the public Internet to access a look-up table. Additional communicative couplings are also contemplated in the present disclosure.

In some implementations, the controller 402 can control one or more settings of the signal generator 202 (for example, waveform shape, output frequency, output power amplitude, output current amplitude, or output voltage amplitude) or the DC power source 302 (for example, switching on or off or adjusting the level of the bias signal). For example, the controller 402 can control the bias signal of the DC power source 302 (for example, a voltage of the bias signal) based on a calculated voltage used to excite a plasma corona (for example, based on conditions within a combustion chamber). The calculated voltage can account for the voltage amplitude being output by the signal generator 202, in some implementations. The calculated voltage can ensure, for example, that the bias signal has a small effect on any standing electromagnetic wave formed within the coaxial resonator 201 based on an output of the signal generator 202.

The controller 402 can be located nearby the signal generator 202, the DC power source 302, the impedance sensor 404, and/or the one or more other sensors 406. For example, the controller 402 may be connected by a wire connection to the signal generator 202, the DC power source 302, the impedance sensor 404, and/or the one or more other sensors 406. Alternatively, the controller 402 can be remotely located relative to the signal generator 202, the DC power source 302, the impedance sensor 404, and/or the one or more other sensors 406. For example, the controller 402 can communicate with the signal generator 202, the DC power source 302, the impedance sensor 404, and/or the one or more other sensors 406 over BLUETOOTH®, over BLUETOOTH LOW ENERGY (BLE)®, over the public Internet, over WIFI® (IEEE 802.11 standards), over a wireless wide area network (WWAN), etc.

In some implementations, the controller 402 can be communicatively coupled to fewer components within the system 400 (for example, only communicatively coupled to the DC power source 302). Further, in implementations that include fewer components than illustrated in the system 400 (for example, in implementations, having only the coaxial resonator 201, the signal generator 202, and the controller 402), the controller 402 can interact with fewer components of the system 400. For instance, the controller can interact only with the signal generator 202.

The impedance sensor 404 can be connected to the coaxial resonator 201 (for example, one lead to the inner conductor 324 of the coaxial resonator 201 and one lead to the outer conductor 322 of the coaxial resonator 201) to measure an impedance of the coaxial resonator 201. In some implementations, the impedance sensor 404 can include an oscilloscope, a spectrum analyzer, and/or an AC volt meter. The impedance measured by the impedance sensor 404 can be transmitted to the controller 402 (for example, as a digital signal or an analog signal). In some implementations, the impedance sensor 404 can be integrated with the controller 402 or connected to the controller 402 through a printed circuit board (PCB) or other mechanism. The impedance data can be used by the controller 402 to perform calculations and to adjust control of the signal generator 202 and/or the DC power source 302.

Similarly, the other sensors 406 can also transmit data to the controller 402. Analogous to the impedance sensor 404, in some implementations, the other sensors 406 can be integrated with the controller 402 or connected to the controller 402 through a PCB or other mechanism. The other sensors 406 can include a variety of sensors, such as one or more of: a fuel gauge, a tachometer (for example, to measure revolutions per minute (RPM)), an altimeter, a barometer, a thermometer, a sensor that measures fuel composition, a gas chromatograph, a sensor measuring fuel-to-air ratio in a given fuel/air mixture, an anemometer, a torque sensor, a vibrometer, an accelerometer, or a load cell.

In some implementations, the controller 402 can be powered by the DC power source 302. In other implementations, the controller 402 can be independently powered by a separate DC power source or an AC power source (for example, rectified within the controller 402).

As an example, a possible implementation of the controller 402 is illustrated in FIG. 4B. As illustrated, the controller 402 can include a processor 452, a memory 454, and a network interface 456. The processor 452, the memory 454, and the network interface 456 can be communicatively coupled over a system bus 450. The system bus 450, in some implementations, can be defined within a PCB.

The processor 452 can include one or more central processing units (CPUs), such as one or more general purpose processors and/or one or more dedicated processors (for example, application-specific integrated circuits (ASICs), digital signal processors (DSPs), or network processors). The processor 452 can be configured to execute instructions (for example, instructions stored within the memory 454) to perform various actions. Rather than a processor 452, some implementations can include hardware logic (for example, one or more resistor-inductor-capacitor (RLC) circuits, flip-flops, latches, etc.) that performs actions (for example, based on the inputs from the impedance sensor 404 or the other sensors 406).

The memory 454 can store instructions that are executable by the processor 452 to carry out the various methods, processes, or operations presently disclosed. Alternatively, the method, processes, or operations can be defined by hardware, firmware, or any combination of hardware, firmware, or software. Further, the memory 454 can store data related to the signal generator 202 (for example, control signals), the DC power source 302 (for example, switching signals), the impedance sensor 404 (for example, look-up tables related to changes in impedance and/or a characteristic impedance of the coaxial resonator 201 based on certain environmental factors), and/or the other sensors 406 (for example, a look-up table of typical wind speeds based on elevation).

The memory 454 can include non-volatile memory. For example, the memory 454 can include a read-only memory (ROM), electrically erasable programmable read-only memory (EEPROM), a hard drive (for example, hard disk), and/or a solid-state drive (SSD). Additionally or alternatively, the memory 454 can include volatile memory. For example, the memory 454 can include a random-access memory (RAM), flash memory, dynamic random-access memory (DRAM), and/or static random-access memory (SRAM). In some implementations, the memory 454 can be partially or wholly integrated with the processor 452.

The network interface 456 can enable the controller 402 to communicate with the other components of the system 400 and/or with outside computing device(s). The network interface 456 can include one or more ports (for example, serial ports) and/or an independent network interface controller (for example, an Ethernet controller). In some implementations, the network interface 456 can be communicatively coupled to the impedance sensor 404 or one or more of the other sensors 406. Additionally or alternatively, the network interface 456 can be communicatively coupled to the signal generator 202, the DC power source 302, or an outside computing device (for example, a user device). Communicative couplings between the network interface 456 and other components can be wireless (for example, over WIFI®, BLUETOOTH®, BLUETOOTH LOW ENERGY (BLE)®, or a WWAN) or wireline (for example, over token ring, t-carrier connection, Ethernet, a trace in a PCB, or a wire connection).

In some implementations, the controller 402 can also include a user-input device (not shown). For example, the user-input device can include a keyboard, a mouse, a touch screen, etc. Further, in some implementations, the controller 402 can include a display or other user-feedback device (for example, one or more status lights, a speaker, a printer, etc.) (not shown). That status of the controller 402 can alternatively be provided to a user device through the network interface 456. For example, a user device such as a personal computer or a mobile computing device can communicate with the controller 402 through the network interface 456 to retrieve the values of one or more of the other sensors 406 (for example, to be displayed on a display of the user device).

### VI. Resonators with Fuel Injection

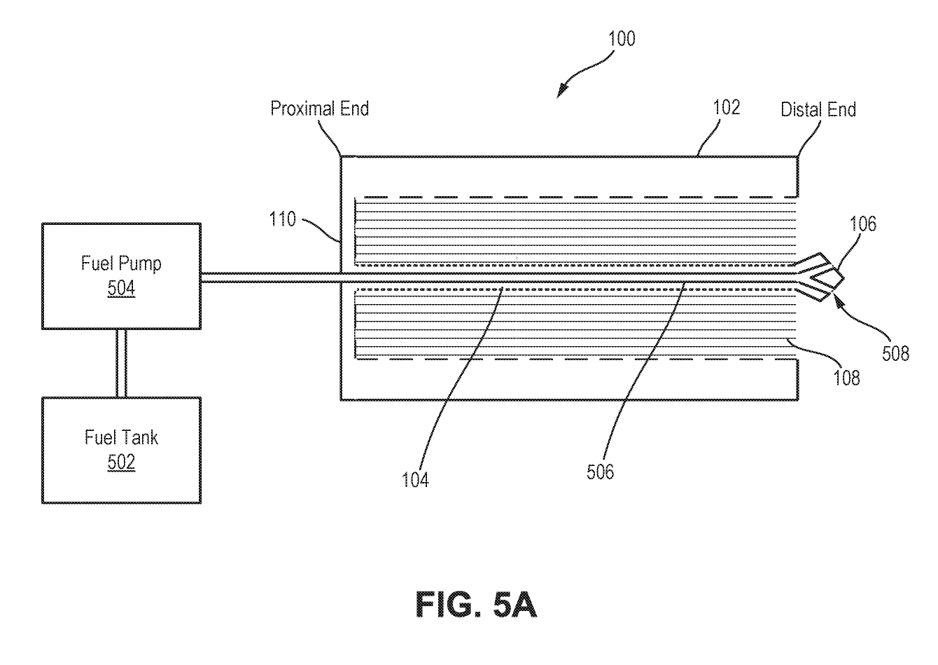

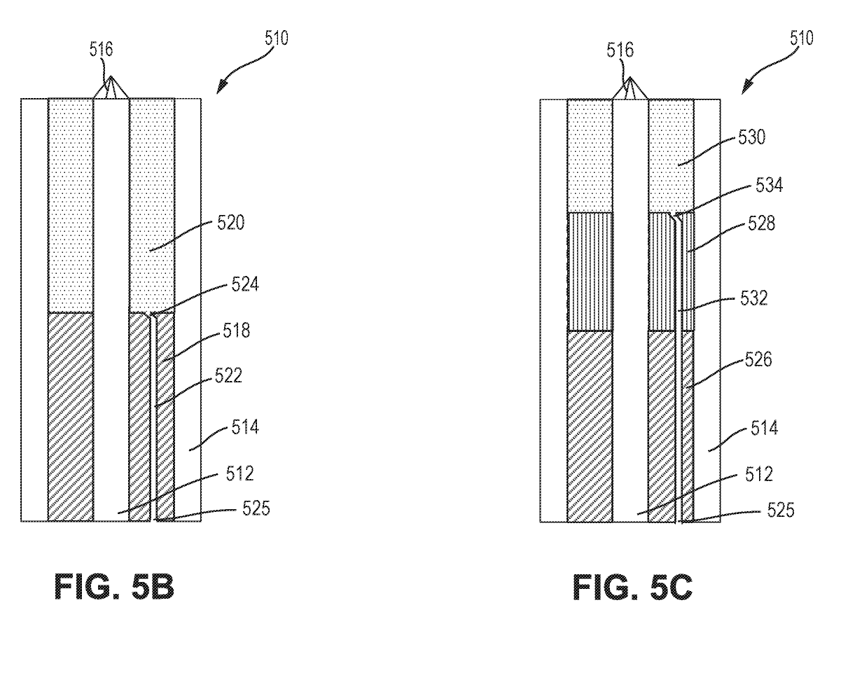

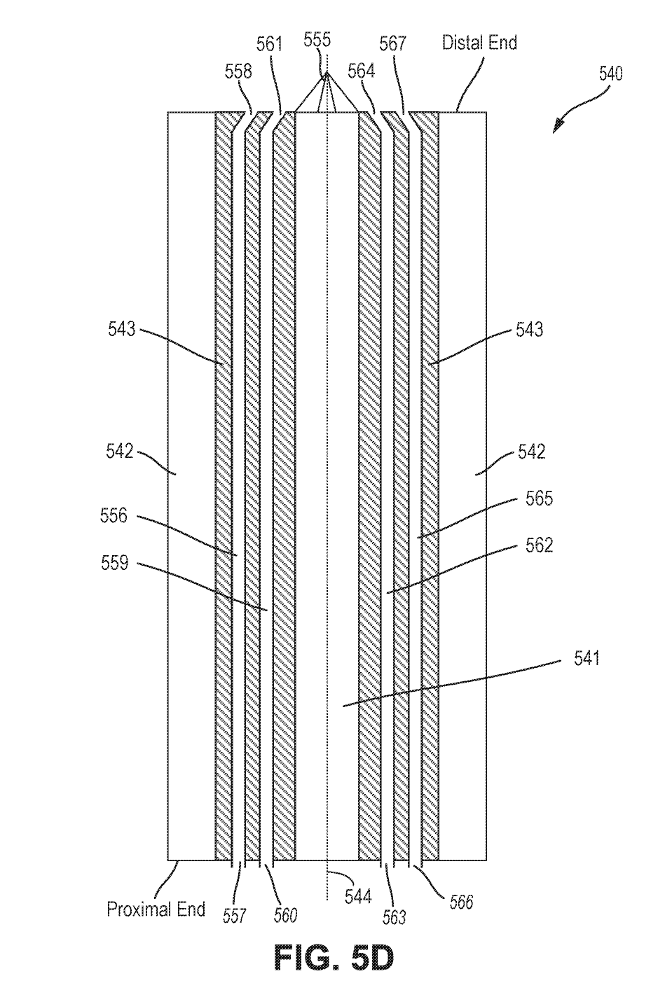

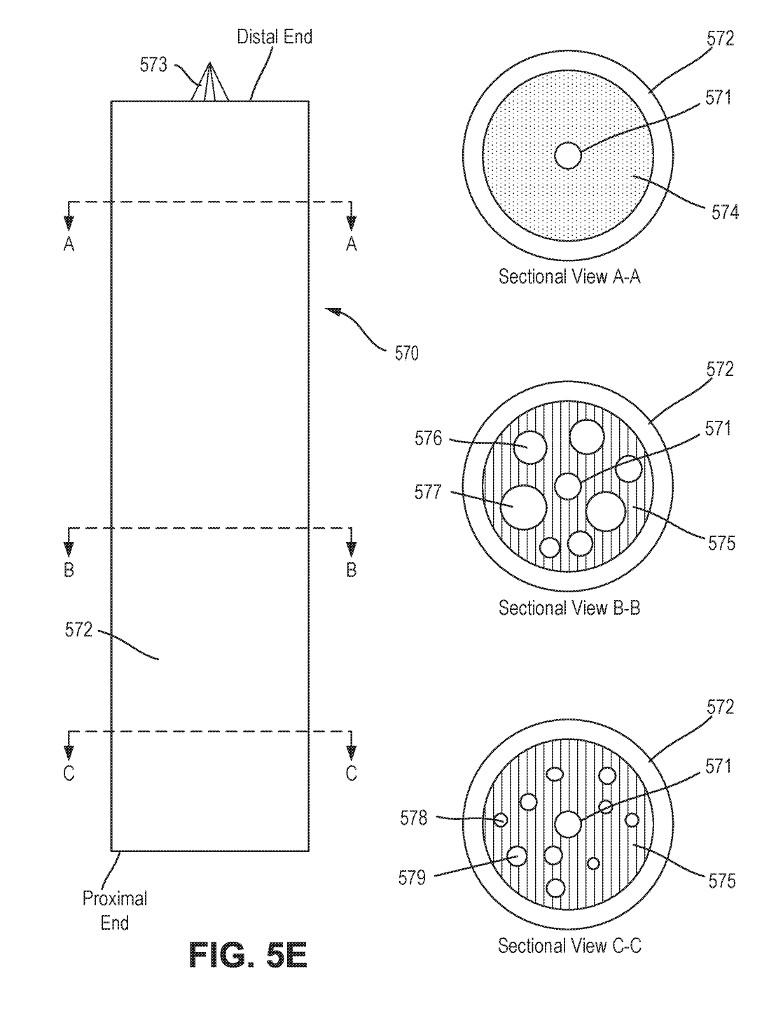

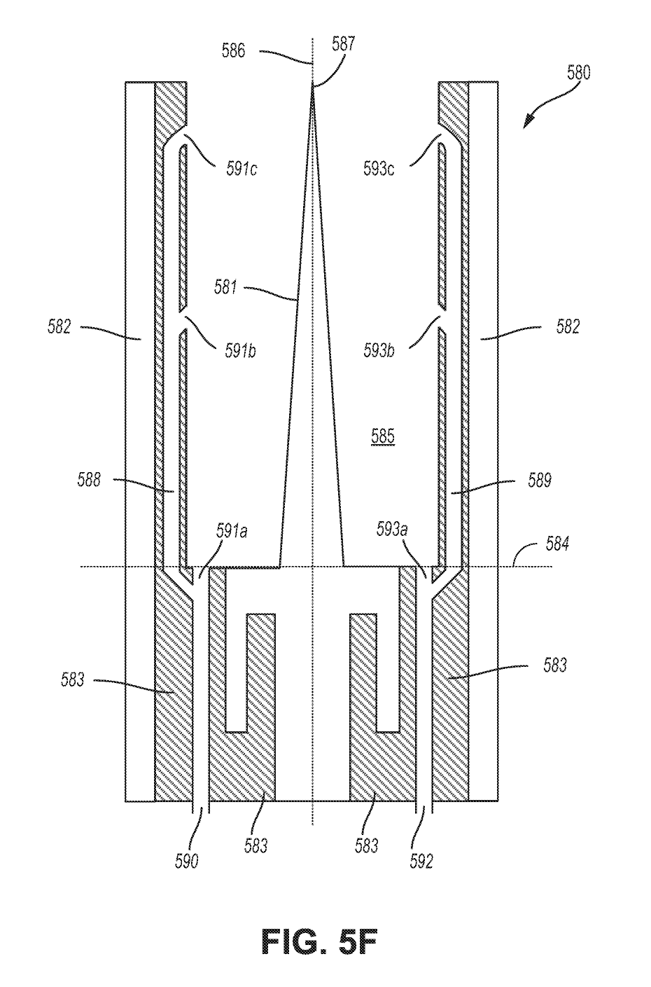

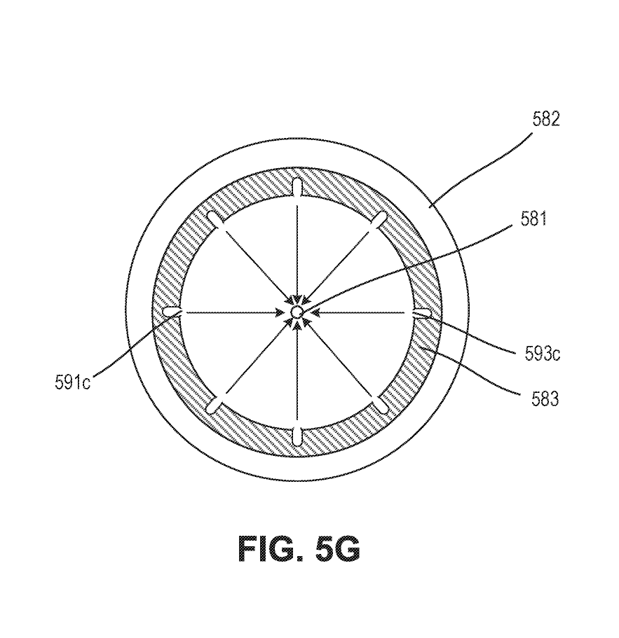

As illustrated in FIG. 5A, in some implementations, the QWCCR structure 100 (or the coaxial resonator 201) can be attached to a fuel tank 502. The fuel tank 502 can provide a fuel source for a combustion chamber or other environment, for example. The fuel tank 502 can contain or be connected to a fuel pump 504 through a fuel-supply line (for example, a hose or a pipe). The fuel pump 504 can transfer fuel from the fuel tank 502 into the fuel-supply line and propel the fuel through a fuel conduit 506 defined by or disposed within the inner conductor 104 of the QWCCR structure 100. For example, the fuel pump 504 can include a mechanical pump (for example, gear pump, rotary vane pump, diaphragm pump, screw pump, peristaltic pump) or an electrical pump. In some implementations, the fuel tank 502 can include various sensors (for example, a pressure sensor, a temperature sensor, or a fuel-level sensor). Such sensors can be electrically connected to the controller 402 in order to provide data regarding the status of the fuel tank 502 to the controller 402, for example. Additionally or alternatively, the fuel pump 504 can be connected to the controller 402. Through such a connection, the controller 402 could control the fuel pump 504 (for example, to switch the fuel pump on and off, set a fuel injection rate, etc.).

In some implementations, the fuel conduit 506 can inject fuel (for example, into a combustion chamber) at one or more outlets 508 defined within the electrode 106 (for example, within a concentrator of the electrode 106). By conveying fuel through the fuel conduit 506 and out one or more outlets 508, fuel can be introduced proximate to a source of ignition energy (for example, proximate to a plasma corona generated near a concentrator of the electrode 106), which can allow for efficient combustion and ignition. In alternate implementations, one or more outlets can be defined with other locations of the fuel conduit 506 (for example, so as not to interfere with the electric field at the concentrator of the electrode 106).

In some implementations, the fuel conduit 506 can act, at least in part, as a Faraday cage (for example, by encapsulating the fuel within a conductor that makes up the fuel conduit 506) to prevent electromagnetic radiation in the QWCCR structure 100 from interacting with the fuel while the fuel is transiting the fuel conduit 506. In other structures, the fuel conduit 506 can allow electromagnetic radiation to interact with (for example, reform) the fuel within the fuel conduit 506.

In some implementations, the QWCCR structure 100 can include multiple fuel conduits 506 (for example, multiple fuel conduits running from the proximal end of the QWCCR structure 100 to the distal end of the QWCCR structure 100). Additionally or alternatively, one or more fuel conduits 506 can be positioned within the dielectric 108 or within the outer conductor 102. As described above, the outlet(s) 508 of the fuel conduit(s) 506 can be oriented in such as a way as to expel fuel toward concentrators (for example, tips, edges, or points) of one or more electrodes 106 (for example, toward regions where plasma coronas are likely to be excited).

FIGS. 5B and 5C each illustrate cutaway side views of an example coaxial resonator 510 having an inner conductor 512, an outer conductor 514, an electrode 516 disposed at a distal end of the coaxial resonator 510, and multiple dielectrics sections between the inner and outer conductors. As depicted in FIG. 5B, for instance, the coaxial resonator 510 includes a first dielectric section 518 and a second dielectric section 520. In an example arrangement, each of the two dielectric sections can be the same dielectric. Alternatively, the dielectric sections can be different dielectrics.

The first dielectric section 518 includes a fuel conduit 522 having an outlet 524 located at a distal end of the fuel conduit and having an inlet 525 located at a proximal end of the fuel conduit. The outlet 524 is oriented towards both the inner conductor 512 and the second dielectric section 520. In an example arrangement, the first dielectric section 518 can be a ceramic material within which the fuel conduit 522 is disposed and through which the fuel can flow towards the outlet 524. Further, the second dielectric section 520 can be either (i) entirely air or (ii) a porous ceramic material through which fuel can flow towards the electrode 516. As an alternate example, the first dielectric section 518 can be a porous ceramic material and the second dielectric section 520 can be air. Other arrangements are possible as well.

Further, as depicted in FIG. 5C, the coaxial resonator 510 includes a first dielectric section 526, a second dielectric section 528, and a third dielectric section 530. Arranged within both the first dielectric section 526 and the second dielectric section 528 is a fuel conduit 532 having an outlet 534 oriented towards both the inner conductor 512 and the third dielectric section 530. In an example arrangement, each of the three dielectric sections can be the same dielectric. Alternatively, at least one of the dielectric sections can be different from the other(s).

In some implementations, the disclosed coaxial resonator can be configured to inject a single type of fuel, such as one of the fuels noted above. In addition to injecting a single type of fuel, the disclosed coaxial resonator arrangements can also be used to mix multiple different types of fuels before, during, or after the coaxial resonator provides electromagnetic waves and exposes the fuel(s) to the electromagnetic waves. This can be accomplished in various ways. In one example, the coaxial resonator can include multiple conduits arranged proximate to dielectric in the resonator, such as multiple fuel conduits arranged along, within, or defined by the dielectric, and configured to operate together to mix fuels. Each such conduit can include a respective inlet configured to receive a distinct type of fuel from a fuel source. Further, each such conduit may be physically separate from each other conduit. Still further, a first conduit can include an outlet arranged proximate to an outlet of a second conduit, and the two outlets can be oriented such that, due to their proximity and orientations, when the first conduit expels one type of fuel out of the first conduit's respective outlet and the second conduit expels a different type of fuel out of the second conduit's respective outlet, the fuels can mix together. For instance, each of the two outlets described above can be arranged to expel the respective fuels into porous dielectric material, in which the fuels can mix together. Additionally or alternatively, the two outlets can be arranged to expel the respective fuels into a cavity of air in the coaxial resonator, in which the fuels can mix together. In some implementations, the coaxial resonator can excite a plasma corona to ignite, in a combustion chamber, a mixture that includes multiple fuels and air.

FIG. 5D illustrates a cross-sectional view of another example coaxial resonator 540. As depicted in FIG. 5D, the coaxial resonator 540 includes an inner conductor 541, an outer conductor 542, and a dielectric material 543 between the inner conductor 541 and the outer conductor 542. Further, the inner conductor 541 is shown projecting along a longitudinal axis 544 to a distal end configured as a concentrator 555 of an electrode.

In addition, also depicted in FIG. 5D are various fuel conduits including: conduit 556 having inlet 557 and outlet 558, conduit 559 having inlet 560 and outlet 561, conduit 562 having inlet 563 and outlet 564, and conduit 565 having inlet 566 and outlet 567. Each such conduit is substantially parallel to longitudinal axis 544 and has an inlet located at a proximal end of the coaxial resonator 540 and an outlet located at a distal end of the coaxial resonator 540. Inlets 557, 560, 563, and 566, are each configured to receive fuel into a respective conduit from a fuel source. Outlets 558, 561, 564, and 567, are each oriented at a slight angle towards longitudinal axis 544 and the distal end of the inner conductor 512, and are each configured to expel fuel towards the concentrator 555 of the electrode.

Next, FIG. 5E illustrates various cross-sectional views of a coaxial resonator 570. As depicted, the coaxial resonator 570 has an inner conductor 571, an outer conductor 572. At a distal end of the coaxial resonator is an electrode 573. In this example, two different dielectrics are between the inner conductor 571 and the outer conductor 572: air 574, and a porous dielectric material 575. In operation, fuel can enter through an inlet (not shown) near a proximal end of the coaxial resonator 570. The fuel can then flow into and through the porous dielectric material 575, next flowing into and through the air 574, and lastly being expelled out of a distal end of the coaxial resonator 570.

Sectional view A-A shows a portion of the coaxial resonator 570 near the distal end of the coaxial resonator 570. In this portion, air 574 is between the inner conductor 571 and the outer conductor 572.

Next, sectional view B-B shows a portion of the coaxial resonator 570 slightly below a midway point between the distal end and the proximal end of the coaxial resonator 570. In this portion, the porous dielectric material 575 is between the inner conductor 571 and the outer conductor 572, and defines channels of a fuel conduit, such as channels 576 and 577. Further, sectional view C-C shows a portion of the coaxial resonator 570 near a proximal end of the coaxial resonator 570. In this portion, the porous dielectric material 575 is less porous than the portion of the coaxial resonator 570 shown in sectional view B-B, and defines additional channels of the fuel conduit, such as channels 578 and 579.

In practice, due to the porous nature of a porous dielectric material, the shape of the channels defined by the material can vary along various points in the material. For example, at some point along the length of the coaxial resonator 570 between sectional views B-B and C-C, thinner channels 578 and 579 can merge together to become wider channel 577.

Alternatively, both channels 578 and 579 can remain physically separate from one another, but each feed into channel 577. Either way, in operation, fuel that flows through channels 578 and 579 can then flow through channel 577, and at some point thereafter can flow into the air 574 portion of the coaxial resonator 570.

As another example, channel 578 and channel 576 can be two different portions of the same channel. Likewise, channel 579 and channel 577 can be two different portions of the same channel through which fuel can flow. For instance, at some point along the length of the coaxial resonator 570 between sectional views B-B and C-C, channel 579 can widen in a funnel-like manner and to form channel 577. Other examples are possible as well.

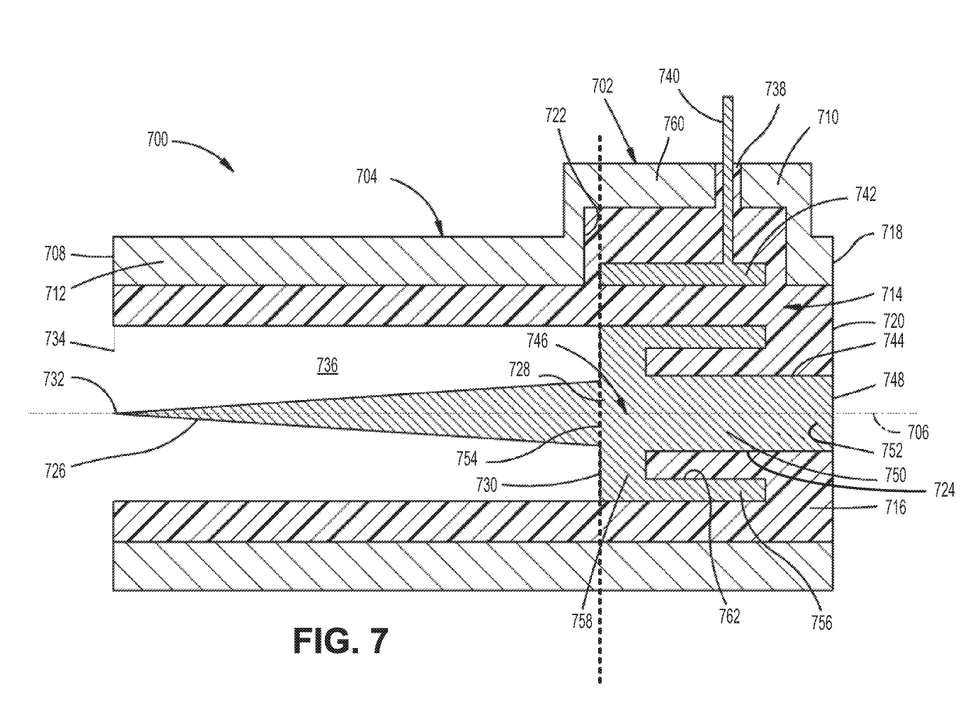

FIG. 5F illustrates a cross-sectional view of an example coaxial resonator 580 that is arranged in a similar manner to the coaxial resonator depicted in FIG. 7. As depicted in FIG. 5F, the coaxial resonator 580 includes an inner conductor 581, an outer conductor 582, and a dielectric material 583 between the inner conductor 581 and the outer conductor 582. In particular, above axis 584, both the dielectric material 583 and a cavity 585 (air, for instance) are between the inner conductor 581 and the outer conductor 582. And below axis 584, the dielectric material 583 is between the inner conductor 581 and the outer conductor 582. Further, the inner conductor 581 is shown to project along a longitudinal axis 586 to a distal end configured as a concentrator 587 of an electrode located at or in close proximity to a distal end of the cavity 585.

In addition, also depicted in FIG. 5F are fuel conduits 588 and 589 that are arranged within the dielectric material 583 and having at least some channels that are substantially parallel to longitudinal axis 586. In practice, the coaxial resonator 580 can be cylindrical, and thus, fuel conduits 588 and 589 can take the form of physically separate conduits arranged within the dielectric material 583, or can take the form of a single, annular conduit arranged within the dielectric material 583.

As shown, fuel conduit 588 includes a fuel inlet 590 and three outlets: outlet 591a, outlet 591b, and outlet 591c, where outlet 591a is located at axis 584, and both outlet 591b and outlet 591c are located above axis 584. Likewise, fuel conduit 589 includes a fuel inlet 592 and three outlets: outlet 593a, outlet 593b, and outlet 593c, where outlet 593a is located at axis 584, and both outlet 593b and 593c are located above axis 584. Fuel inlets 590 and 592 are each configured to receive fuel into conduits 588 and 589, respectively, from a fuel source.

Slightly below axis 584, respective channels of fuel conduits 588 and 589 branch off to run within the dielectric material 583 above axis 584. Outlets 591b, 591c, 593b, and 593c, are then each oriented at a slight angle towards longitudinal axis 586 and the distal end of the inner conductor 581, and are each configured to expel fuel into the cavity 585 in a direction towards the inner conductor 581 and in a direction towards the distal end of the coaxial resonator 580. Further, outlets 591a and 593a are oriented so that each of their longitudinal axes are substantially parallel to longitudinal axis 586. Thus, outlets 591a and 593a are each configured to expel fuel into the cavity 585 in a direction that is largely parallel to the longitudinal axis 586 and in a direction toward the distal end of the coaxial resonator 580.

In some implementations, multiple conduits similar to conduits 588 and 589 can be arranged within the dielectric material 583 at other locations about longitudinal axis 586. Each of such conduits can include more outlets, less outlets, or the same number of outlets, each of which can be at the same or different locations along the conduit as those shown in FIG. 5F. For example, one such conduit can include an outlet disposed in a distal end of the coaxial resonator (in other words, at the top of the coaxial resonator) and configured to expel fuel out towards the distal end of the inner conductor 581 and/or towards an area entirely outside of the coaxial resonator, depending on the orientation of the outlet. In another example, a single, annular outlet can be disposed at a location along the length of the dielectric material 583 and configured to expel fuel in a radial pattern into the cavity 585 toward the inner conductor 581. Similarly, multiple outlets with similar locations and orientations as outlets 591b and 593b or outlets 591c and 593c can be disposed in the dielectric material 583 and can be together configured to expel fuel in a radial pattern toward the inner conductor 581. Other examples are possible as well.

FIG. 5G illustrates a cross-sectional view of an example coaxial resonator 580 with multiple outlets, including outlet 591c and 593c, disposed within the dielectric material 583 in an annular pattern. The arrows shown in FIG. 5G represent the direction of fuel. As shown, each such outlet can be configured to expel fuel in a radial pattern toward the inner conductor 581. Expelling the fuel toward the inner conductor can help to direct the fuel toward a plasma corona provided at the concentrator 587.

At least a portion of the fuel conduit(s) in a resonator can be arranged proximate to the dielectric of that resonator. In some implementations, at least a portion of the fuel conduit is proximate to the dielectric by being arranged along the dielectric. In some implementations, at least a portion of the fuel conduit is proximate to the dielectric by being defined by a shape of the dielectric. Furthermore, in some implementations, at least a portion of the fuel conduit is proximate to the dielectric by being disposed within the dielectric. In those implementations, the fuel conduit can include a tube, such as a glass tube, a sapphire tube, a quartz tube, an aliphatic polyamide tube, or a non-porous ceramic tube, for example.

### VII. Additional Resonator Implementations

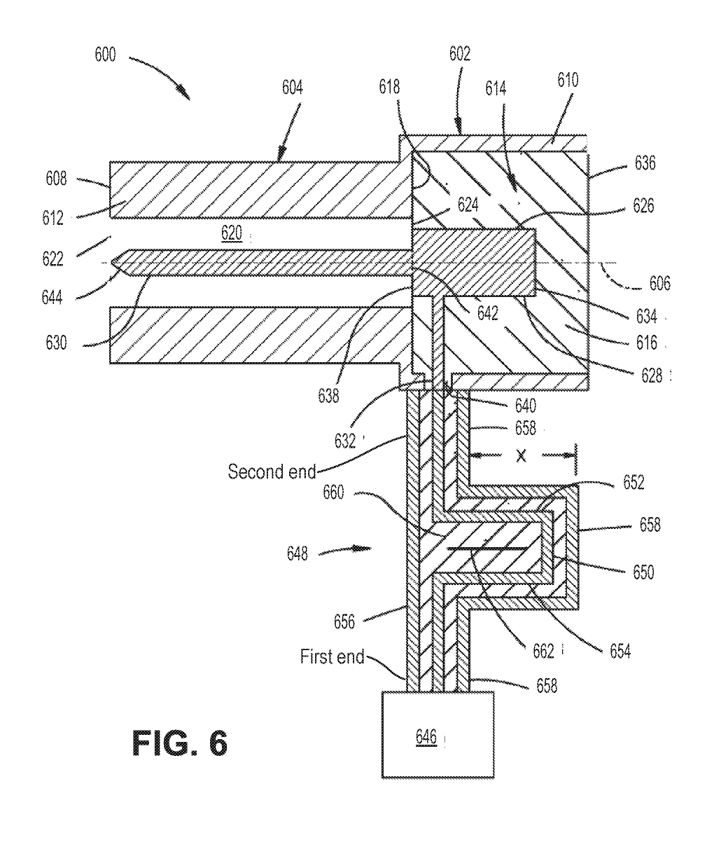

FIG. 6 illustrates a cross-sectional view of an example alternative coaxial resonator 600 connected to a DC power source through an additional resonator assembly acting as an RF attenuator, in accordance with example implementations. The coaxial resonator 600 is an assembly of two quarter-wave coaxial cavity resonators that are coupled together. More specifically, the coaxial resonator 600 includes a first resonator 602 and a second resonator 604 electrically coupled in a series arrangement along a longitudinal axis 606. In some implementations, the coaxial resonator 600 includes a DC bias condition established at a node of the voltage standing wave (for example, between quarter-wave segments). In such implementations, there may be no impedance mismatch. Because there is no impedance mismatch, the diameters of the inner conductor and the outer conductor of the first resonator 602 can be different than the diameters of the inner conductor and the outer conductor of the second resonator 604, respectively, without impacting the quality factor (Q). In such a way, the DC bias condition might not affect or interact with the AC signal coming from a signal generator.

The first resonator 602 and the second resonator 604 are defined by a common outer conductor wall structure 608. The outer conductor wall structure 608 includes a first cylindrical wall 610 and a second cylindrical wall 612 centered on the longitudinal axis 606. The first cylindrical wall 610 is constructed of a conducting material and surrounds a first cylindrical cavity 614 centered on the longitudinal axis 606. The first cylindrical cavity 614 is filled with a dielectric 616 having a relative dielectric constant approximately equal to four (εᵣ≈4), for example.

In the example implementation of FIG. 6, the first resonator 602 and the second resonator 604 adjoin one another in a connection plane 618 that is perpendicular to the longitudinal axis 606. In other examples, the connection plane 618 might not be perpendicular to the longitudinal axis 606, and can instead be designed with a different configuration that maintains constant impedance between the first resonator 602 and the second resonator 604.

The second cylindrical wall 612 is constructed of a conducting material and surrounds a second cylindrical cavity 620 that is also centered on the longitudinal axis 606. The second cylindrical cavity 620 is coaxial with the first cylindrical cavity 614, but can have a greater physical length. The second cylindrical wall 612 provides the second cylindrical cavity 620 with a distal end 622 spaced along the longitudinal axis 606 from a proximal end 624 of the second cylindrical cavity 620.

A center conductor structure 626 is supported within the conductor wall structure 608 of the coaxial resonator 600 by the dielectric 616. The center conductor structure 626 includes a first center conductor 628, a second center conductor 630, and a radial conductor 632.

The first center conductor 628 reaches within the first cylindrical cavity 614 along the longitudinal axis 606. In the example implementation shown in FIG. 6, the first center conductor 628 has a proximal end 634 adjacent a proximal end 636 of the first cylindrical cavity 614, and has a distal end 638 adjacent the distal end 624 of the first cylindrical cavity 614. The radial conductor 632 projects radially from a location adjacent the distal end 638 of the first center conductor 628, across the first cylindrical cavity 614, and outward through an aperture 640.

The second center conductor 630 has a proximal end 642 at the distal end 638 of the first center conductor 628. The second center conductor 630 projects along the longitudinal axis 606 to a distal end 644 configured as an electrode tip located at or in close proximity to the distal end 622 of the second cylindrical cavity 620.

To reduce any mismatch in impedances between the first resonator 602 and the second resonator 604, the relative radial thicknesses between both the cylindrical walls 610, 612 and the respective center conductors 628, 630 are defined in relation to the relative dielectric constant of the dielectric 616 and the dielectric constant of the air or gas that fills the second cylindrical cavity 620. In the example implementation of FIG. 6, the physical length of the second center conductor 630 along the longitudinal axis 606 is approximately twice the physical length of the first center conductor 628 along the longitudinal axis 606. However, based at least in part on the dielectric 616 having a relative dielectric constant approximately equal to four, the electrical lengths of the two center conductors 628 and 630 are approximately equal.

In example implementations, any gaps between any of the center conductors 628, 630 and any outer conductor could be filled with a dielectric and/or the gap (for example, the second cylindrical cavity 620) could be large enough to reduce arcing (in other words, large enough such that the electric field is not of sufficient intensity to result in a dielectric breakdown of air or the intervening dielectric). As further shown in FIG. 6, the dielectric 616 fills the first cylindrical cavity 614 around the first center conductor 628 and the radial conductor 632.

In the illustrated example, a DC power source 646 is connected to the center conductor structure 626 through the radial conductor 632 connected adjacent to a virtual short-circuit point of the DC power source 646.

An RF control component, specifically, an RF frequency cancellation resonator assembly 648 is disposed between the radial conductor 632 and the DC power source 646 to restrict RF power from reaching the DC power source 646. The RF frequency cancellation resonator assembly 648 is an additional resonator assembly having a center conductor 650. The center conductor 650 has a first portion 652 and a second portion 654, each of which has the same electrical length “X” illustrated in FIG. 6 (and the same electrical length as the first center conductor 628 and the second center conductor 630).

In an example implementation, the electrical length “X” depicted in FIG. 6 can be sized such that the center conductor 650 is an odd-integer multiple of half wavelengths (for example, ½λ₀, 3/2λ₀, 5/2λ₀, 7/2λ₀, 9/2λ₀, 11/2λ₀, 13/2λ₀, etc.) out of phase (in other words, 180° out of phase) with the outer conducting wall 656 and the outer conducting wall 658, simultaneously, where λ₀ is the resonant wavelength, and where the resonant wavelength λ₀ is inversely related to the frequency of the RF power. In alternative implementations, a similar “folded” structure to the electrical length “X” could be located within the cylindrical cavity 614 to achieve a similar phase shift between the inner conductor and the outer conductor.

The RF frequency cancellation resonator assembly 648 also has a short outer conducting wall 656 and a long outer conducting wall 658. The short outer conducting wall 656 has first and second ends on opposite ends of the RF frequency cancellation resonator assembly 648. The long outer conducting wall 658 also has first and second ends on opposite ends of the RF frequency cancellation resonator assembly 648. The first and second ends of the short outer conducting wall 656 are each on the opposite side of the RF frequency cancellation resonator assembly 648 from the corresponding first and second ends of the long outer conducting wall 658.

In an example implementation, the difference in electrical length between the short outer conducting wall 656 and the long outer conducting wall 658 is substantially equal to the combined electrical length of the first portion 652 and the second portion 654. In this example, the combined electrical length of the first portion 652 and the second portion 654 is substantially equal to twice the electrical length of the first center conductor 628.

In an example implementation, the short outer conducting wall 656 and the long outer conducting wall 658 surround a cavity 660 filled with a dielectric. In operation, with this example implementation, electric current running along the outer conductor of the RF frequency cancellation resonator assembly 648 primarily follows the shortest path and run along the short outer conducting wall 656. Accordingly, electric current on the outer conductor of the RF frequency cancellation resonator assembly 648 travels two fewer quarter-wavelengths than current running along the center conductor 650 of the RF frequency cancellation resonator assembly 648.

In examples, the RF frequency cancellation resonator assembly 648 can also have an internal conducting ground plane 662 disposed within the cavity 660 and between the first portion 652 and the second portion 654 of the center conductor 650. Based on the geometry of the cancellation resonator assembly 648, this configuration provides a frequency cancellation circuit connected between the DC power source 646 and the radial conductor 632.

Further, in examples, the RF frequency cancellation resonator assembly 648 is configured to shift a voltage supply of RF energy 180 degrees out of phase relative to the ground plane 662 of the coaxial resonator 600 due to the difference in electrical length between the short outer conducting wall 656 and the center conductor 650 of the RF frequency cancellation resonator assembly 648.

FIG. 7 illustrates a cross-sectional view of another example alternative coaxial resonator 700 connected to a DC power source through an additional resonator assembly acting as an RF attenuator, in accordance with an example implementation. The coaxial resonator 700 includes a first resonator portion 702 and a second resonator portion 704 electrically coupled in a series arrangement along a longitudinal axis 706.

As depicted in FIG. 7, the first resonator portion 702 and the second resonator portion 704 are defined by a common outer conductor wall structure 708. The wall structure 708 includes a first cylindrical wall portion 710 and a second cylindrical wall portion 712 centered on the longitudinal axis 706. The first cylindrical wall portion 710 is constructed of a conducting material and surrounds a first cylindrical cavity 714 centered on the longitudinal axis 706. In this example implementation, the first cylindrical cavity 714 is filled with a dielectric 716.

An annular edge 718 of the first cylindrical wall portion 710 defines a proximal end 720 of the first cylindrical cavity 714. A proximal end of the second cylindrical wall portion 712 adjoins a distal end 722 of the first cylindrical cavity 714.

The coaxial resonator 700 further includes a first center conductor portion 724 and a second center conductor portion 726 (the center conductor portions 724, 726 represented by the densest cross-hatching in FIG. 7). For illustration, the first center conductor portion 724 and the second center conductor portion 726 are separated by the vertical dashed line in FIG. 7. In some implementations, both the first center conductor portion 724 and the second center conductor portion 726 can correspond to an odd-integer multiple of quarter wavelengths based on the frequency of an RF power source used to excite the coaxial resonator 700. The second center conductor portion 726 has a proximal end 728 adjoining a distal end 730 of the first center conductor portion 724. The second center conductor portion 726 projects along the longitudinal axis 706 to a distal end configured as a concentrator 732 (for example, a tip) of an electrode located at or in close proximity to a distal end 734 of a second cylindrical cavity 736.

The coaxial resonator 700 has an aperture 738 that reaches radially outward through the first cylindrical wall portion 710. A radial conductor 740 extends out through the aperture 738 from the longitudinal axis 706 to be connected to an RF power source (for example, the signal generator 202) by an RF power input line. The end of the radial conductor 740 that is closer to the longitudinal axis 706 connects to a parallel plate capacitor 742 that is in a coupling arrangement to a center conductor structure 744. The parallel plate capacitor 742 is also in a coupling arrangement to an inline folded RF attenuator 746. The spacing between the parallel plate capacitor 742 and the center conductor structure 744 can depend on the materials used for fabrication (for example, the materials used to fabricate the parallel plate capacitor 742, the center conductor structure 744, and/or the dielectric 716).

In an example, the DC power source 646 described above is connected to the center conductor structure 744 at a proximal end 748 of the center conductor structure 744 with a DC power input line. The inline folded RF attenuator 746 is disposed between the second resonator portion 704 and the DC power source 646 to restrict RF power from reaching the DC power source 646.

The inline folded RF attenuator 746 includes an interior center conductor portion 750 having a proximal end 752 and a distal end 754. The inline folded RF attenuator 746 also includes an exterior center conductor portion 756 and a transition center conductor portion 758 that connects or couples the interior center conductor portion 750 and the exterior center conductor portion 756.

The exterior center conductor portion 756 has a proximal end largely in the same plane as the proximal end 752, and a distal end largely in the same plane as the distal end 754. For example, in the cross-sectional illustration of FIG. 7, the plane of the proximal end 752 and the plane of the proximal end of the exterior center conductor portion 756 can be the plane of the cross-section that is illustrated. In this example implementation, the transition center conductor portion 758 is located proximal to the distal end 754. The exterior center conductor portion 756 surrounds the interior center conductor portion 750.

In this example, the exterior center conductor portion 756 resembles a cylindrical portion of conducting material surrounding the rest of the interior center conductor portion 750. The longitudinal lengths of the interior center conductor portion 750 and the exterior center conductor portion 756 are substantially equal to the longitudinal length of the parallel plate capacitor 742 with which they are in a coupling arrangement. The electrical length between the proximal end 752 to the distal end 754, for both the interior center conductor portion 750 and the exterior center conductor portion 756, is substantially equal to one quarter-wavelength. The second center conductor portion 726 and the second cylindrical wall portion 712 are both configured to have an electrical length of one quarter-wavelength.

The wall structure 708 includes a short outer conducting portion 760 which has a proximal end largely in the same plane as the proximal end 752, and a distal end largely in the same plane as the distal end 754. An outer conducting path runs from the distal end of the wall structure 708 (that is substantially coplanar with the distal end 734 of the second cylindrical cavity 736), along the short outer conducting portion 760, and stops at the proximal end 720 of the first cylindrical wall portion 710. In this example, the outer conducting path has an electrical length of two quarter-wavelengths.

An inner conducting path runs from the concentrator 732 to the proximal end 728 of the second center conductor portion 726, along the outside of the transition center conductor portion 758, then along the outside from the distal end to the proximal end of the exterior center conductor portion 756, then along an interior wall 762 of the exterior center conductor portion 756 from its proximal end to its distal end, then along the interior center conductor portion 750 from its distal end to its proximal end. In this example, the electrical length of this inner conducting path is four quarter-wavelengths, or two half wavelengths. The difference in electrical lengths between the inner conducting path and the outer conducting path is one half wavelength.

With this configuration, the inline folded RF attenuator 746 operates as a radio-frequency control component connected between the DC power source 646 and the voltage supply of RF energy. The inline folded RF attenuator 746 is configured to shift a voltage supply of RF energy 180 degrees out of phase relative to the ground plane of the coaxial resonator 700.

The particular arrangement depicted in FIG. 7 is not limiting with respect to the orientation of the inline folded RF attenuator 746. In other examples, the entire arrangement depicted in FIG. 7 can be “stretched,” with the inline folded RF attenuator 746 being disposed further away from the concentrator 732 and not directly coupled to the parallel plate capacitor 742. For example, the inline folded RF attenuator 746 could be separated by one quarter-wavelength from the portion of the center conductor that would remain in direct coupling arrangement with the parallel plate capacitor 742. The coaxial resonator 700 can achieve a maximize efficiency when (i) the inline folded RF attenuator 746 is an odd-integer multiple of quarter wavelengths from the concentrator 732; and (ii) the inline folded RF attenuator 746 is an odd-integer multiple of quarter wavelengths in electrical length.

In another example, the arrangement depicted in FIG. 7 could be more compressed, with the exterior center conductor portions 756 of the inline folded RF attenuator 746 extending longitudinally as far as the parallel plate capacitor 742 and also surrounding the portion of center conductor exposed for plasma creation. This can be implemented by arranging the center conductor structure 744 in the middle so that the exterior center conductor portions 756 extends in either direction longitudinally. Any particular geometry of this arrangement can involve adjusting the various parameters of dielectrics to ensure impedance matching and full 180 degree phase cancellation.

In one example, the arrangements described with respect to FIGS. 6 and 7 and the particular combination of components that provide the RF signal to the coaxial resonators are contained in a body dimensioned approximately the size of a gap spark igniter and adapted to mate with a combustor (for example, of an internal combustion engine). As an example for illustration, a microwave amplifier could be disposed at the resonator, and the resonator could be used as the frequency determining element in an oscillator amplifier arrangement. The amplifier/oscillator could be attached at the top or back of an igniter, and could have the high voltage supply also integrated in the module with diagnostics. This example permits the use of a single, low-voltage DC power supply for feeding the module along with a timing signal.

### VIII. Jet Engines

The above coaxial resonators could be usefully employed in the context of a gas turbine such as a jet turbine configured to power an aircraft. For example, a coaxial cavity resonator similar to the coaxial resonator 201 illustrated in FIG. 2 could be used in a gas turbine. While reference is made to “QWCCR,” “QWCCR structure,” and “coaxial resonator” elsewhere in the description, it will be understood that other types of resonators are possible and contemplated.

An example gas turbine includes a compressor coupled to a turbine through a shaft, and the gas turbine also includes a combustion chamber or area, called a combustor. In operation, atmospheric air flows through a compressor that brings the air to higher pressure. Energy is then added by spraying fuel into the air and igniting it so the combustion generates a high-temperature, high-pressure gas flow. The high-temperature, high-pressure gas enters a turbine, where it expands down to an exhaust pressure, producing a shaft work output at the shaft coupled to the turbine in the process.

The shaft work output is used to drive the compressor and other devices (for example, an electric generator) that can be coupled to the shaft. The energy that is not used for shaft work comes out in the exhaust gases that can include a high temperature and/or a high velocity. Gas turbines can be utilized to power aircraft, trains, ships, electrical generators, pumps, gas compressors, and tanks, among other machines.

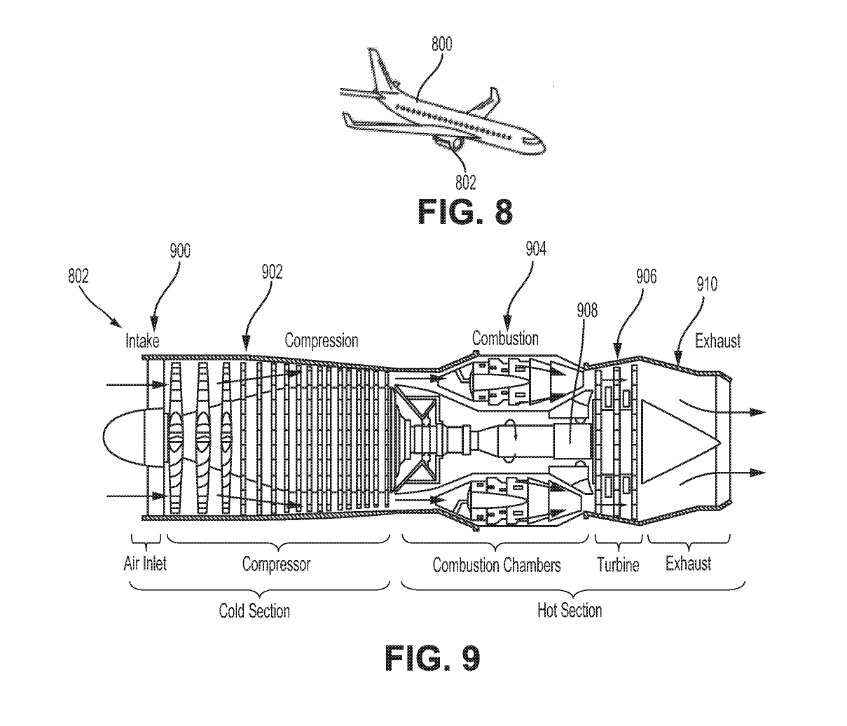

FIG. 8 illustrates an aircraft 800 having a jet engine 802, according to example implementations. To help propel the aircraft 800 through the air, the aircraft 800 includes a propulsion system operable to generate thrust. The jet engine 802 is a gas turbine engine that is part of the propulsion system of the aircraft 800. The aircraft 800 can include several jet engines (for example, 2 or 4) similar to the jet engine 802 coupled to wings of the aircraft 800, for example. The jet engine 802 includes several components of a gas turbine such as the compressor, the combustor, and the turbine.

FIG. 9 illustrates several components of the jet engine 802, according to an example implementation. As illustrated, the jet engine 802 is configured as a gas turbine engine. Large amounts of surrounding air (free stream) are continuously brought into an inlet or intake 900. At the rear of the intake 900, the air enters a compressor 902 (axial, centrifugal, or both). The compressor 902 operates as many rows of airfoils, with each row producing an increase in pressure. At the exit of the compressor 902, the air is at a much higher pressure than free stream at the intake 900.

Fuel is mixed with the compressed air exiting the compressor 902, and the fuel-compressed air mixture is burned in a combustor 904, generating a flow of hot, high pressure gas. The hot, high pressure gas exiting the combustor 904 then passes through a turbine 906, which extracts energy from the flow of gas by making turbine blades spin in the flow. The energy extracted by the turbine 906 is then used to turn the compressor 902 by coupling the compressor 902 and the turbine 906 by a central shaft 908.

The turbine 906 transforms or converts some energy of the hot gas to drive the compressor 902, but there is enough energy left over to provide thrust to the jet engine 802 by increasing velocity of the flow of gas through a nozzle 910 disposed adjacent the turbine 906. Because the exit velocity is greater than the free stream velocity, thrust is created and the aircraft 800 is propelled.

Several variations could be made to the jet engine 802. For instance, the jet engine 802 could be configured as a turbofan engine or a turboprop engine where additional components are added to the several components illustrated in FIG. 9.

The combustor 904, which can also be referred to as a burner, combustion chamber, or flame holder, comprises the area of the jet engine 802 where combustion takes place. The combustor 904 is configured to contain and maintain stable combustion despite high air flow rates. As such, in examples, the combustor 904 is configured to mix the air and fuel, ignite the air-fuel mixture, and then mix in more air to complete the combustion process.

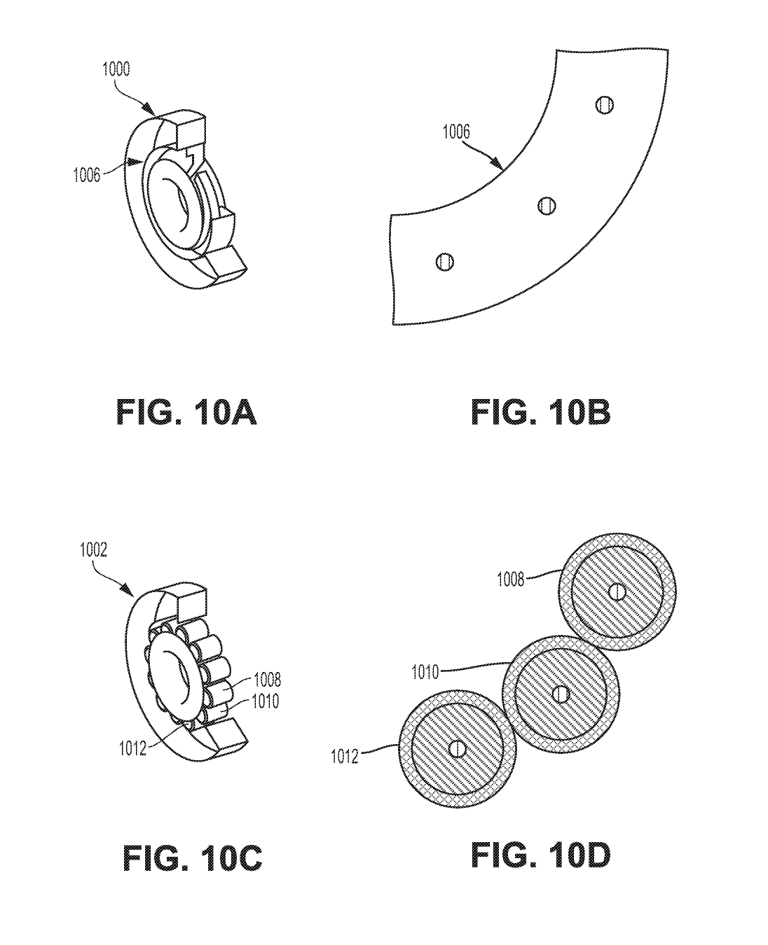

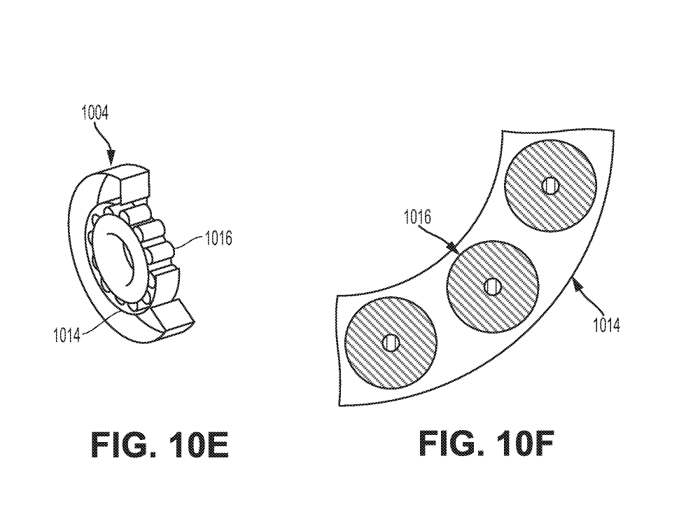

FIGS. 10A, 10B, 10C, 10D, 10E, 10F. illustrate example types of combustors, according to example implementations. In particular, FIG. 10A illustrates a partial perspective view of an annular combustor 1000, and FIG. 10B illustrates a partial frontal view of the annular combustor 1000. FIG. 10C illustrates a partial perspective view of a tubular or can combustor 1002, and FIG. 10D illustrates a partial frontal view of the can combustor 1002. FIG. 10E illustrates a partial perspective view of a can-annular combustor 1004, and FIG. 10F illustrates a partial frontal view of the can-annular combustor 1004.

The annular combustor 1000 shown in FIGS. 10A-10B has an annular cross section and has a liner sitting inside an outer casing, which has been peeled open in FIG. 10A for illustration. The annular combustor 1000 does not define separate combustion zones, but rather has a continuous liner and casing forming a ring 1006 (the annulus).

The can combustor 1002 shown in FIGS. 10C and 10D includes multiple combustion cans such as combustion cans 1008, 1010, and 1012 arranged in a radial array about a central shaft. Each combustion can is a self-contained cylindrical combustion chamber that has both a liner and a casing. Each combustion can has its own fuel injector, igniter, liner, and casing.

The primary air from the compressor 902 is guided into each individual combustion can, where it is decelerated, mixed with fuel, and then ignited. Secondary air also comes from the compressor 902, where it is fed outside of the liner. The secondary air is then fed, for example, through slits in the liner, into the combustion zone to cool the liner using thin film cooling.

In example implementations, multiple combustion cans are arranged around the jet engine 802, and their shared exhaust is fed to the turbine 906. However, the can combustor 1002 can weigh more than other combustor configurations and can be characterized by higher pressure drop across the combustion cans than other combustor configurations.

The can-annular combustor 1004 shown in FIGS. 10E-10F includes an annular casing 1014 and can-shaped liners, such as liner 1016. The can-annular combustor 1004 has discrete combustion zones contained in separate liners with their own fuel injectors. Unlike the can combustor 1002, the combustion zones of the can-annular combustor 1004 share a common ring (annulus) casing (for example, annular casing 1014). Each combustion zone of the can-annular combustor 1004 does not operate as a separate pressure vessel; rather, the combustion zones “communicate” with each other through liner holes or connecting tubes that allow some air to flow circumferentially between the combustion zones. Further, rather than having separate igniters for each combustion can, once combustion takes place in one or two combustion cans of the can-annular combustor 1004 cans, combustion could spread to and ignite the other combustion cans due to communication between the combustion zones through the liner holes or connecting tubes.

Regardless of the type of combustor, the combustion process inside the combustor 904 can determine, at least partially, many of the operating characteristics of the jet engine 802, such as fuel efficiency, levels of emissions, and transient response (the response to changing conditions such a fuel flow and air speed). Further, also regardless of the type of combustor, the combustor 904 has several components that can be used, and these several components are described below.

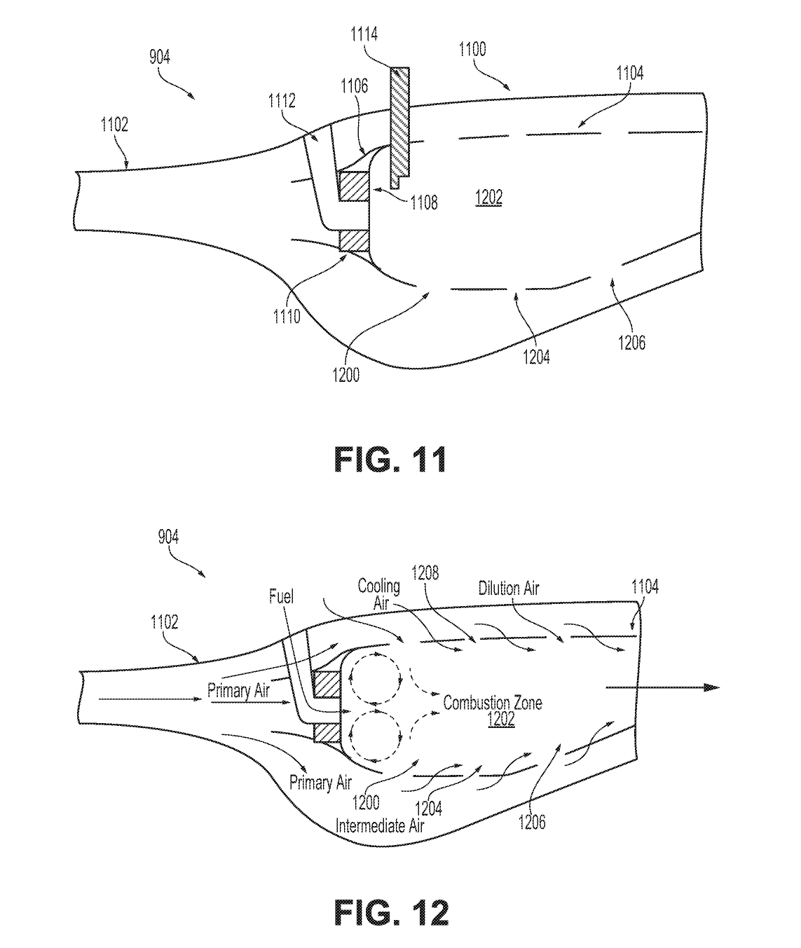

FIG. 11 illustrates a schematic diagram of a partial view of the combustor 904, according to an example implementation. The combustor 904 includes a casing 1100 that is configured as an outer shell of the combustor 904. The casing 1100 can be protected from thermal loads by the air flowing in it, and can operate as a pressure vessel that withstands the difference between the high pressures inside the combustor 904 and the lower pressure outside the combustor 904.

The combustor 904 also includes a diffuser 1102 that is configured to slow the high speed, highly compressed air from the compressor 902 to a velocity optimal for the combustor 904. Reducing the velocity results in a loss in total pressure, and the diffuser 1102 is configured to limit such loss of pressure. The diffuser 1102 is also configured to limit flow distortion by avoiding flow effects like boundary layer separation.

The combustor 904 further includes a liner 1104 that contains the combustion process and is configured to withstand extended high temperature cycles, and therefore can be made from superalloys. Furthermore, the liner 1104 is cooled with air flow. In some example implementations, in addition to air cooling, the combustor 904 can include thermal barrier coatings to further cool the liner 1104.

FIG. 12 illustrates air flow paths through the combustor 904, according to an example implementation. Primary air is the main combustion air and is highly compressed air from the compressor 902. The primary air can be decelerated using the diffuser 1102 and is fed through primary air holes 1200. This air is mixed with fuel, and then combusted in a combustion zone 1202.

Intermediate air is the air injected into the combustion zone 1202 through intermediate air holes 1204. The air injected through the intermediate air holes 1204 completes the combustion processes, cooling the air down and diluting concentrations of carbon monoxide (CO) and hydrogen (H₂).

Dilution air is air injected through dilution air holes 1206 in the liner 1104 at the end of the combustion zone 1202 to help cool the air to before it reaches the turbine 906. The dilution air can be used to produce the uniform temperature profile desired in the combustor 904.

Cooling air is air that is injected through cooling air holes 1208 in the liner 1104 to generate a layer (film) of cool air to protect the liner 1104 from the high combustion temperatures. The combustor 904 is configured such that the cooling air does not directly interact with the combustion air and combustion process.

Referring back to FIG. 11, the combustor 904 further includes a snout 1106, which is an extension of a dome 1108. The snout 1106 operates as an air splitter, separating the primary air from the secondary air flows (intermediate, dilution, and cooling air).

The dome 1108 and a swirler 1110 are the components of the combustor 904 through which the primary air flows as it enters the combustion zone 1202. The dome 1108 and the swirler 1110 are configured to generate turbulence in the flow to rapidly mix the air with fuel. The swirler 1110 establishes a local low pressure zone that forces some of the combustion products to recirculate, creating high turbulence. However, the higher the turbulence, the higher the pressure loss is for the combustor 904, so the dome 1108 and the swirler 1110 are configured to not generate more turbulence than is sufficient to mix the fuel and air. In some examples, with the resonators disclosed in the present disclosure, the combustor 904 can be configured without the dome 1108 and the swirler 1110. In other examples, the dome 1108 and the swirler 1110 can be made smaller when the combustor resonators disclosed in the present disclosure are used because the flame front propagation can be faster than when a conventional igniter is used.

The combustor 904 further includes a fuel injector 1112 configured to introduce fuel to the combustion zone 1202 and, along with the swirler 1110, is configured to mix the fuel and air. The fuel injector 1112 can be configured as any of several types of fuel injectors including: pressure-atomizing, air blast, vaporizing, and premix/prevaporizing injectors.

Pressure atomizing fuel injectors rely on high fuel pressures (as much as 1200 pounds per square inch (psi)) to atomize the fuel. When using this type of fuel injector, the fuel system is configured to be sufficiently robust to withstand such high pressures. The fuel tends to be heterogeneously atomized, resulting in incomplete or uneven combustion, which generates pollutants and smoke.

The air-blast injector “blasts” fuel with a stream of air, atomizing the fuel into homogeneous droplets, and can cause the combustor 904 to be smokeless. This air blast injector can operate at lower fuel pressures than the pressure atomizing fuel injector.

The vaporizing fuel injector is similar to the air-blast injector in that the primary air is mixed with the fuel as it is injected into the combustion zone 1202. However, with the vaporizing fuel injector the fuel-air mixture travels through a tube within the combustion zone 1202. Heat from the combustion zone 1202 is transferred to the fuel-air mixture, vaporizing some of the fuel to enhance the mixing before the mixture is combusted. This way, the fuel is combusted with low thermal radiation, which helps protect the liner 1104. However, the vaporizer tube can have low durability because of the low fuel flow rate within it causing the tube to be less protected from the combustion heat.

The premixing/prevaporizing injector is configured to mix or vaporize the fuel before it reaches the combustion zone 1202. This way, the fuel is uniformly mixed with the air, and emissions from the jet engine 802 can be reduced. However, fuel can auto-ignite or otherwise combust before the fuel-air mixture reaches the combustion zone 1202, and the combustor 904 can thus be damaged.

In some example implementations, a resonator could be configured with fuel passages disposed within the resonator, such that the resonator integrates operations of the fuel injector 1112 with operations of an igniter described below. In these examples, the resonator could be configured to perform the atomization and vaporization of the fuel in addition to mixing and preparing the fuel for combustion. The fuel would then be passed through a formed plasma to ensure ignition. Further, the presence of electromagnetic waves radiated by the resonator could be used to energize the air-fuel mixture and stimulate combustion.

The combustor 904 also includes an igniter 1114 configured to ignite air-fuel mixture to cause combustion. In examples, the igniter 1114 can be configured as an electrical spark igniter, similar to an automotive spark plug. However, there are several disadvantages to such configuration as described below. The igniter 1114 is disposed proximate to the combustion zone 1202 where the fuel and air are already mixed, but is located upstream from the combustion location so that it is not damaged by the combustion itself. In example implementations, once combustion is initially started by the igniter 1114, the combustion is self-sustaining and the igniter 1114 is no longer used. In the annular combustor 1000 and the can-annular combustor 1004, the flame can propagate from one combustion zone to another, so igniters might not be used at each combustion zone.

However, in some examples, combustion can stop due to operating conditions that are not favorable to sustaining combustion. For example, the aircraft 800 can operate at high altitude with low air density, which might affect combustion. In another example, a speed of the aircraft 800 can be sufficiently low to stop the combustion process. Other operating conditions could cause the combustion to stop. In these examples, the igniter 1114 could also be used to restart combustion.

In some systems, ignition-assisting techniques can be used to restart combustion. One such method is oxygen injection, where oxygen is fed to the ignition area, helping the fuel to easily combust. This is particularly useful in some aircraft applications where the jet engine 802 may have to restart at high altitude. Further, described in the present disclosure are igniters and systems that could lower the probability of stopping and having to restart combustion. Particularly, the igniter 1114 could be configured as any of the resonators described in the present disclosure to enhance combustion. In some examples, if the igniter 1114 is configured as a coaxial resonator, the coaxial resonator could be used as a sensor to obtain real-time measurements of the conditions inside the combustor 904 and could be used to predict when combustion would stop (for example, when a flameout would occur). Once such a prediction is made, flameout can be precluded (or its likelihood reduced) by proactively performing operations such as adding more fuel, providing additional plasma, and/or increasing compression using the compressor 902, among other possible operations.

In some example implementations of the jet engine 802, combustion can take place in locations within the jet engine 802 other than the combustor 904. For example, in order for an aircraft to fly faster than the speed of sound, the aircraft needs to generate a high thrust to overcome a sharp rise in drag near the speed of sound. To achieve such high thrust, an afterburner can be added to the jet engine. The afterburner can be considered another type of combustor.

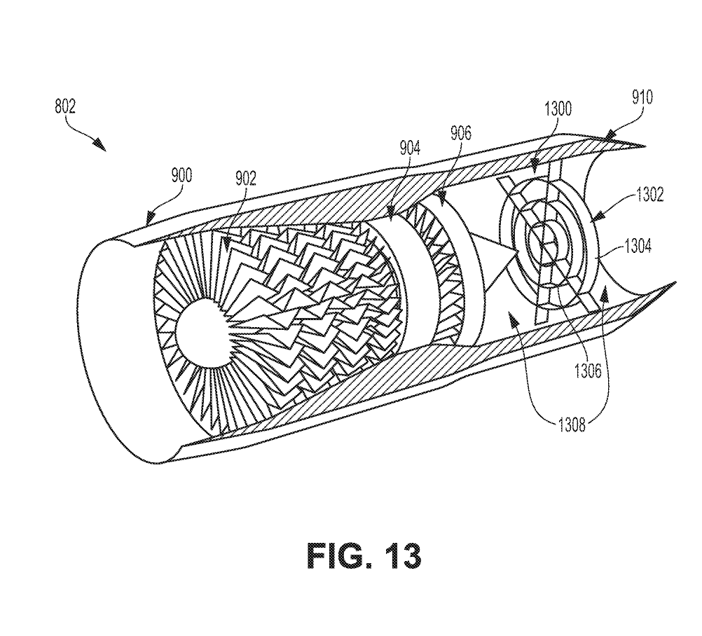

FIG. 13 illustrates the jet engine 802 including an afterburner 1300 downstream of the turbine 906, in accordance with an example implementation. As described above with respect to FIG. 9, some of the energy of the exhaust gas from the combustor 904 is used to turn the turbine 906. The afterburner 1300 is used to add energy to generate more thrust by injecting fuel directly into the hot exhaust gas exiting the turbine 906.

The nozzle 910 of the jet engine 802, as illustrated in FIG. 13, is extended or moved downstream in the jet engine 802 to enable placing flame holders 1302 between the turbine 906 and the exit of the jet engine 802. As shown in FIG. 13, the flame holders 1302 can include multiple hoops, such as hoops 1304, 1306. In another arrangement, the flame holders 1302 can include multiple parallel gutters that extend across an afterburner channel 1308 and perpendicular to the engine axis. In yet another arrangement, the flame holders 1302 can include multiple gutters extending radially from the internal surface of the afterburner channel 1308 in a star pattern with respect to the engine axis. The gutters of the flame holders 1302 can be configured with a u- or v-shaped cross section that is open on a downstream side of the gutter.

The flame holders 1302 provide a zone of low velocity air so as to retain gases during their combustion in the afterburner channel 1308.

In some examples, when the afterburner 1300 is turned on, additional fuel is injected through, between, or around the flame holders 1302 and into the gas exiting the turbine 906. In other examples, fuel is injected in the afterburner 1300 upstream of the flame holders 1302. The fuel burns and produces additional thrust.

After passing the turbine 906, the gas from the turbine 906 expands, thus losing temperature. The gas from the turbine 906 is an input gas to the afterburner 1300. Fuel is injected into the input gas from the turbine 906 to produce a fuel-air mixture within an afterburner channel 1308. Combustion of the fuel within the fuel-air mixture within the afterburner channel 1308 results in an exhaust gas from the afterburner 1300 having a temperature and pressure greater than a temperature and pressure, respectively, of the gas from the turbine 906. The exhaust gas resulting from combustion within the afterburner channel 1308 passes through the nozzle 910 at a higher velocity, thereby generating additional thrust.

In some examples, ignition within the afterburner 1300 may be hard to achieve. In particular, because velocities and temperatures do not substantially change at the inlet of the afterburner 1300, ignition in the afterburner 1300 may be difficult to achieve when the aircraft 800 is flying at high altitudes. The difficulty is associated with the low pressure in the afterburner 1300 that affects ignition directly. Therefore, it can be desirable to have a system that better prepares the fuel for easier ignition in the afterburner 1300 at higher altitude.

Further, the exhaust gas from the turbine 906 that enters the afterburner 1300 has reduced oxygen and is not highly compressed due to previous combustion at the combustor 904. Therefore, combustion in the afterburner 1300 is generally fuel-inefficient compared with combustion in the combustor 904. Thus, the afterburner 1300 increases thrust at the cost of increased fuel inefficiency, thereby limiting its practical use to short bursts or intermittent operation. As such, the afterburner 1300 is turned on selectively when the extra thrust is used, but is otherwise turned off. It can thus be desirable to have an afterburner that is more efficient to enable using the afterburner more often and more efficiently to enable persistent, as opposed to intermittent operation.

The combustion taking place at the combustor 904 and the combustion taking place in the afterburner 1300 of the jet engine 802 can affect many of the operating characteristics of the jet engine 802. As examples, combustion determines fuel efficiency, thrust levels, and levels of emissions and transient response (the response to changing conditions such a fuel flow and air speed). It can thus be desirable to have an ignition system that prepares the fuel for efficient and thorough combustion, facilitates starting and restarting ignition when desired regardless of altitude, and enables combustion of a lean fuel mixture at high compression ratios to increase efficiency.

### IX. Afterburners

FIG. 13 illustrates the jet engine 802 including an afterburner 1300 downstream of the turbine 906, in accordance with an example implementation. As described above with respect to FIG. 9, some of the energy of the exhaust gas from the combustor 904 is used to turn the turbine 906. The afterburner 1300 is used to add energy to generate more thrust by injecting fuel directly into the hot exhaust gas exiting the turbine 906.

The nozzle 910 of the jet engine 802, as illustrated in FIG. 13, is extended or moved downstream in the jet engine 802 to enable placing flame holders 1302 between the turbine 906 and the exit of the jet engine 802. As shown in FIG. 13, the flame holders 1302 can include multiple hoops, such as hoops 1304, 1306. In another arrangement, the flame holders 1302 can include multiple parallel gutters that extend across the afterburner channel 1308 and perpendicular to the engine axis. In yet another arrangement, the flame holders 1302 can include multiple gutters extending radially from the internal surface of the afterburner channel 1308 in a star pattern with respect to the engine axis. The gutters of the flame holders 1302 can be configured with a u- or v-shaped cross section that is open on a downstream side of the gutter. The flame holders 1302 provide a zone of low velocity air so as to retain gases during their combustion in the afterburner channel 1308.

In some examples, when the afterburner 1300 is turned on, additional fuel is injected through, between, or around the flame holders 1302 and into the gas exiting the turbine 906. In other examples, fuel is injected in the afterburner 1300 upstream of the flame holders 1302. The fuel burns and produces additional thrust.

After passing the turbine 906, the gas from the turbine 906 expands, thus losing temperature. The gas from the turbine 906 is an input gas to the afterburner 1300. Fuel is injected into the input gas from the turbine 906 to produce a fuel-air mixture within the afterburner channel 1308. Combustion of the fuel within the fuel-air mixture within the afterburner channel 1308 results in an exhaust gas from the afterburner 1300 having a temperature and pressure greater than a temperature and pressure, respectively, of the gas from the turbine 906. The exhaust gas resulting from combustion within the afterburner channel 1308 passes through the nozzle 910 at a higher velocity, thereby generating additional thrust with respect to gas from the turbine 906 that flows through the afterburner channel 1308 when fuel is not being injected into the afterburner channel 1308.

The fuel-air mixture produced by the injection process of fuel in the afterburner 1300 has a flame propagation velocity that is lower than the gas speed through the afterburner 1300. Thus, unless sources of continuous ignition are present in the chamber, the burning gas ignited by a temporary process could be blown out of the jet engine 802 as soon as the ignition is stopped.

In examples, this ignition process can start the stabilization process of the flame and can then be turned off. Further, fuel can be added in sequence to a number of stream tubes in the afterburner 1300 to prevent pressure surges during afterburner ignition and to allow modulation of the thrust of the afterburner 1300. Thus, once one region is “lit,” it can act as a source of ignition for adjacent regions when fuel is added to them.

Several ignition techniques could be used in the afterburner 1300 including: hot-streak, spark or arc ignition, and pilot burner techniques. In the hot-streak technique, fuel is injected for a short period into the gas resulting from the combustor 904 just upstream of the turbine 906. The combustible flow formed by this process produces a hot stream of burning gas. Combustion occurs in this stream by auto-ignition because of the high temperatures present upstream of the turbine 906. The hot streak can be maintained for a brief period to prevent thermal damage to the turbine 906.

In the arc-ignition technique, ignition and initiation of the flame stabilization process can be started by producing a high-energy electric arc in a primary stream tube. In this example, ignition can be produced by placing the arc in a region of the wake of the flame holders that is sheltered and that can have its own fuel supply system.

The pilot-burner technique is similar to the arc-ignition technique and can use an arc to initiate combustion. In the pilot burner technique, in an example, a small can burner is located in the primary stream tube. A continuous source of hot combustion products is established and acts in a manner similar to the hot-streak technique to start the stabilization process once fuel injection is started.

In some examples, ignition may be hard to achieve. In particular, because velocities and temperatures do not substantially change at the inlet of the afterburner 1300, ignition or “relighting” of the combustion process in the afterburner 1300 may be difficult to achieve when the aircraft 800 is flying at high altitudes. The difficulty is associated with the low pressure in the afterburner 1300 that affects both the preparation of the fuel (by the injector system) and the ignition process directly. Therefore, it can be desirable to have a system that better prepares the fuel for easier ignition in the afterburner 1300 at higher altitude.

Further, because the exhaust gas from the turbine 906 that enters the afterburner 1300 has reduced oxygen due to previous combustion at the combustor 904, and because the fuel is not burning in a highly compressed air environment, the afterburner 1300 is generally inefficient compared with the combustor 904. Efficiency of the afterburner 1300 can also decline as the inlet and tailpipe pressure decrease with increasing altitude. Thus, the afterburner 1300 significantly increases thrust at the cost of high fuel consumption and increased fuel inefficiency, thereby limiting its practical use to short bursts. As such, the afterburner 1300 is turned on selectively when the extra thrust is used, but is otherwise turned off. It can thus be desirable to have an afterburner that is more efficient to enable using the afterburner more often and more efficiently to enable persistent, as opposed to intermittent, supersonic flight.

The combustion taking place at the combustor 904 and the combustion taking place in the afterburner 1300 of the jet engine 802 can affect many of the operating characteristics of the jet engine 802. As examples, combustion determines fuel efficiency, thrust levels, and levels of emissions and transient response (the response to changing conditions such a fuel flow and air speed). It can thus be desirable to have an ignition system that prepares the fuel for efficient and thorough combustion, facilitates starting and restarting ignition when desired regardless of altitude, and enables combustion of a lean fuel mixture at high compression ratios to increase efficiency.

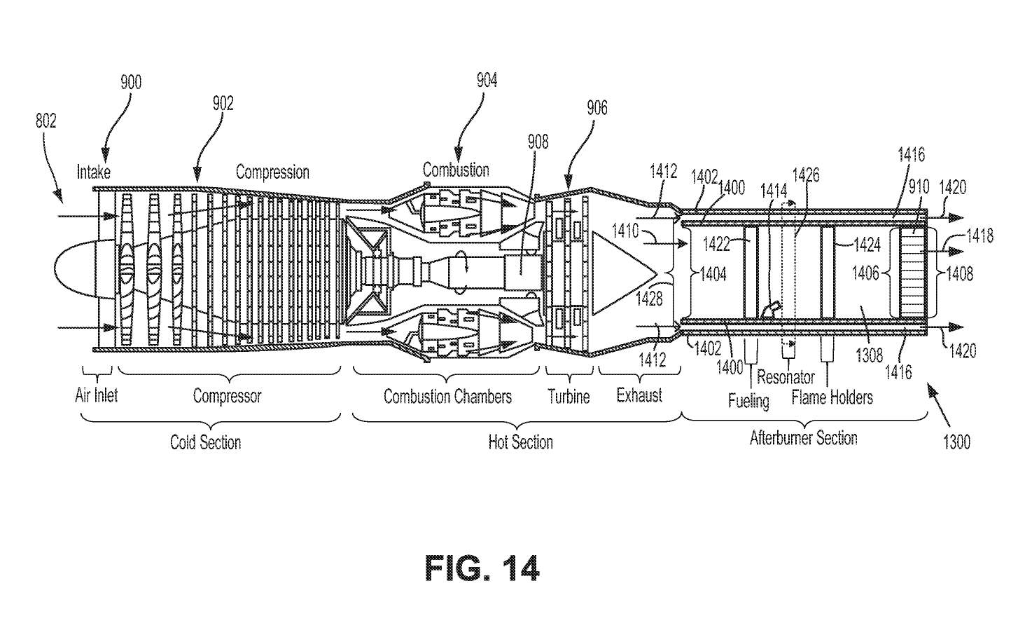

FIG. 14 shows the jet engine 802 and additional details of the afterburner 1300. In FIG. 14, the nozzle 910 is downstream from the turbine 906 to enable placing a fueling section 1422, a resonator section 1426, and a flame holders section 1424 between the turbine 906 and the nozzle 910. The flame holders 1302 can be disposed within the flame holders section 1424.

A torch igniter 1414 can, but need not necessarily, be disposed within the afterburner channel 1308. In an example implementation, the torch igniter 1414 can be disposed between the fueling section 1422 and the flame holders section 1424. The torch igniter 1414 can ignite fuel within the torch igniter 1414 to produce a flame that ignites fuel within the afterburner channel 1308.

The afterburner 1300, and particularly the fueling section 1422 and/or the resonator section 1426, can include a resonator according to the example implementations. The resonator can be a coaxial-cavity resonator, similar to the coaxial resonator 201 illustrated in FIG. 2, for example. Alternatively, the resonator can be a dielectric resonator, a crystal resonator, a ceramic resonator, a surface-acoustic-wave resonator, an yttrium-iron-garnet resonator, a rectangular-waveguide cavity resonator, a parallel-plate resonator, or a gap-coupled microstrip resonator. While reference is made to “QWCCR,” “QWCCR structure,” and “coaxial resonator” elsewhere in the disclosure, it will be understood that other types of resonators are possible and contemplated. Furthermore, the afterburner 1300, the fueling section 1422, and/or the resonator section 1426, can include at least one ring of resonators. Several examples of a ring of resonators are discussed below.

In the afterburner 1300, the nozzle 910 can be configured as an adjustable nozzle to vary the amount of thrust provided by the jet engine 802. Adjusting the nozzle 910 can include increasing or decreasing an aperture size of the nozzle 910. Decreasing the aperture size of the nozzle 910 constricts airflow through the nozzle 910 to increase the thrust of the jet engine 802. In an example implementation, the nozzle 910 is a component of the afterburner 1300. In another example implementation, the nozzle is a component removably attachable to the afterburner 1300 or provided in another manner.

As shown in FIG. 14, the afterburner 1300 can include an afterburner duct 1400, a casing 1402, and the afterburner channel 1308. The afterburner duct 1400 is a structure that defines the afterburner channel 1308. For example, the afterburner duct 1400 can include a metallic structure that defines a shape and volume of the afterburner channel 1308. As will be discussed below, a component of the afterburner 1300 can attach to and/or pass through the afterburner duct 1400. As an example, a fuel supply line for transferring fuel from a fuel tank outsider of the afterburner duct 1400 to a fuel outlet in the afterburner channel 1308 can attach to and/or pass through the afterburner duct 1400. In an example implementation, the afterburner duct 1400 can include a port for the fuel supply line to pass through the afterburner duct 1400. A port can include a through-hole in the afterburner duct 1400.

A fuel supply line can be made from one or more materials. As an example, the fuel supply line can comprise a steel tube or an aluminum tube. A fuel supply line can include multiple attachment fittings, such as multiple threaded fittings to connect a fuel supply line to fuel pump, a fuel storage tank, a resonator, another fuel supply line, a strut configured for transporting fuel, etc. A strut, for instance, can be one of multiple struts configured to support a bracket in the afterburner channel, such as a bracket in the center of the afterburner channel 1308 or proximate to the afterburner duct 1400. Such struts can include one or more fuel outlets and can be connected to or part of a fuel supply line connected to a fuel pump or fuel storage tank. The fuel outlets can be disposed within the struts to output fuel in a fuel spray pattern for the afterburner 1300. Further, a strut can include a tubular strut, having one or more passages that extend at least partially through a tube.

The afterburner duct 1400 includes an open end 1404. For example implementations in which the afterburner 1300 is attached to the turbine 906, the open end 1404 is in proximity to an exit 1428 of the turbine 906. In those example implementations, the open end 1404 is open to the exit 1428 to permit a gas 1410 from the turbine 906 to enter into the afterburner channel 1308. The gas 1410 can be referred to as an input gas from the turbine 906, an exhaust gas from the turbine 906, an input gas to the afterburner 1300, and/or an input gas to the afterburner channel 1308.

The afterburner duct 1400 includes another open end that is downstream and opposite the open end 1404. In the example implementation in which the nozzle 910 is a component removably attachable to the afterburner 1300, the other open end can be an open end that is upstream of the nozzle 910, such as the open end 1406. In the example implementation in which the nozzle 910 is a component of the afterburner 1300, the other open end can be an open end at or within the nozzle 910, such as the open end 1408. The afterburner channel 1308 can extend from the open end 1404 to the open end 1406 or 1408.

The gas 1410 that enters the afterburner channel 1308 at the open end 1404 can be mixed with fuel. Combustion of that gas and fuel mixture can occur within channel 1308. An exhaust gas 1418 formed during combustion of the gas and fuel mixture within the afterburner channel 1308 can exit the afterburner 1300 through the open end 1406 or 1408.

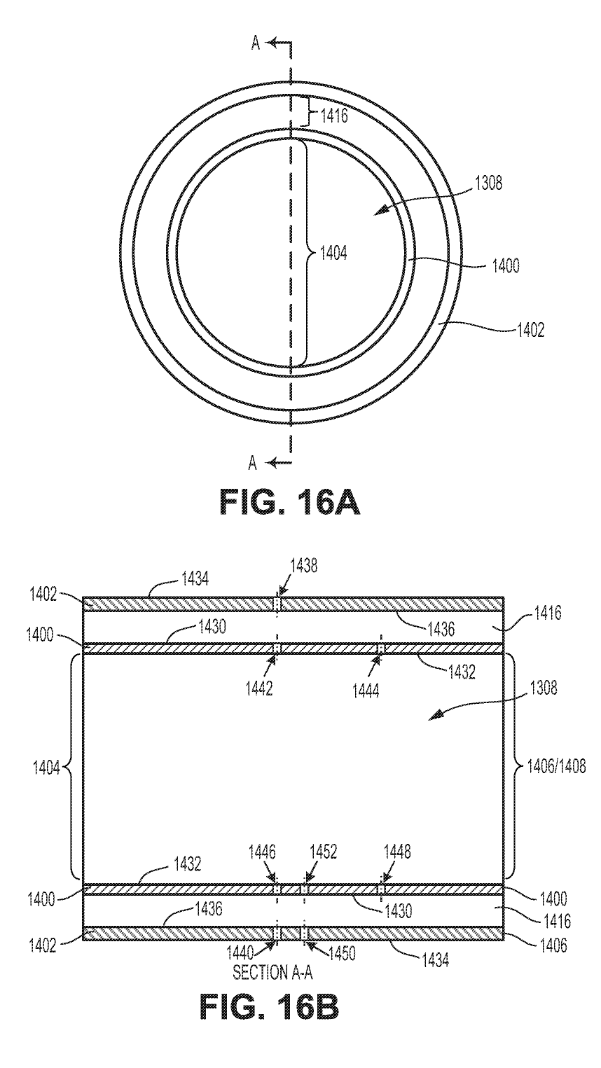

The casing 1402 can be configured to support the afterburner duct 1400 within the casing 1402. One or more brackets (not shown) and/or fasteners (not shown) can be used for attaching the afterburner duct 1400 to the casing 1402. The afterburner 1300 can include a cooling passage 1416 between the afterburner duct 1400 and the casing 1402. A gas 1412 from the turbine 906 can flow into the cooling passage 1416. The afterburner duct 1400 can include cooling ports (shown in FIG. 16B) so that at least some of the gas 1412 within the cooling passage 1416 can pass through the afterburner duct 1400 and into the afterburner channel 1308. A gas within the cooling passage 1416 and/or a gas within the cooling ports can cool the afterburner duct 1400. A gas 1420 can exit the cooling passage 1416 proximate the nozzle 910. The gas 1420 can include a portion of the gas 1412, such as a portion of the gas 1412 that did not pass through the cooling ports into the afterburner channel 1308.

A shape of the casing 1402 or some portion of the casing 1402 can be any of a variety of shapes. For an example implementation in which the casing 1402 is attached to the aircraft 800, the shape of the casing 1402 can depend on the shape of a portion of the aircraft 800 at which the casing 1402 attaches to the aircraft 800. The shape of a portion of the casing 1402 can be a cylinder, a rectangular prism, a pyramid, a frustum, or some other shape. Likewise, the shape of the entire casing 1402 can be a cylinder, a rectangular prism, a pyramid, a frustum, some other shape, or a combination of two or more shapes.

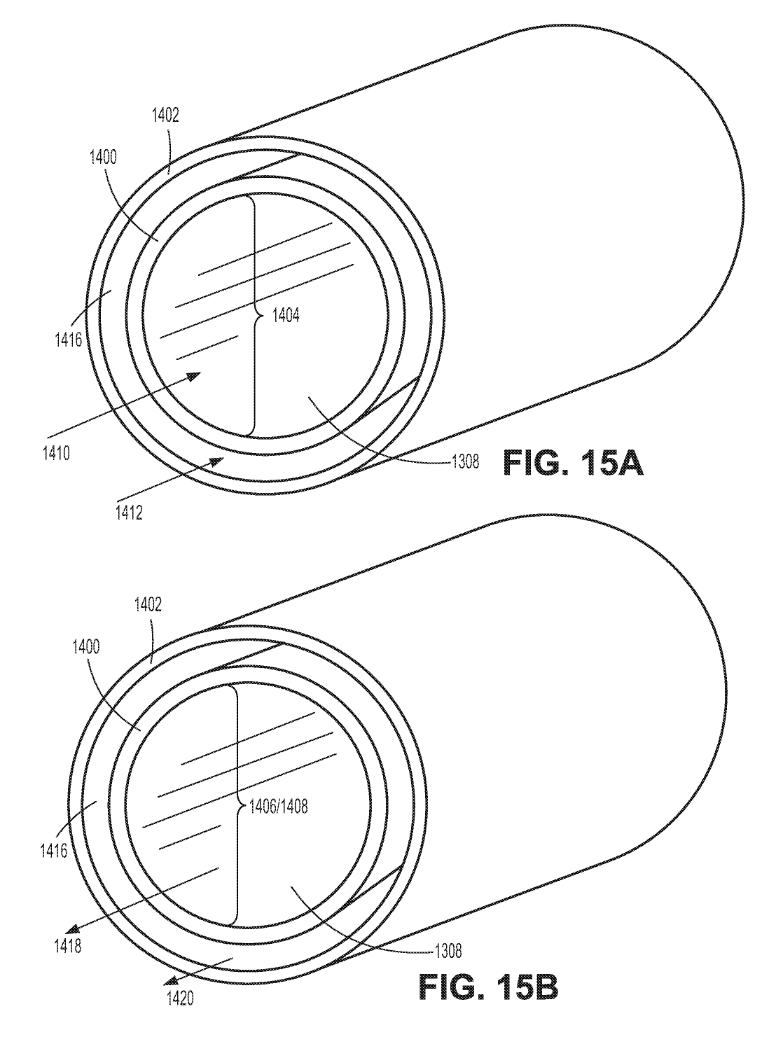

A shape of the afterburner duct 1400 or a portion of the afterburner duct 1400 can also be any of a variety of shapes. The shape of the afterburner duct 1400 or the portion of the afterburner duct 1400 can depend on the shape(s) of the casing 1402. The shape of a portion of the afterburner duct 1400 can be a cylinder, a rectangular prism, a pyramid, a frustum, or some other shape. And likewise, the shape of the entire duct 1400 can be a cylinder, a rectangular prism, a pyramid, a frustum, some other shape, or a combination of two or more shapes. For example purposes only, FIGS. 15A and 15B illustrate the afterburner duct 1400 and the casing 1402 both having cylindrical shapes. The afterburner duct 1400 and the casing 1402 do not necessarily have to have the same shapes. For example the afterburner duct 1400 can be cylindrical, and the casing can have a non-cylindrical shape, such as a rectangular prism.

Furthermore, in some example implementations the afterburner duct 1400 may serve as the casing for the afterburner.

FIG. 15A is a perspective view of the afterburner duct 1400 and the casing 1402 with a view of the open end 1404. FIG. 15A shows a portion of the afterburner channel 1308, and a portion of the cooling passage 1416. The gas 1410 enters the afterburner channel 1308 through the open end 1404. The gas 1412 enters the cooling passage 1416 proximate the open end 1404.

FIG. 15B is a perspective view of the afterburner duct 1400 and the casing 1402 with a view of the open end 1406 or 1408. FIG. 15B shows a portion of the afterburner channel 1308, and a portion of the cooling passage 1416. The exhaust gas 1418 exits the afterburner channel 1308 through the open end 1406 or 1408. The gas 1420 exits the cooling passage 1416 proximate the open end 1406 or 1408.

FIG. 16A is an elevation view of the afterburner duct 1400 and the casing 1402 from the side of the afterburner duct 1400 having the open end 1404. FIG. 16A shows that the cooling passage 1416 is between the afterburner duct 1400 and the casing 1402. FIG. 16A also shows the afterburner channel 1308 is within the afterburner duct 1400.

FIG. 16B is a cross-sectional view A-A of the afterburner duct 1400 and the casing 1402 shown in FIG. 16A. As shown in FIG. 16B, the casing 1402 has an outer surface 1434 and an inner surface 1436. Similarly, the afterburner duct 1400 has an outer surface 1430 and an inner surface 1432. The cooling passage 1416 can be formed by at least the outer surface 1430 in cooperation with the inner surface 1436. The open end 1404 and the open end 1406 or 1408 extend between portions of the inner surface 1432 shown in FIG. 16B.

FIG. 16B also shows ports 1438, 1440, 1450 within the casing 1402, and ports 1442, 1444, 1446, 144, 1452 within the afterburner duct 1400. A port in the casing 1402 and a port in the afterburner duct 1400 can be aligned, such as the pair of ports 1438, 1442, the pair of ports 1440, 1446, and the pair of ports 1450, 1452. A pair of aligned ports can provide a path for routing a fuel supply line, a strut, an electrical circuitry conduit, and/or a resonator, through the casing 1402 and the afterburner duct 1400, into the afterburner channel 1308. A port in the afterburner duct 1400, such as the ports 1444, 1448 might not be aligned with a port in the casing 1402. Those ports may be used as cooling ports and/or cooling air holes. Some of the gas 1412 flowing within the cooling passage 1416 can pass through the ports 1444, 1148 to reduce a temperature of the afterburner duct 1400.

Returning to FIG. 14, the torch igniter 1414 could be used to initiate combustion of fuel within the afterburner channel 1308 when additional thrust by the jet engine 802 is requested. The torch igniter 1414 or another shield can shield a resonator from at least a portion of a force occurring in the channel due to a gas flowing through the afterburner channel 1308. Shielding a resonator using the torch igniter 1414 or another shield in proximity to the resonator may permit the resonator to provide a plasma corona with a shape that improves combustion of the fuel within the channel.

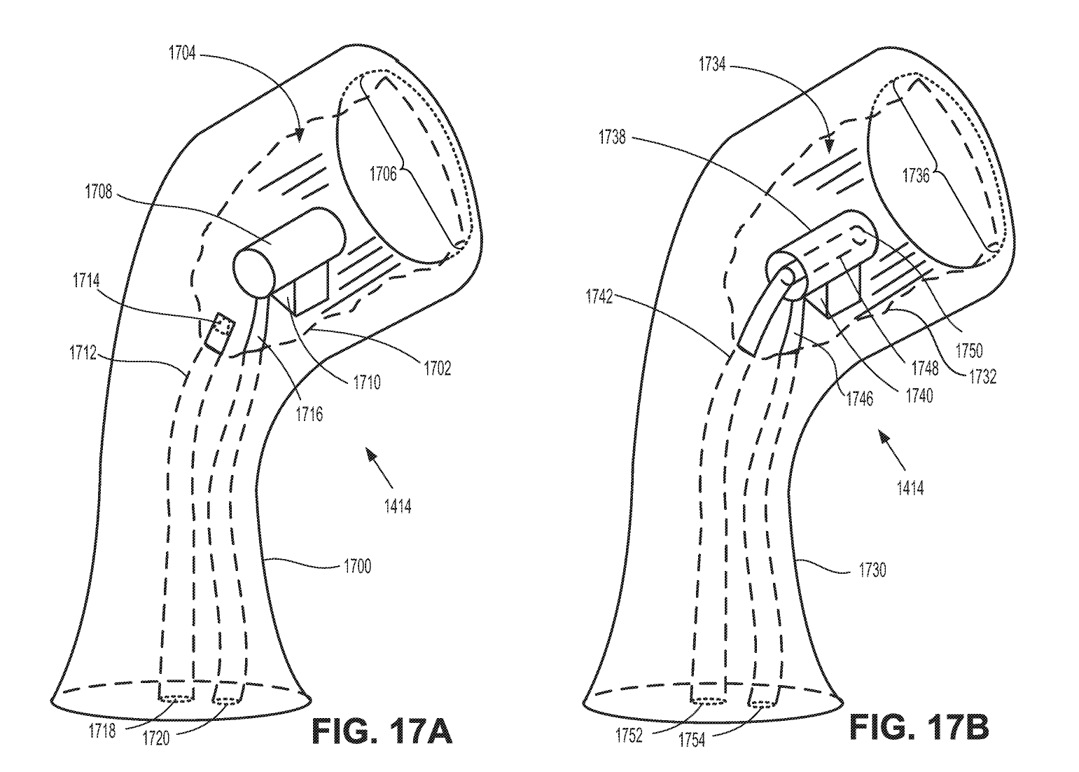

FIG. 17A illustrates details of the torch igniter 1414 in accordance with an example implementation. As shown in FIG. 17A, the torch igniter 1414 includes a casing 1700. A portion of the casing 1700 bounded by a broken line 1702 is cut away to show other portions of the torch igniter 1414. The torch igniter 1414 includes a torch igniter channel 1704, a torch igniter opening 1706, a resonator 1708, and an attachment bracket 1710 for attachment of the resonator 1708 within the torch igniter channel 1704.

The torch igniter 1414 includes a fuel supply line 1712 and an electrical circuitry conduit 1716. The fuel supply line 1712 includes an outlet 1714 for outputting fuel into the torch igniter channel 1704. The fuel supply line 1712 can pass through a hole 1718 in the casing 1700 and through a pair of ports, such as the ports 1446, 1440, so that the fuel within a fuel pump and/or fuel tank, outside of the casing 1402, can be provided to outlet 1714. A portion of the electrical circuitry conduit 1716 can pass through a hole 1720 in the casing 1700 and through a pair of ports, such as the ports 1452, 1450, so that electrical circuitry can be routed within the electrical circuitry conduit 1716 from outside of the casing 1402 to the resonator 1708.

The resonator 1708 can be arranged like any resonator discussed in this disclosure. Accordingly, the electrical circuitry conduit 1716 can include electrical conductors to and from a signal generator, such as the signal generator 202 shown in FIG. 2, or electrical conductors to and from a signal generator and a DC power source, such as the signal generator 202 and the DC power source shown in FIGS. 3A, 3B, and 4A.

A fuel pump, such as the fuel pump 504, can pump fuel through the fuel supply line 1712. The fuel within the fuel supply line 1712 can be output through the outlet 1714 and into the torch igniter channel 1704. The resonator 1708 can be excited with a signal carried on electrical conductors within the electrical circuitry conduit 1716 to generate a plasma corona. That plasma corona can cause combustion of the fuel output into the torch igniter channel 1704. A flame generated by combustion of the fuel in the torch igniter channel 1704 can pass through the torch igniter opening 1706 in order to start combustion of fuel within the afterburner channel 1308.

FIG. 17B illustrates details of the torch igniter 1414 in accordance with another example implementation. As shown in FIG. 17B, the torch igniter 1414 includes a casing 1730. A portion of the casing 1730 bounded by a broken line 1732 is cut away to show other portions of the torch igniter 1414. The torch igniter 1414 includes a torch igniter channel 1734, a torch igniter opening 1736, a resonator 1738, and an attachment bracket 1740 for attachment of the resonator 1738 within the torch igniter channel 1734.

The torch igniter 1414 includes a fuel supply line 1742 and an electrical circuitry conduit 1746. The fuel supply line 1742 is removably connectable to a fuel conduit 1748 within the resonator 1738. The fuel conduit 1748 includes an outlet 1750 for outputting fuel into the torch igniter channel 1734. The fuel supply line 1742 can pass through a hole 1752 in the casing 1730 and through a pair of ports, such as the ports 1446, 1440, so that the fuel within a fuel pump and/or fuel tank, outside of the casing 1402, can be provided to outlet 1750. A portion of the electrical circuitry conduit 1746 can pass through a hole 1754 in the casing 1730 and through a pair of ports, such as the ports 1452, 1450, so that electrical circuitry can be routed within the electrical circuitry conduit 1746 from outside of the casing 1402 to the resonator 1738.

The resonator 1738 can be arranged like any resonator discussed in this disclosure. Accordingly, the electrical circuitry conduit 1746 can include electrical conductors to and from a signal generator, such as the signal generator 202 shown in FIG. 2, or electrical conductors to and from a signal generator and a DC power source, such as the signal generator 202 and the DC power source shown in FIGS. 3A, 3B, and 4A.

A fuel pump, such as the fuel pump 504, can pump fuel through the fuel supply line 1742. The fuel within the fuel supply line 1742 can be output through the outlet 1750 and into the torch igniter channel 1734. The resonator 1738 can be excited with a signal carried on electrical conductors within the electrical circuitry conduit 1746 to generate a plasma corona. That plasma corona can cause combustion of the fuel output into the torch igniter channel 1734. A flame generated by combustion of the fuel in the torch igniter channel 1734 can pass through the torch igniter opening 1736 in order to start combustion of fuel within the afterburner channel 1308. In this example implementation, outputting the fuel in proximity to the plasma corona can help improve efficiency of combustion of the fuel.

As indicated above, the torch igniter 1414 can be used to initiate combustion of fuel within the afterburner channel 1308. In other implementations, combustion of fuel within the afterburner channel 1308 can be initiated by a resonator or resonators that are not within the torch igniter 1414. In still other implementations, combustion of fuel within the afterburner channel 1308 can be initiated by both the torch igniter 1414 and a resonator or resonators that are not within the torch igniter 1414.

Returning to FIG. 14, the fueling section 1422 is a section of the afterburner 1300 that includes a fuel outlet for outputting fuel into the afterburner channel 1308. The fuel outlet within the fueling section 1422 can be disposed within a component of the afterburner, such as a strut, a resonator, or a fuel injector. The fuel output by the fuel outlet can mix with the gas the afterburner 1300 receives from the turbine 906. The fueling section 1422 can include a ring of resonators in which at least one resonator in the ring includes at least one fuel conduit and at least one fuel outlet. The afterburner 1300 can include multiple fueling sections having a separate ring of resonators in which at least one resonator in the ring includes at least one fuel conduit and at least one fuel outlet. Furthermore, a resonator in a ring of resonators in the fueling section 1422 does not necessarily have to include a fuel conduit and fuel outlet. A plasma corona provided by a resonator in the afterburner 1300 can cause combustion of the fuel output by the fueling section 1422 and/or by a resonator in the fueling section 1422.

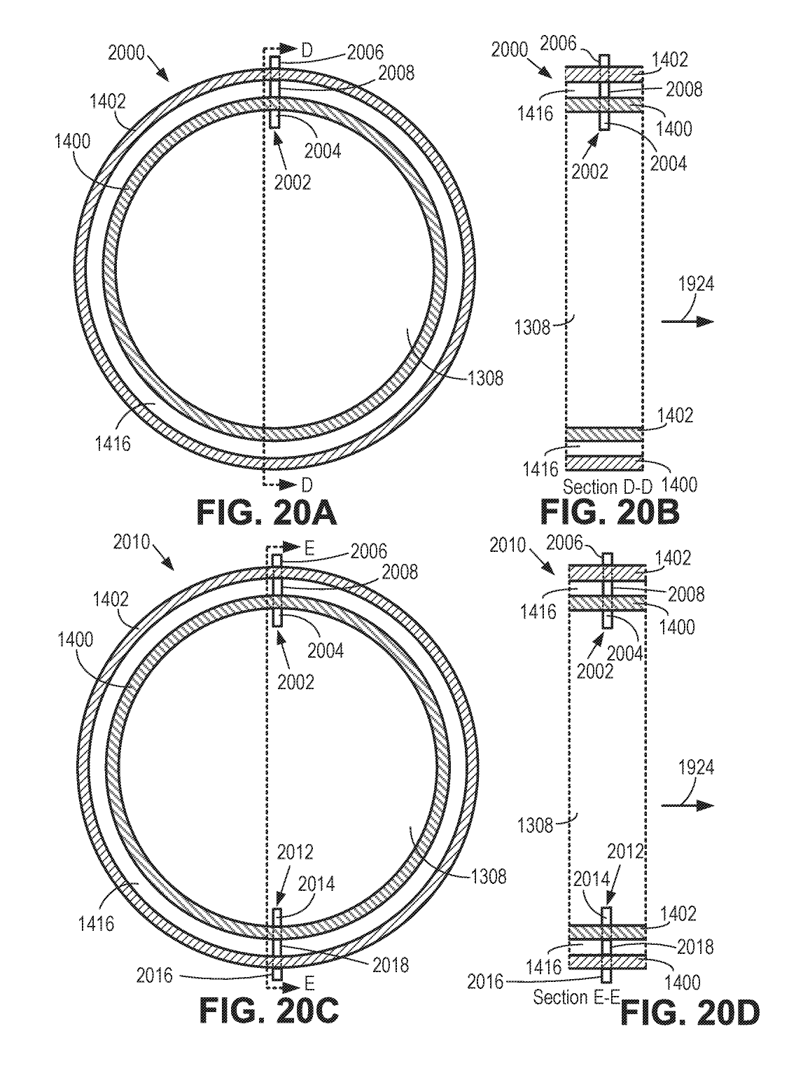

The resonator section 1426 is a section of the afterburner 1300 that includes one or more resonators. In some implementations, multiple resonators in the resonator section 1426 and/or otherwise within the afterburner are arranged as a ring of resonators. Furthermore, a resonator section that includes (i) one or more resonators, (ii) a fuel conduit within the resonator, and (iii) a fuel outlet within the fuel conduit, can also be considered a fueling section. Examples of a resonator section, such as the resonator section 1426, are shown in FIGS. 20A to 27D.

A resonator of the afterburner 1300 can be configured to be electromagnetically coupled to a radio-frequency power source, such as the signal generator 202. A resonator of the afterburner 1300 can be configured to provide electromagnetic waves and/or a plasma corona when the resonator is excited by the radio-frequency power source. A resonator of the afterburner 1300 can be arranged like any resonator discussed in this disclosure. A resonator of the afterburner 1300 can be disposed outside of the afterburner channel 1308, disposed within the afterburner channel 1308, or partially disposed within the afterburner channel 1308 and partially disposed outside of the afterburner channel 1308.

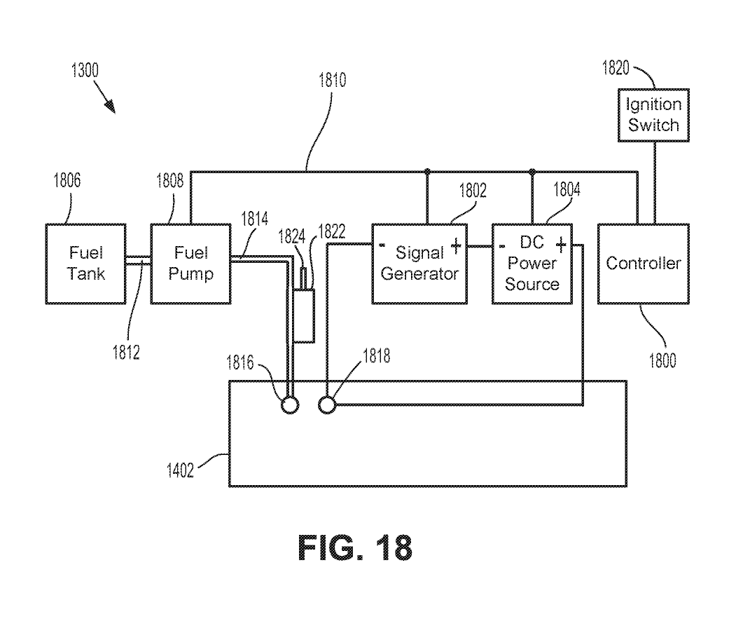

FIG. 18 is a block diagram showing additional features of the afterburner 1300 in accordance with an example implementation. As shown in FIG. 18, the afterburner 1300 includes a controller 1800, a signal generator 1802, a DC power source 1804, a fuel tank 1806, a fuel pump 1808, fuel supply lines 1812, 1814, ports 1816, 1818, and ignition switch 1820. A system bus, network or other connection mechanism 1810 can communicatively couple the controller 1800 to the signal generator 1802, the DC power source 1804, and/or the fuel pump 1808. The ports 1816, 1818 can extend through the casing 1402 or through the casing 1402 and the afterburner duct 1400. The ignition switch 1820 can be configured for changing a signal level, such as a voltage level, on an input line to the controller 1800 to signal that use of the afterburner 1300 is requested or that use of the afterburner 1300 is no longer requested.

The fuel pump 1808 can be installed within the fuel tank 1806 and/or can be attached to the fuel tank 1806 by the fuel supply line 1812. The fuel tank 1806 and the fuel pump 1808 can be located outside of the casing 1402. The fuel supply line 1814 is attached to the fuel pump 1808 and can be routed along the casing 1402 to the port 1816, at which point the fuel supply line 1814 can pass through the casing 1402 to enter the afterburner 1300. The fuel supply line 1814 can further pass through the afterburner duct 1400 so that a portion of the fuel supply line 1814 is disposed within the afterburner channel 1308. The fuel supply line 1814 can include and/or connect to a strut, such as a tubular strut, that projects inward through the casing 1402, through the afterburner duct 1400 and into the afterburner channel 1308.

Electrical circuitry can be connected to the signal generator 1802 and/or the DC power source 1804. The signal generator 1802 can be arranged like any signal generator discussed in this disclosure, such as the signal generator 202. For instance, the signal generator 1802 can include a radio-frequency power source discussed in this disclosure. Moreover, the signal generator 1802 can include at least one signal generator (in other words, one or more signal generators), such as at least one radio-frequency power source. For the implementations in which the afterburner 1300 includes a plurality of resonators that are electromagnetically coupled to and/or configured to electromagnetically couple to the at least one radio-frequency power source, each resonator can be electromagnetically coupled to and/or configured to electromagnetically couple to a separate radio-frequency power source or to a radio-frequency power source electromagnetically coupled to and/or configured to electromagnetically couple to at least one other resonator of the plurality of resonators.

For some implementations, as discussed, the signal generator 1802 can include a single signal generator. That signal generator 1802 can provide one resonator with a signal to excite that resonator. Alternatively, that signal generator 1802 can, for example, provide multiple resonators with a signal to excite those multiple resonators. As an example, the signals can be provided by multiple signal outputs of the signal generator 1802. As another example, the signals can be provided by a single signal output of the signal generator 1802 and travel to the multiple resonators via parallel electrical circuitry.

Furthermore, for some implementations, as discussed, the signal generator 1802 can include multiple signal generators. For some of those implementations, each signal generator 1802 can electromagnetically couple to a respective resonator of the multiple resonators. For some other implementations, one or more of the multiple signal generators can electromagnetically couple to two or more resonators. As an example, a first signal generator can electromagnetically couple to a set of one or more resonators configured for providing electromagnetic waves and a plasma corona, and a second signal generator can electromagnetically couple to a set of one or more resonators configured for providing electromagnetic waves, but not the plasma corona.

Furthermore, in some implementations, the signal provided by the signal generator 1802 to one or more resonators electromagnetically coupled to the signal generator 1802 can include a pulsed signal. In some of those implementations, the pulsed signal can, but need not necessarily, include a pulse train, a non-sinusoidal waveform, or a square wave. As an example, the pulsed signal provided by the signal generator 1802 can include a pulsed signal within the range of 100-1000 Hz. The frequency range of the pulsed signal can vary based on an amplifier used by and/or in conjunction with the signal generator 1802. The pulsed signal has a duty cycle. The duty cycle can, but need not necessarily, be fifty percent on and fifty percent off. For instance, in some implementations, the duty cycle could be within the range twenty percent on and eighty percent off, to eighty percent on and twenty percent off. Increasing the duty cycle of the pulsed signal can result in transferring more energy to the resonator(s) receiving the pulsed signal.

The DC power source 1804 can be arranged like any DC power source discussed in this disclosure, such as the DC power source 302. Moreover, the DC power source 1804 can include at least one DC power source (in other words, one or more DC power sources). For the implementations in which the afterburner 1300 includes a plurality of resonators, each resonator can be electromagnetically coupled to and/or configured to electromagnetically couple to a separate DC power source or to a DC power source electromagnetically coupled to and/or configured to electromagnetically couple to at least one other resonator of the plurality of resonators.

In an example implementation, the electrical circuitry connected to the signal generator 1802 and/or the DC power source 1804 can be routed along the outer surface 1434 of the casing 1402. In another example implementation, the electrical circuitry connected to the signal generator 1802 and/or the DC power source 1804 can be routed to the port 1816, at which point the electrical circuitry can pass through the casing 1402 to enter the afterburner 1300. The electrical circuitry connected to the signal generator 1802 and/or the DC power source 1804 can also connect to a resonator of the afterburner 1300, such as a resonator in a ring of resonators. As shown in FIG. 18, the electrical circuitry provided to the port 1818 can include an electrical circuit connected to the signal generator 1802 and an electrical circuit connected to the DC power source 1804. In another implementation, two electrical circuits from the signal generator 1802 can be provided to the port 1818 for connection to a resonator disposed in the afterburner channel 1308.

In an example implementation, the resonator of the afterburner 1300 can include a resonator completely disposed within the afterburner channel 1308, a resonator partially disposed within the afterburner channel 1308 and partially disposed outside of the afterburner channel 1308, and/or a resonator completely disposed outside of the afterburner channel 1308. The resonator of the afterburner 1300 can include an electrode disposed within the afterburner channel 1308. And the signal generator 1802 can be configured to excite the resonator of the afterburner 1300 with a radio frequency signal. Further, for implementations in which the resonator of the afterburner 1300 includes two conductors, the DC power source 1804 can be configured to provide a bias signal between those two conductors.

Exciting the resonator of the afterburner 1300 with the radio frequency signal can cause the resonator to provide electromagnetic waves and/or a plasma corona within the afterburner 1300. In an example implementation in which the electrode of the resonator is disposed within the afterburner channel 1308, that resonator can provide the electromagnetic waves and/or a plasma corona within the afterburner channel 1308. In another example implementation, the resonator of the afterburner 1300 can provide the electromagnetic waves and/or a plasma corona within the torch igniter channel 1704, 1734. In yet another example implementation, the resonator of the afterburner 1300 can provide the electromagnetic waves within a fuel supply line, such as the fuel supply line 1814, a fuel supply line leading to a fuel outlet, and/or a fuel conduit within a resonator.

The fuel supply line 1814 can include and/or be fluidly coupled to a treatment chamber 1822. In an example implementation, the treatment chamber 1822 can be within the afterburner channel 1308. In another example implementation, the treatment chamber 1822 can be outside of the afterburner channel 1308, such as a treatment chamber attached to the casing 1402. At least a portion of a resonator 1824, such as a distal end of the resonator 1824, can be disposed within the treatment chamber 1822 and excited by a signal from the signal generator 1802 so that the electromagnetic waves can be used to modify the fuel in any of the ways presently discussed in order to “pretreat” the fuel within the treatment chamber 1822. The fuel, after being exposed to electromagnetic waves in the treatment chamber 1822, can flow through the fuel supply line 1814 to afterburner channel 1308 and/or a fuel outlet, such as a fuel outlet within a fuel conduit in a resonator. A portion of the fuel supply line 1814, such as a portion between the treatment chamber 1822 and the afterburner channel 1308 and/or the fuel outlet can be made of a material, such as a metal or a rare earth magnetic material, that can insulate the electromagnetic effects of the pretreated fuel while the pretreated fuel is in transit within the fuel supply line 1814 from the treatment chamber 1822.

The controller 1800 can be configured to perform a variety of operations. For example, the controller 1800 can be configured to cause fuel within a fuel tank, such as the fuel tank 1806, to be pumped through a fuel supply line, such as fuel supply lines 1812, 1814, and into the afterburner channel 1308 for mixing with a gas within the afterburner channel 1308. The controller 1800 can be configured to cause fuel to be output through a fuel outlet, such as any fuel outlet discussed in this disclosure. As another example, the controller 1800 can be configured to cause the DC power source 1804 to switch from one operating state to another operating state, such as an operating state in which the DC power source 1804 is providing a bias signal between two conductors of a resonator of the afterburner 1300 to an operating state in which the DC power source 1804 is not providing the bias signal between those two conductors of the resonator. As another example, the controller 1800 can be configured to cause the signal generator 1802 to output a radio frequency signal.

The controller 1800 can control one or more DC power sources and/or one or more radio-frequency power sources connected to the resonators of a ring of resonators. In some implementations, the signal generator 1802 includes at least a first radio-frequency power source and a second radio-frequency power source, and the ring of resonators includes at least (i) a first resonator set having at least one resonator configured to be electromagnetically coupled to at least the first radio-frequency power source, and (ii) a second resonator set having at least one resonator configured to be electromagnetically coupled to at least the second radio-frequency power source. Each first radio-frequency power source is configured to provide the signal to at least one resonator of the first resonator set. Likewise, each second radio-frequency power source is configured to provide the signal to at least one resonator of the second resonator set. The DC power source 1804 can include one or more direct-current power source. Those direct-current power sources can provide a bias signal between the first conductor and the second conductor of each resonator in the ring of resonators. In some of the implementations, at least a portion of each resonator of the first ring of resonators is at least partially disposed in the afterburner channel 1308 upstream or downstream of the second ring of resonators.

The controller 1800 can include a processor, a memory, and a data transceiver. The processor can include one or more general purpose processors (for example, an INTEL® single core microprocessor or an INTEL® multicore microprocessor), and/or one or more special purpose processors (for example, a digital signal processor, a graphics processor, or an application specific integrated circuit (ASIC) processor). The processor can be configured to execute computer-readable program instructions. The processor can be configured to execute hard-coded functionality in addition to or instead of software-coded functionality.

The memory can include one or more memories. The memory can comprise a non-transitory memory or a transitory memory. The non-transitory memory can be located within or as part of the processor (for example, within a single integrated circuit chip) or can be separate and distinct from the processor. The non-transitory memory can include a volatile or non-volatile storage component, such as an optical, magnetic, organic or other memory or disc storage component. The non-transitory memory can include or be configured as a random-access memory (RAM), a read-only memory (ROM), a programmable read-only memory (PROM), an erasable programmable read-only memory (EPROM), an electrically erasable programmable read-only memory (EEPROM), or a compact disk read-only memory (CD-ROM). The RAM can include static RAM or dynamic RAM.

The data transceiver can include a receiver to receive data transmitted over a wired or wireless communication link, and a transmitter to transmit data over the wired or wireless communication link. In an example implementation, the controller 1800 can be arranged like the controller 402 shown in FIG. 4B.

### X. Resonator(s) in Afterburner Implementations

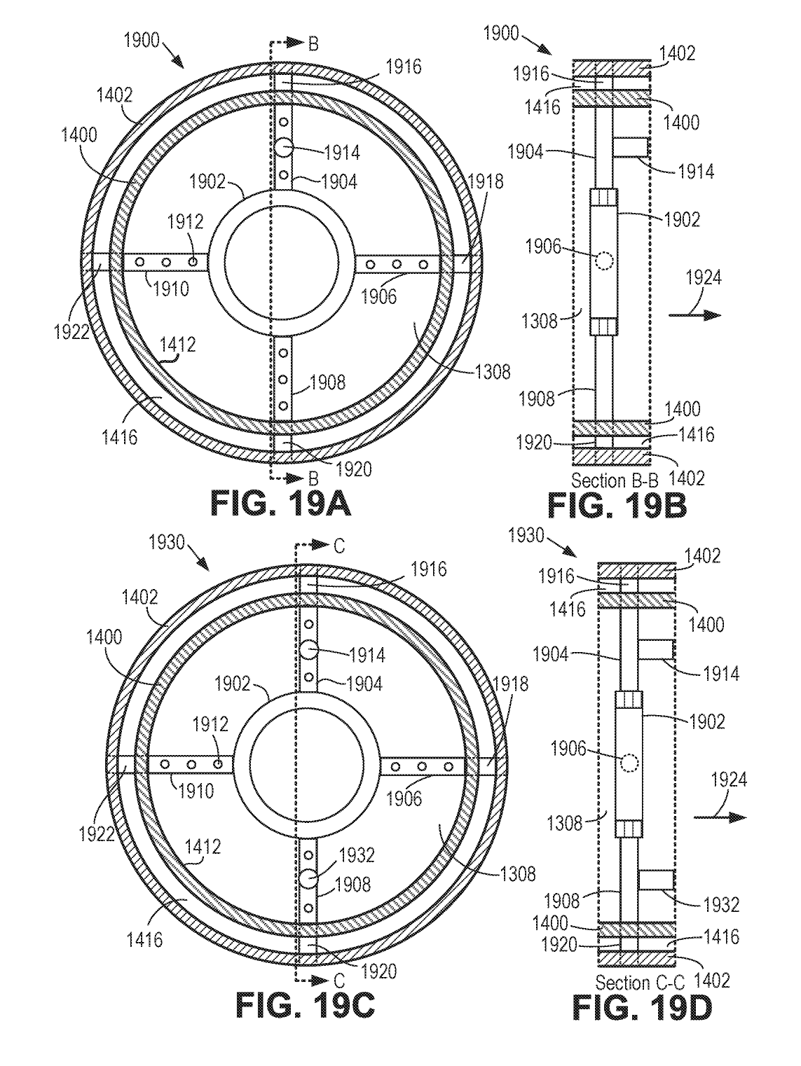

FIG. 19A is a cross-sectional view of a fueling section 1900 for an example implementation in which a shape of at least a portion of the afterburner duct 1400 is annular. At least a portion of the casing 1402 can, but need not necessarily, have an annular shape. The fueling section 1900 is an example implementation of the fueling section 1422 shown in FIG. 14.

The fueling section 1900 includes a bracket 1902 within the afterburner channel 1308 and includes struts 1904, 1906, 1908, 1910. The bracket 1902 can support the struts 1904, 1906, 1908, 1910. A portion (not shown) of each of the struts 1904, 1906, 1908, 1910 can be disposed within a port in the afterburner duct 1400. Portions 1916, 1918, 1920, 1922 of the struts 1904, 1906, 1908, 1910, respectively, can be disposed within the cooling passage 1416. A portion (not shown) of each of the struts 1904, 1906, 1908, 1910 can be disposed within a port in the casing 1402. Further, a portion (not shown) of each of the struts 1904, 1906, 1908, 1910 can be disposed outside of the casing 1402 for attaching the struts 1904, 1906, 1908, 1910 to the casing 1402. In some implementations, the struts 1904, 1906, 1908, 1910 are tubular struts with one or more passages.

In an example implementation, a strut supported by and/or attached to the bracket 1902 can be connected to a portion of a fuel supply line, such as the fuel supply line 1814. A strut connected to the fuel supply line 1814 can include an outlet, such as an outlet 1912, for outputting fuel into the afterburner channel 1308. In another example implementation, a strut supported by and/or attached to the bracket 1902 can be connected to the fuel supply line 1814 and a resonator can be attached to the strut, such as a resonator 1914 attached to the strut 1904. A strut connected to a fuel supply line can be part of that fuel supply line.

In another example implementation, a strut supported by and/or attached to the bracket 1902 can include a passage for electrical circuitry that is connected to the signal generator 1802 and/or the DC power source 1804. In yet another example implementation, a strut supported by and/or attached to the bracket 1902 can include both a passage for the electrical circuitry and a portion of a fuel supply line. For the example implementations that include a strut supported by and/or attached to the bracket 1902, the implementations can include a number of struts other than four struts as shown in FIG. 19A.

The resonator 1914 can be configured as any resonator discussed in this disclosure. Electrical circuitry connected to the signal generator 1802 and/or the DC power source 1804 can connect to the resonator 1914. In some example implementations, the resonator 1914 can include a fuel conduit. In accordance with those implementations, the fuel conduit can be fluidly coupled to a fuel passage within the strut 1904. The resonator 1914 can be configured to provide electromagnetic waves and/or a plasma corona in response to being excited by a radio frequency signal from the signal generator 1802.

Components, such as a fuel supply line and/or a fuel conduit, that are fluidly coupled are components connected together such that a fluid, such as a fuel, can flow from one component to the other component. In some implementations, two components can be fluidly coupled such that the fluid can flow from a first component to a second component and from the second component to the first component. In other implementations, two components can be fluidly coupled such that the fluid can flow from the first component to the second component, but not from the second component to the first component. Those other implementations can, for example, include a one-way check valve that prevents the fluid within the second component to flow into the first component.

FIG. 19B is a cross-sectional view of the fueling section 1900. FIG. 19B includes an arrow 1924 to indicate a direction that a gas could flow through the afterburner channel 1308 and the cooling passage 1416 within the fueling section 1900. The vertical dashed lines in FIG. 19B, as well as in FIGS. 19D, 20B, 20D, 21B, 21D, 22B, 22D, 23B, and 23D represent left and right ends of a section cut out of the afterburner 1300, rather than any hidden feature show in those figures.

FIG. 19C is a cross-sectional view of a fueling section 1930 for an example implementation in which a shape of at least a portion of the afterburner duct 1400 is annular. At least a portion of the casing 1402 can, but need not necessarily, have an annular shape The fueling section 1930 is an example implementation of the fueling section 1422 shown in FIG. 14, and is one of many possible variations of the fueling section 1900 shown in FIG. 19A. This variation shows the fueling section 1930 with a resonator on multiple different struts.

The fueling section 1930 includes the bracket 1902 within the afterburner channel 1308 and includes the struts 1904, 1906, 1908, 1910, as discussed above. The fueling section 1930 includes multiple resonators attached to the struts. As shown in FIG. 19C, the resonator 1914 is attached to the strut 1904, and a resonator 1932 is attached to the strut 1908. For the example implementations that include one or more struts in the fueling section 1930, more than two resonators can be attached to the struts. Furthermore, more than one resonator can be attached to a single strut.

The resonator 1932 can be configured as any resonator discussed in this disclosure. Electrical circuitry connected to the signal generator 1802 and/or the DC power source 1804 can connect to the resonator 1932. In some example implementations, the resonator 1932 can include a fuel conduit. In accordance with those implementations, the fuel conduit can be fluidly coupled to a fuel passage within the strut 1908. The resonator 1932 can be configured to provide electromagnetic waves and/or a plasma corona in response to being excited by a radio frequency signal from the signal generator 1802.

FIG. 19D is a cross-sectional view of the fueling section 1930. FIG. 19D includes an arrow 1924 to indicate a direction that a gas could flow through the afterburner channel 1308 and the cooling passage 1416 within the fueling section 1930. A resonator, or at least a portion of a resonator that extends from the casing 1402, through the afterburner duct 1400, and into the afterburner channel 1308, can be disposed between a strut of the fueling section 1900, 1930 and the open end 1406 or 1408 of the afterburner duct 1400.

FIG. 20A is a cross-sectional view of a resonator section 2000 for an example implementation in which a shape of at least a portion of the afterburner duct 1400 is annular.

The casing 1402 can, but need not necessarily, have an annular shape. The resonator section 2000 is an example implementation of the resonator section 1426 shown in FIG. 14.

The resonator section 2000 includes a resonator 2002. A portion 2004 of the resonator 2002 is disposed within the afterburner channel 1308, and another portion of the resonator 2002 is disposed outside of the afterburner channel 1308. In accordance with an example implementation, the portion of the resonator 2002 outside of the afterburner channel 1308 can include a portion 2006 outside of the casing 1402, a portion 2008 between the afterburner duct 1400 and the casing 1402, a portion (not shown) that is within a port in the afterburner duct 1400, and a portion (not shown) that is within a port in the casing 1402. The portion 2004 can include an electrode for providing electromagnetic waves and/or a plasma corona within the afterburner channel 1308 when the resonator 2002 is excited by a signal from the signal generator 1802.

The resonator 2002 can be configured as any resonator discussed in this disclosure. Electrical circuitry connected to the signal generator 1802 and/or the DC power source 1804 can connect to the resonator portion 2006. In this way, the electrical circuitry connected to the resonator 2002 does not have to be routed through the casing 1402, through the afterburner duct 1400, or within the afterburner channel 1308. In some example implementations, the resonator 2002 can include a fuel conduit. In accordance with those implementations, a fuel supply line can connect to the portion 2006 so that the fuel supply line to the resonator 2002 does not have to be routed through the casing 1402.

FIG. 20B is a cross-sectional view of the resonator section 2000. FIG. 20B includes an arrow 1924 to indicate a direction that a gas could flow through the afterburner channel 1308 and the cooling passage 1416 within the resonator section 2000.

FIG. 20C is a cross-sectional view of a resonator section 2010 for an example implementation in which a shape of at least a portion of the afterburner duct 1400 is annular. The casing 1402 can, but need not necessarily, have an annular shape. The resonator section 2010 is one of many possible variations of the resonator section 2000 shown in FIG. 20. This variation shows the resonator section 2010 with resonators at a top and bottom of the afterburner channel 1308.

The resonator section 2010 includes multiple resonators. FIG. 20C shows the resonator 2002 and a resonator 2012. As with the resonator 2002 discussed above, a portion 2014 of the resonator 2012 is disposed within the afterburner channel 1308, and another portion of the resonator 2012 is disposed outside of the afterburner channel 1308. Similarly, in accordance with an example implementation, the portion of the resonator 2012 outside of the afterburner channel 1308 can include a portion 2016 outside of the casing 1402, a portion 2018 between the afterburner duct 1400 and the casing 1402, a portion (not shown) that is within a port in the afterburner duct 1400, and a portion (not shown) that is within a port in the casing 1402.

As with the resonator 2002, the resonator 2012 can be configured as any resonator discussed in this disclosure. Electrical circuitry connected to the signal generator 1802 and/or the DC power source 1804 can connect to the resonator portion 2016. In this way, the electrical circuitry connected to the resonator 2012 does not have to be routed through the casing 1402, through the afterburner duct 1400, nor within the afterburner channel 1308. In some example implementations, the resonator 2012 can include a fuel conduit. In accordance with those implementations, a fuel supply line can connect to the portion 2016 so that the fuel supply line to the resonator 2012 does not have to be routed through the casing 1402.

The multiple resonators within the resonator section 2010 can be spaced apart equally. For example, adjacent resonators can be spaced apart by a common number of degrees. As shown in FIG. 20C, the resonators 2002 and 2012 are spaced apart by one-hundred eighty degrees. If the multiple resonators within the resonator section 2010 include more than two resonators, those multiple resonators can, but need not necessarily, be spaced apart equally. The multiple resonators within the resonator section 2010 can be part of and/or form a ring of resonators.

FIG. 20D is a cross-sectional view of the resonator section 2010. FIG. 20D includes an arrow 1924 to indicate a direction that a gas could flow through the afterburner channel 1308 and the cooling passage 1416 within the resonator section 2010. The portions 2004, 2014 can include an electrode for providing electromagnetic waves and/or a plasma corona within the afterburner channel 1308 when the resonators 2002, 2012, respectively, are excited by a signal from the signal generator 1802. As discussed above, the signal that excites multiple resonators can include multiple signals from one signal generator or multiple signals from multiple signal generators.

The resonators 2002, 2012 can be disposed such that an axis of each of those resonators is perpendicular to a central axis of the afterburner channel 1308. Attaching the resonators 2002, 2012 to the casing 1402 and/or the afterburner duct 1400 as shown in FIGS. 20A and 20B may provide for easy installation of the resonators 2002, 2012 into the casing 1402 and/or the afterburner duct 1400.

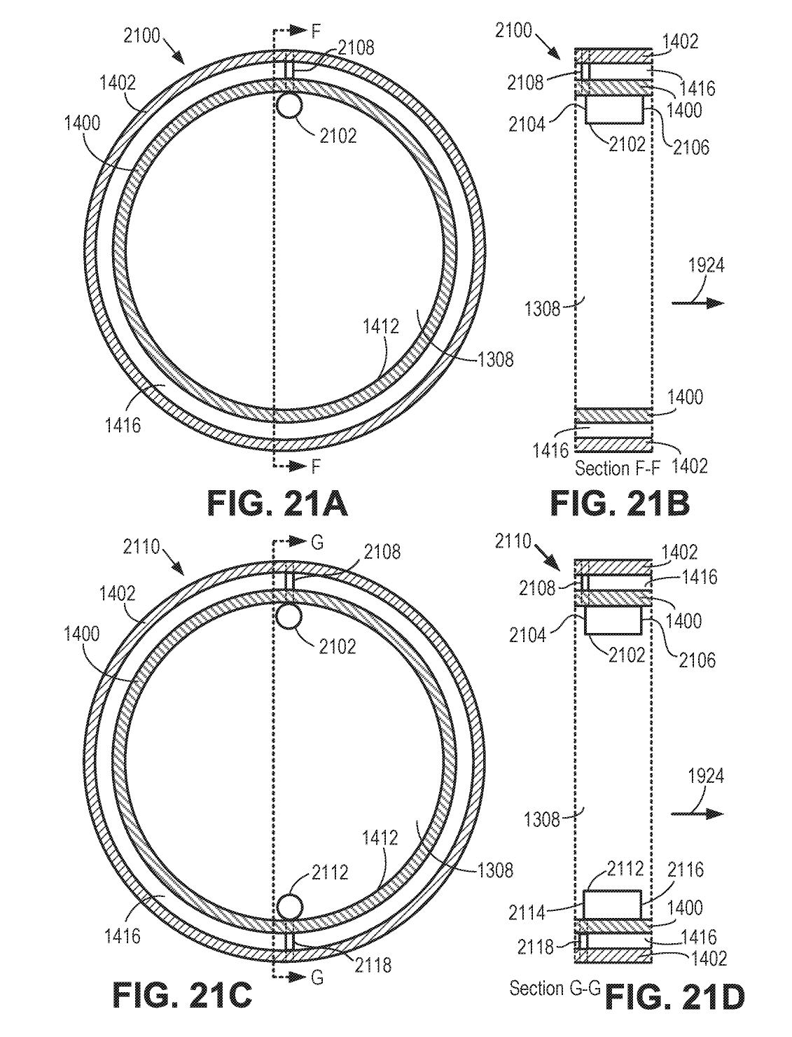

FIG. 21A is a cross-sectional view of a resonator section 2100 for an example implementation in which a shape of at least a portion of the afterburner duct 1400 is annular. At least a portion of the casing 1402 can, but need not necessarily, have an annular shape. The resonator section 2100 is an example implementation of the resonator section 2000 shown in FIG. 20.

The resonator section 2100 includes a resonator 2102 within the afterburner channel 1308. The resonator 2102 can be disposed in proximity to one or more ports in the afterburner duct 1400 that are aligned with a respective port in the casing 1402. Electrical circuitry and/or a fuel supply line can be routed through those ports into the afterburner channel 1308 for connecting to the resonator 2102. Furthermore, the resonator section 2100 can include a strut 2108 disposed within a port in the afterburner duct 1400 and a port in the casing 1402. The electrical circuitry and/or the fuel supply line can be routed through one or more passages in the strut 2108.

The resonator 2102 can be configured as any resonator discussed in this disclosure. Electrical circuitry connected to the signal generator 1802 and/or the DC power source 1804 can connect to the resonator 2102. In some example implementations, the resonator 2102 can include a fuel conduit. The resonator 2102 can be clamped or otherwise attached to the afterburner duct 1400.

The resonator 2102 includes ends 2104 and 2106. In an example implementation, the end 2104 can be a proximal end of any example resonator and the end 2106 can be a distal end of that example resonator. In accordance with this implementation, the portion of the resonator extending from the proximal end 2104 to the distal end 2106 can be used to shield the distal end 2106 from the gas flowing within the afterburner channel 1308. In another example implementation, the end 2104 can be a distal end of any example resonator and the end 2106 can be a proximal end of that example resonator. In accordance with this implementation, the electromagnetic waves provided by the resonator 2102 can affect the gas flowing within the afterburner channel 1308. A distal end of the resonator 2012 can include an electrode for providing electromagnetic waves and/or a plasma corona within the afterburner channel 1308 when the resonator 2102 is excited by a signal from the signal generator 1802.

FIG. 21B is a cross-sectional view of the resonator section 2100. FIG. 21B includes an arrow 1924 to indicate a direction that a gas could flow through the afterburner channel 1308 and the cooling passage 1416 within the resonator section 2100.

FIG. 21C is a cross-sectional view of a resonator section 2110 for an example implementation in which a shape of at least a portion of the afterburner duct 1400 is annular. The casing 1402 can, but need not necessarily, have an annular shape. The resonator section 2110 is one of many possible variations of the resonator section 2000 shown in FIG. 20. This variation shows the resonator section 2110 with resonators at a top and bottom of the afterburner channel 1308.

The resonator section 2110 includes multiple resonators. FIG. 21C shows the resonator 2102 and a resonator 2112. The resonator 2112 can be disposed in proximity to one or more ports in the afterburner duct 1400 that are aligned with a respective port in the casing 1402. Electrical circuitry and/or a fuel supply line can be routed through those ports into the afterburner channel 1308 for connecting to the resonator 2112.

As with the resonator 2102, the resonator 2112 can be configured as any resonator discussed in this disclosure. Electrical circuitry connected to the signal generator 1802 and/or the DC power source 1804 can connect to the resonator 2112. In some example implementations, the resonator 2112 can include a fuel conduit. The resonator section 2110 can include multiple struts, such as the strut 2108 and a strut 2118 disposed within a port in the afterburner duct 1400 and a port in the casing 1402. The electrical circuitry and/or the fuel supply line can be routed through one or more passages in the strut 2108, 2118. The resonator 2112 can be clamped to the afterburner duct 1400. The resonator 2112 includes ends 2114 and 2116, which can be configured as the ends 2104, 2106.

The multiple resonators within the resonator section 2110 can be spaced apart equally. For example, adjacent resonators can be spaced apart by a common number of degrees. As shown in FIG. 21C, the resonators 2102 and 2112 are spaced apart by one-hundred eighty degrees. If the multiple resonators within the resonator section 2110 include more than two resonators, those multiple resonators can, but need not necessarily, be spaced apart equally. The multiple resonators within the resonator section 2110 can be part of and/or form a ring of resonators.

FIG. 21D is a cross-sectional view of the resonator section 2110. FIG. 21D includes an arrow 1924 to indicate a direction that a gas could flow through the afterburner channel 1308 and the cooling passage 1416 within the resonator section 2110.

In an example implementation, a resonator within the resonator section 2100 can be disposed within the afterburner channel 1308 such that an axis of that resonator is parallel to a central axis of the afterburner channel 1308. In another example implementation, a resonator within the resonator section 2100 can be disposed within the afterburner channel 1308 such that an axis of that resonator is oblique to the central axis of the afterburner channel 1308 and parallel to the afterburner duct 1400 proximate to that resonator. In yet another example implementation, a resonator within the resonator section 2100 can be disposed within the afterburner channel 1308 such that an axis of that resonator is oblique to the central axis of the afterburner channel 1308 and oblique to the afterburner duct 1400 proximate to that resonator.

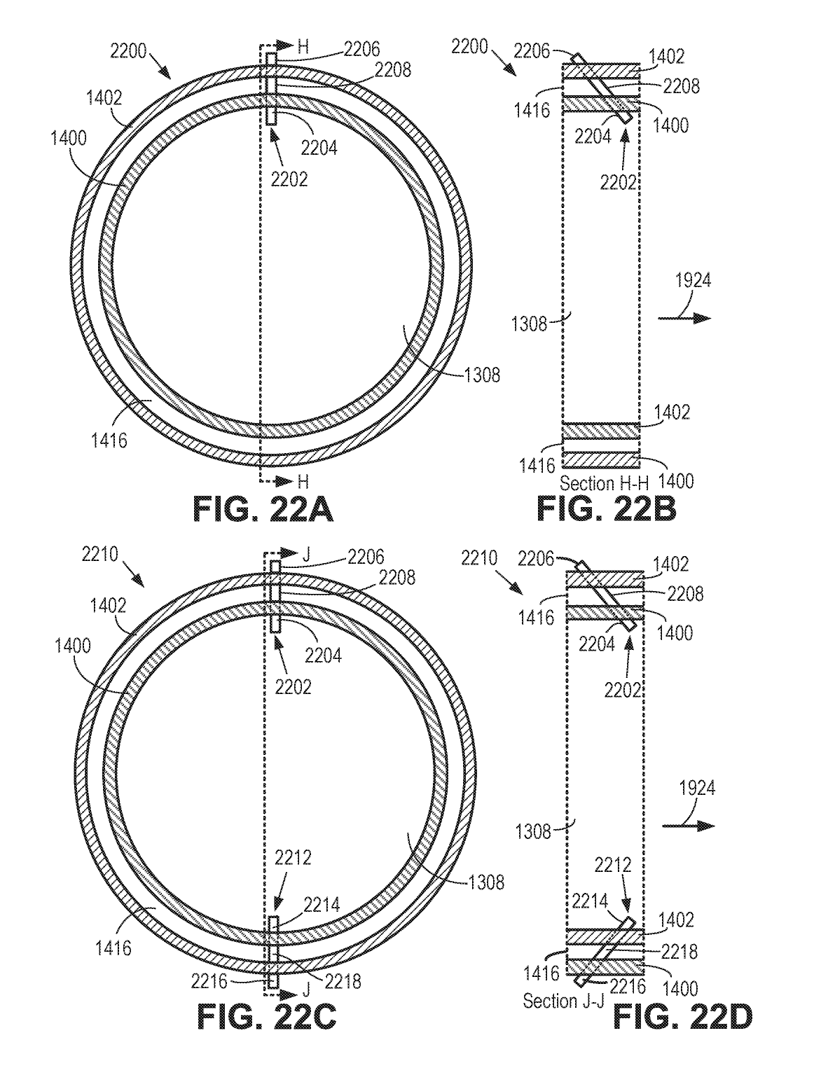

FIG. 22A is a cross-sectional view of a resonator section 2200 for an example implementation in which a shape of at least a portion of the afterburner duct 1400 is annular. The casing 1402 can, but need not necessarily, have an annular shape. The resonator section 2200 is an example implementation of the resonator section 2000 shown in FIG. 20.

The resonator section 2200 includes a resonator 2202. A portion 2204 of the resonator 2202 is disposed within the afterburner channel 1308, and another portion of the resonator 2202 is disposed outside of the afterburner channel 1308. In accordance with an example implementation, the portion of the resonator 2202 outside of the afterburner channel 1308 can include a portion 2206 outside of the casing 1402, a portion 2208 between the afterburner duct 1400 and the casing 1402, a portion (not shown) that is within a port in the afterburner duct 1400, and a portion (not shown) that is within a port in the casing 1402. The portion 2204 can include an electrode for providing electromagnetic waves and/or a plasma corona within the afterburner channel 1308 when the resonator 2202 is excited by a signal from the signal generator 1802.

The resonator 2202 is disposed obliquely to the afterburner duct 1400 and/or the casing 1402 such that the portion 2204 is further downstream in the afterburner 1300 as compared to the portion 2206. Attaching the resonator 2202 obliquely in that manner allows for some of the portion 2204 to block and/or redirect the gas flowing in proximity to the portion 2204 so as to help provide a better shaped plasma corona and/or to help improve fuel injection from a fuel conduit, if included within the resonator 2202.

The resonator 2202 can be configured as any resonator discussed in this disclosure. Electrical circuitry connected to the signal generator 1802 and/or the DC power source 1804 can connect to the resonator portion 2206. In this way, the electrical circuitry connected to the resonator 2202 does not have to be routed through the casing 1402, through the afterburner duct 1400, nor within the afterburner channel 1308. In some example implementations, the resonator 2202 can include a fuel conduit. In accordance with those implementations, a fuel supply line can connect to the portion 2206 so that the fuel supply line to the resonator 2202 does not have to be routed through the casing 1402.

FIG. 22B is a cross-sectional view of the resonator section 2200. FIG. 22B includes an arrow 1924 to indicate a direction that a gas could flow through the afterburner channel 1308 and the cooling passage 1416 within the resonator section 2200.

FIG. 22C is a cross-sectional view of a resonator section 2210 for an example implementation in which a shape of at least a portion of the afterburner duct 1400 is annular. The casing 1402 can, but need not necessarily, have an annular shape. The resonator section 2210 is one of many possible variations of the resonator section 2000 shown in FIG. 20. This variation shows the resonator section 2210 with resonators at a top and bottom of the afterburner channel 1308.

The resonator section 2210 includes multiple resonators. FIG. 22C shows the resonator 2202 and a resonator 2212. The portions of the resonator 2202 are discussed above. A portion 2214 of the resonator 2212 is disposed within the afterburner channel 1308, and another portion of the resonator 2212 is disposed outside of the afterburner channel 1308. In accordance with an example implementation, the portion of the resonator 2212 outside of the afterburner channel 1308 can include a portion 2216 outside of the casing 1402, a portion 2218 between the afterburner duct 1400 and the casing 1402, a portion (not shown) that is within a port in the afterburner duct 1400, and a portion (not shown) that is within a port in the casing 1402.

As with the resonator 2202, the resonator 2212 is disposed obliquely to the afterburner duct 1400 and/or the casing 1402 such that the portion 2214 is further downstream in the afterburner 1300 as compared to the portion 2216. Attaching the resonator 2212 obliquely in that manner allows for some of the portion 2214 to block and/or redirect the gas flowing in proximity to the portion 2214 so as to provide a better shaped plasma corona and/or for improved fuel injection from a fuel conduit, if included within the resonator 2212.

The resonator 2212 can be configured as any resonator discussed in this disclosure. Electrical circuitry connected to the signal generator 1802 and/or the DC power source 1804 can connect to the resonator portion 2216. In this way, the electrical circuitry connected to the resonator 2212 does not have to be routed through the casing 1402, through the afterburner duct 1400, nor within the afterburner channel 1308. In some example implementations, the resonator 2212 can include a fuel conduit. In accordance with those implementations, a fuel supply line can connect to the portion 2216 so that the fuel supply line to the resonator 2212 does not have to be routed through the casing 1402.

The multiple resonators within the resonator section 2210 can be spaced apart equally. For example, adjacent resonators can be spaced apart by a common number of degrees. As shown in FIG. 22C, the resonators 2202 and 2212 are spaced apart by one-hundred eighty degrees. If the multiple resonators within the resonator section 2210 include more than two resonators, those multiple resonators can, but need not necessarily, be spaced apart equally. The multiple resonators within the resonator section 2210 can be part of and/or form a ring of resonators.

FIG. 22D is a cross-sectional view of the resonator section 2210. FIG. 22D includes an arrow 1924 to indicate a direction that a gas could flow through the afterburner channel 1308 and the cooling passage 1416 within the resonator section 2210. The portions 2204, 2214 can include an electrode for providing electromagnetic waves and/or a plasma corona within the afterburner channel 1308 when the resonators 2202, 2212, respectively, are excited by a signal from the signal generator 1802.

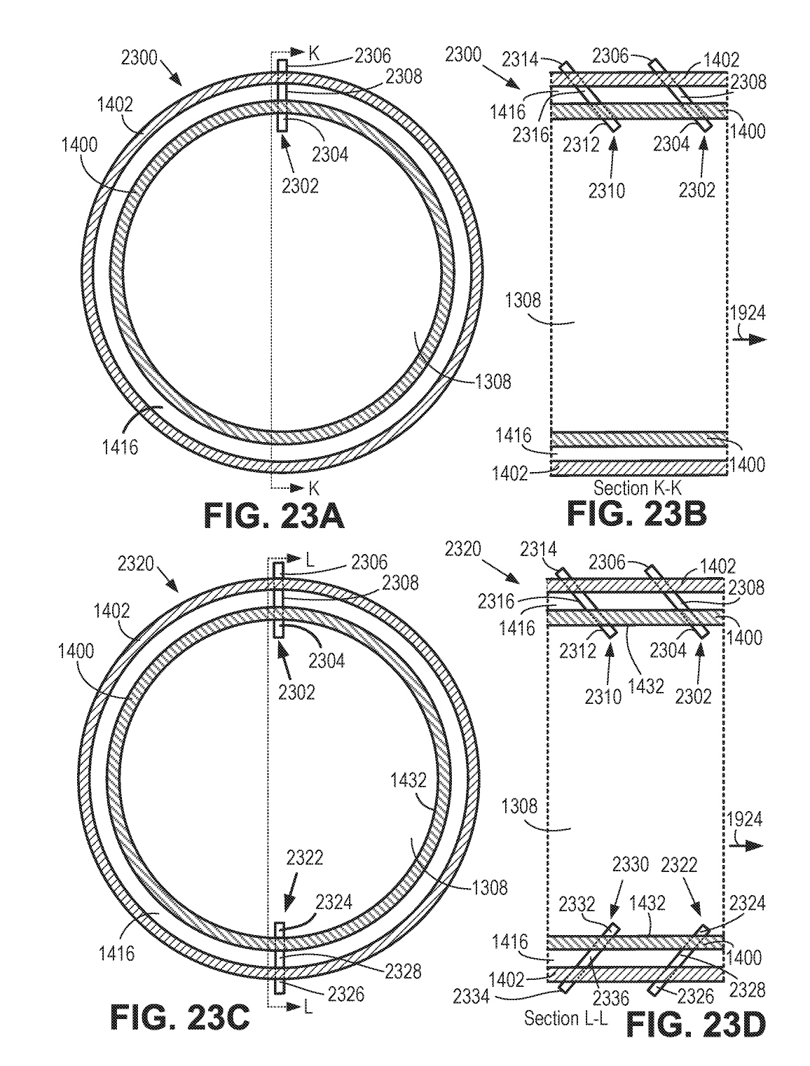

FIG. 23A is a cross-sectional view of a resonator section 2300 for an example implementation in which a shape of at least a portion of the afterburner duct 1400 is annular. The casing 1402 can, but need not necessarily, have an annular shape. The resonator section 2300 is an example implementation of the resonator section 2000 shown in FIG. 20. This variation is an example implementation in which a resonator section includes multiple resonators and multiple rings of at least one resonator. FIG. 23B is a cross-sectional view of the resonator section 2300. FIG. 23B shows a resonator 2302 and a resonator 2310 at a top of the afterburner channel 1308.

As shown in FIG. 23B, a portion 2304 of the resonator 2302 is disposed within the afterburner channel 1308, and another portion of the resonator 2302 is disposed outside of the afterburner channel 1308. In accordance with an example implementation, the portion of the resonator 2302 outside of the afterburner channel 1308 can include a portion 2306 outside of the casing 1402, a portion 2308 between the afterburner duct 1400 and the casing 1402, a portion (not shown) that is within a port of the afterburner duct 1400, and a portion (not shown) that is within a port of the casing 1402.

Similarly, as shown in FIG. 23B, a portion 2312 of the resonator 2310 is disposed within the afterburner channel 1308, and another portion of the resonator 2310 is disposed outside of the afterburner channel 1308. In accordance with an example implementation, the portion of the resonator 2310 outside of the afterburner channel 1308 can include a portion 2314 outside of the casing 1402, a portion 2316 between the afterburner duct 1400 and the casing 1402, a portion (not shown) that is within the afterburner duct 1400, and a portion (not shown) that is within the casing 1402.

The portions 2304, 2312 of the resonators 2302, 2310 can include a respective electrode for providing electromagnetic waves and/or a plasma corona within the afterburner channel 1308 when the resonators 2302, 2310, respectively, are excited by a signal from the signal generator 1802.

The resonators 2302, 2310 are disposed obliquely to the afterburner duct 1400 and/or the casing 1402 such that the portions 2304, 2312 are further downstream in the afterburner 1300 as compared to the portions 2306, 2314, respectively. Attaching the resonators 2302, 2310 obliquely in that manner allows for some of the portion 2304 to block and/or redirect the gas flowing in proximity to the portion 2304 and some of the portion 2312 to block and/or redirect the gas flowing in proximity to the portion 2312, so as to provide a better shaped plasma corona and/or for improved fuel injection from a fuel conduit, if included within the resonators 2302, 2310. In an example implementation, the resonators 2302, 2310 can be at different angles than each other.

The resonators 2302, 2310 can be configured as any resonator discussed in this disclosure. Electrical circuitry connected to the signal generator 1802 and/or the DC power source 1804 can connect to the resonator portions 2306, 2314. In this way, the electrical circuitry connected to the resonator 2302, 2310 does not have to be routed through the casing 1402, through the afterburner duct 1400, nor within the afterburner channel 1308. In some example implementations, the resonator 2302 and/or the resonator 2310 can include a fuel conduit. In accordance with those implementations, a fuel supply line can connect to the portion 2306 and/or the portion 2314 so that the fuel supply line(s) to the resonator 2302 and/or the resonator 2310 do not have to be routed through the casing 1402.

FIG. 23B includes an arrow 1924 to indicate a direction that a gas could flow through the afterburner channel 1308 and the cooling passage 1416 within the resonator section 2300. In an example implementation, the resonator 2310, being upstream of the resonator 2302, can include a fuel conduit to transport fuel to be exposed to electromagnetic waves provided when the resonator 2310 is excited with a radio-frequency signal from the signal generator 1802. The fuel can be treated by the electromagnetic waves while the fuel is in the fuel conduit and/or after the fuel is output by a fuel outlet. In accordance with the foregoing implementation, the resonator 2302, being downstream of the resonator 2310, can be excited with a radio-frequency signal from the signal generator 1802 in order to provide a plasma corona for causing combustion of fuel output by the resonator 2310. The resonator 2310 can, but need not necessarily, generate a plasma corona for causing combustion of fuel.

FIG. 23C is a cross-sectional view of a resonator section 2320 for an example implementation in which a shape of at least a portion of the afterburner duct 1400 is annular. The casing 1402 can, but need not necessarily, have an annular shape. The resonator section 2320 is one of many possible variations of the resonator section 2000 shown in FIG. 20. This variation shows the resonator section 2010 with multiple resonators at a top of the afterburner channel 1308 and multiple resonators at a bottom of the afterburner channel 1308. FIG. 23D is a cross-sectional view of the resonator section 2320.

The resonator section 2320 includes multiple resonators. FIG. 23D shows resonators 2302, 2310, 2322, 2330. The portions of the resonators 2302, 2310 are discussed above. A portion 2324 of the resonator 2322 is disposed within the afterburner channel 1308, and another portion of the resonator 2322 is disposed outside of the afterburner channel 1308. In accordance with an example implementation, the portion of the resonator 2322 outside of the afterburner channel 1308 can include a portion 2326 outside of the casing 1402, a portion 2328 between the afterburner duct 1400 and the casing 1402, a portion (not shown) that is within a port in the afterburner duct 1400, and a portion (not shown) that is within a port in the casing 1402.

Similarly, a portion 2332 of the resonator 2330 is disposed within the afterburner channel 1308, and another portion of the resonator 2330 is disposed outside of the afterburner channel 1308. In accordance with an example implementation, the portion of the resonator 2330 outside of the afterburner channel 1308 can include a portion 2334 outside of the casing 1402, a portion 2336 between the afterburner duct 1400 and the casing 1402, a portion (not shown) that is within a port in the afterburner duct 1400, and a portion (not shown) that is within a port in the casing 1402.

The portions 2324, 2332 of the resonators 2322, 2330 can include a respective electrode for providing electromagnetic waves and/or a plasma corona within the afterburner channel 1308 when the resonators 2322, 2330, respectively, are excited by a signal from the signal generator 1802.

The resonators 2322, 2330 are disposed obliquely to the afterburner duct 1400 and/or the casing 1402 such that the portions 2324, 2332 are further downstream in the afterburner 1300 as compared to the portions 2326, 2334, respectively. Attaching the resonators 2322, 2330 obliquely in that manner allows for some of the portion 2324 to block and/or redirect the gas flowing in proximity to the portion 2324 and some of the portion 2332 to block and/or redirect the gas flowing in proximity to the portion 2332, so as to provide a better shaped plasma corona and/or for improved fuel injection from a fuel conduit, if included within the resonators 2302, 2310.

The resonator 2322, 2330 can be configured as any resonator discussed in this disclosure. Electrical circuitry connected to the signal generator 1802 and/or the DC power source 1804 can connect to the resonator portions 2326, 2336. In this way, the electrical circuitry connected to the resonators 2322, 2330 does not have to be routed through the casing 1402, through the afterburner duct 1400, nor within the afterburner channel 1308. In some example implementations, the resonator 2322 and/or the resonator 2330 can include a fuel conduit. In accordance with those implementations, a fuel supply line can connect to the portion 2326 and/or the portion 2336 so that the fuel supply line(s) to the resonator 2322 and/or the resonator 2330 do not have to be routed through the casing 1402.

In an example implementation, at least some of the multiple resonators disposed partly within the resonator section 2320 can be arranged as a ring of resonators or multiple rings of resonators. As an example, the resonator section 2320 can include a first ring of resonators within a first cross section of the resonator section 2320 including the resonators 2310, 2330, and a second ring of resonators within a second cross section of the resonator section 2320 including the resonators 2302, 2322. As another example, some of the multiple resonators disposed partly within the resonator section 2320 can be within a ring of resonators in which the resonators of the ring are equally spaced from one another around the inner surface 1432 of the afterburner duct 1400. The equal spacing between resonators can be defined as a number of degrees, such as one hundred eighty degree spacing between the resonators 2302 and 2322. In another example implementation, the multiple resonators disposed partly within the resonator section 2320 can be disposed in proximity to one another in a particular part of resonator section 2320, such as at a top of the inner surface 1432. If the multiple resonators within the resonator section 2320 include more than two resonators, those multiple resonators can, but need not necessarily, be spaced apart equally.

FIG. 23D includes an arrow 1924 to indicate a direction that a gas could flow through the afterburner channel 1308 and the cooling passage 1416 within the resonator section 2320. In an example implementation, the resonator 2330, being upstream of the resonator 2322, can include a fuel conduit for outputting fuel to be exposed to electromagnetic waves provided when the resonator 2330 is excited with a radio-frequency signal from the signal generator 1802. The fuel can be treated by the electromagnetic waves while the fuel is in the fuel conduit and/or after the fuel is output by a fuel outlet. In accordance with the foregoing implementation, the resonator 2322, being downstream of the resonator 2330, can be excited with a radio-frequency signal from the signal generator 1802 in order to provide a plasma corona for causing combustion of fuel output by the resonator 2330. The resonator 2322 can, but need not necessarily, generate a plasma corona for causing combustion of fuel.

The fueling sections 1900, 1930 shown in FIGS. 19A-D and the resonator sections 2000, 2010, 2100, 2110, 2200, 2210, 2300, 2320 shown in FIGS. 20A-23D are shown with the afterburner duct 1400 and the casing 1402 having an annular cross-section. The afterburner duct 1400 and the casing 1402 for the afterburner 1300 can have different shaped cross-sections, such as an elliptical cross-section, a rectangular cross-section or a different shaped cross-section.

The resonator in the resonator sections 2000, 2100, 2200, 2300 is shown as being at a top portion of the afterburner channel 1308. The resonators in the resonator sections 2010, 2110, 2210, 2320 are shown as being at a top or bottom portion of the afterburner channel 1308. In other example implementations, the resonator can be located at a portion of the afterburner channel 1308 other than the top or bottom portion of the afterburner channel 1308. Multiple resonators in a resonator section of the afterburner 1300 can be arranged a ring of resonators. The afterburner 1300 can include multiple rings of resonators, such as a first ring of resonators in the fueling section 1422 and a second ring of resonators in the resonator section 1426. The first ring of resonators can include a first set of resonators and the second ring of resonators can include a second set of resonators. At least one signal generator 1802 can provide a signal to each resonator of the first set of resonators, and to each resonator of the second set of resonators. Moreover, at least one DC power source 1804 can provide a signal to each resonator of the first set of resonators, and/or each resonator of the second set of resonators.

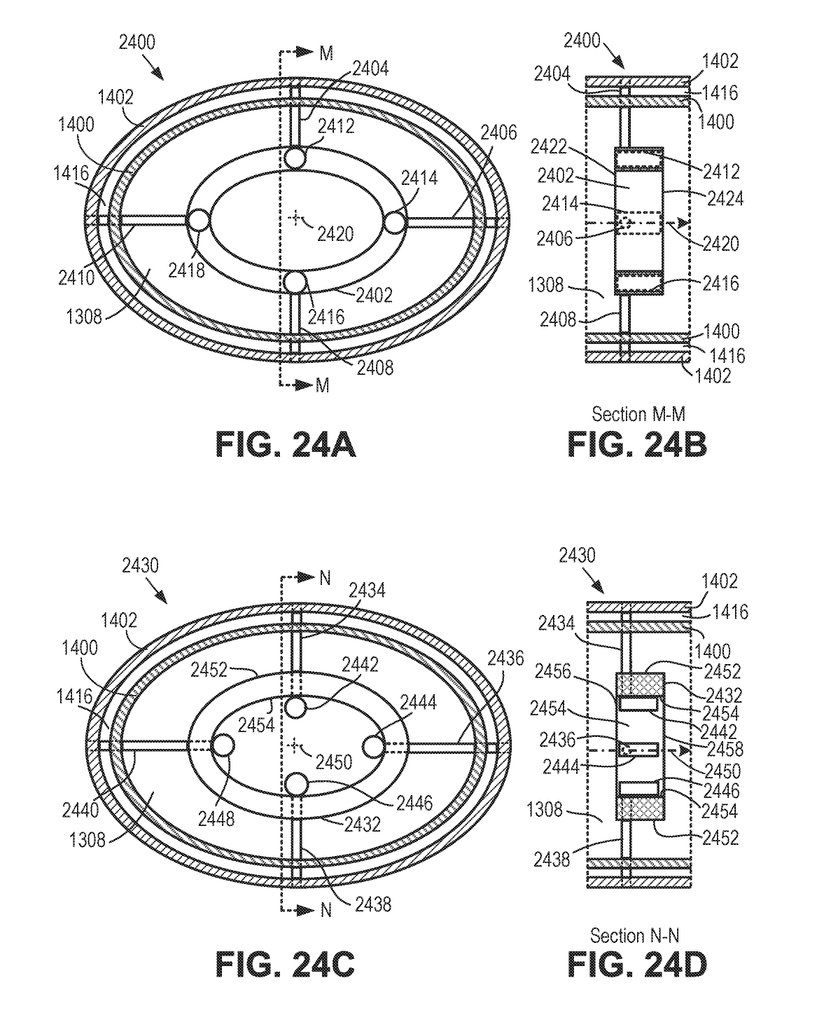

The afterburner 1300 can include a ring of resonators within a section of the afterburner 1300, such as a fueling section 1422, 1900, 1930, a resonator section 1426, 2000, 2010, 2100, 2110, 2200, 2210, 2300, 2320, or some other cross-section of the afterburner 1300. A ring of resonators includes multiple resonators. In an example implementation, a resonator of a ring of resonators can be (i) disposed partly within the afterburner channel 1308 and disposed partly outside of the afterburner channel 1308, or disposed completely within the afterburner channel 1308. In an example implementation, the resonators of a ring of resonators can be equally spaced from one another. In an example implementation, the resonators of a ring of resonators can be staggered within the afterburner channel 1308 such that some of the resonators within the afterburner channel 1308 are downstream of other resonators of the ring of resonators within the afterburner channel 1308. In an example implementation, a resonator in a ring of resonators can be disposed in the afterburner 1300 such that a center axis of the resonator is perpendicular, parallel, or oblique to a portion of the afterburner duct 1400 in proximity to the resonator. FIG. 24A to FIG. 27D, discussed below, illustrate additional examples of a ring of resonators.

FIG. 24A is a cross-sectional view of a resonator section 2400 for an example implementation in which a shape of at least a portion of the afterburner duct 1400 is elliptical. At least a portion of the casing 1402 can, but need not necessarily, have an elliptical shape. The resonator section 2400 is another one of the many variation of the resonator section 2000 shown in FIG. 20. FIG. 24A shows the cooling passage 1416, the afterburner channel 1308, and a longitudinal axis 2420 of the afterburner channel 1308.

FIG. 24B is a cross-sectional view of the resonator section 2400. FIG. 24B shows the longitudinal axis 2420 as an arrow. A gas could flow through the afterburner channel 1308 and the cooling passage 1416 within the resonator section 2400 in a direction shown by that arrow.

The resonator section 2400 includes a bracket 2402, multiple struts, and a ring of resonators including multiple resonators. At least a portion of the bracket 2402 is disposed in the afterburner channel 1308. The bracket 2402 includes an upstream end 2422 and a downstream end 2424. A bracket within a resonator section, such as the bracket 2402, can provide support for at least one resonator. In an example implementation, the at least one resonator supported by a bracket in a resonator section can be disposed at least partially within the bracket and/or can attach to a surface of the bracket. A bracket within a resonator section can be made from a metal tube or a metal bar, for example.

The bracket 2402 can, but need not necessarily, have an elliptical shape. Any bracket described as having an elliptical shape can be annular and/or circular. Furthermore, any portion of the afterburner duct 1400 described as having an elliptical shape can be annular and/or circular. Furthermore still, any portion of the casing 1402 described as having an elliptical shape can be annular and/or circular. Furthermore still, a bracket in a resonator section, such as the bracket 2402, can be at least partially hollow, as shown in FIG. 24B.

As shown in FIG. 24A, a ring of resonators within a resonator section can include four resonators, such as resonators 2412, 2414, 2416, 2418. In an alternative implementation, a ring of resonators within a resonator section can include fewer or more than four resonators. Furthermore, each resonator within a resonator section can be configured as any resonator discussed in this description.

As shown in FIG. 24B, the resonators 2412, 2414, 2416, are disposed within the bracket 2402. Likewise, the resonator 2418 can be disposed within the bracket 2402. In alternative implementations in which a portion of a resonator is disposed within a bracket, a portion of the resonator can extend upstream beyond an upstream end of the bracket and/or a portion of the resonator can extend downstream of a downstream end of the bracket. For instance, a proximal end of the resonator 2416 can extend upstream in the afterburner channel 1308 beyond the upstream end 2422 and/or a distal end of the resonator 2416 can extend downstream in the afterburner channel 1308 beyond the downstream end 2424. A resonator may extend beyond a bracket in a resonator section to improve ease in connecting a fuel conduit and/or electrical circuitry to the resonator. Furthermore, a resonator may extend beyond a bracket in a resonator section to increase the likelihood that the bracket does not interfere with a plasma corona generated by the resonator.

As further shown in FIG. 24A, the multiple struts of a resonator section can include four struts, such as struts 2404, 2406, 2408, 2410. In an alternative implementation, a resonator section can include fewer or more than four struts. A strut in a resonator section can support (i) a bracket in the resonator section, such as the bracket 2402, and/or a resonator in the resonator section, such as the resonator 2412, 2414, 2416, 2418. A strut in a resonator section, such as the strut 2404, 2406, 2408, 2410, can have a portion of the strut disposed within a port in the afterburner duct 1400. Similarly, a strut in a resonator section, such as the strut 2404, 2406, 2408, 2410, can have a portion of the strut disposed within a port in the casing 1402.

In an example implementation, at least one strut within a resonator section, such as the strut 2404, 2406, 2408, 2410 in the resonator section 2400, can include at least one passage. As an example, a passage within a strut can extend from the casing 1402 to (i) a bracket, such as the bracket 2402, and/or (ii) a resonator within the resonator section including that strut. As another example, a passage within a strut can extend just partially through the strut. Such a passage can be configured for carrying fuel. A passage for carrying fuel can, but need not necessarily, extend from one end of that strut to some point before the opposite end of the strut so that the strut does not expel fuel through the opposite end of the strut. That strut may include one or more fuel outlets between the two ends of the strut.

Furthermore, electrical circuitry connectable to a resonator within a resonator section, such as the resonator section 2400, can be routed through a passage in a strut, such as the strut 2404, 2406, 2408, 2410. Furthermore still, electrical circuitry connectable to a resonator within a resonator section can be routed through a first passage in a strut and fuel can flow through a second passage in that strut. In an implementation in which a strut includes a fuel passage, the strut can include one or more fuel outlets for outputting fuel from the strut to the afterburner channel 1308. In another implementation in which a strut includes a fuel passage, the strut can pass the fuel to a fuel conduit within a resonator.

FIG. 24A and/or FIG. 24B illustrate the resonators 2412, 2414, 2416, 2418 disposed such that a longitudinal axis of each of the resonators 2412, 2414, 2416, 2418 is parallel to the longitudinal axis 2420. In an alternative implementation, a longitudinal axis of at least one resonator 2412, 2414, 2416, 2418 is oblique to the longitudinal axis 2420.

FIG. 24C is a cross-sectional view of a resonator section 2430 for an example implementation in which a shape of at least a portion of the afterburner duct 1400 is elliptical. At least a portion of the casing 1402 can, but need not necessarily, have an elliptical shape. The resonator section 2430 is one of many possible variations of the resonator section 2000 shown in FIG. 20. This variation includes a bracket 2432 having an outer exterior surface 2452, an inner exterior surface 2454, an upstream end 2456, a downstream end 2458, and multiple resonators attached to the inner exterior surface 2454 and/or attached in proximity to the inner exterior surface 2454. FIG. 24C shows the cooling passage 1416, the afterburner channel 1308, and a longitudinal axis 2450 of the afterburner channel 1308.

FIG. 24D is a cross-sectional view of the resonator section 2430. FIG. 24D shows the longitudinal axis 2450 as an arrow. A gas could flow through the afterburner channel 1308 and the cooling passage 1416 within the resonator section 2430 in a direction shown by that arrow.

The resonator section 2430 includes the bracket 2432, multiple struts, and a ring of resonators including multiple resonators. As shown in FIG. 24C, the ring of resonators of the resonator section 2430 includes resonators 2442, 2444, 2446, 2448. The multiple struts of the resonator section 2430 include struts 2434, 2436, 2438, 2440. The bracket 2432 can, but need not necessarily, have an elliptical shape. FIG. 24D shows that a resonator section can include a bracket (for example, the bracket 2432) having at least a portion that is solid.

As shown in FIG. 24D, the resonators 2442, 2444, 2446 are attached to the inner exterior surface 2454 and/or in proximity to the inner exterior surface 2554. Likewise, the resonator 2448 can be attached to the inner exterior surface 2454 and/or in proximity to the inner exterior surface 2554. In alternative implementations in which a portion of a resonator is attached to an inner or outer exterior surface of a bracket and/or in proximity to the inner or outer exterior surface of the bracket, a portion of the resonator can extend upstream beyond an upstream end of the bracket and/or a portion of the resonator can extend downstream of a downstream end of the bracket. For instance, a proximal end of the resonator 2444 can extend upstream in the afterburner channel 1308 beyond the upstream end 2456 and/or a distal end of the resonator 2444 can extend downstream in the afterburner channel 1308 beyond the downstream end 2458.

FIG. 24C and/or FIG. 24D illustrate the resonators 2442, 2444, 2446, 2448 disposed such that a longitudinal axis of each of the resonators 2442, 2444, 2446, 2448 is parallel to the longitudinal axis 2450. In an alternative implementation, a longitudinal axis of at least one resonator 2442, 2444, 2446, 2448 is oblique to the longitudinal axis 2450.

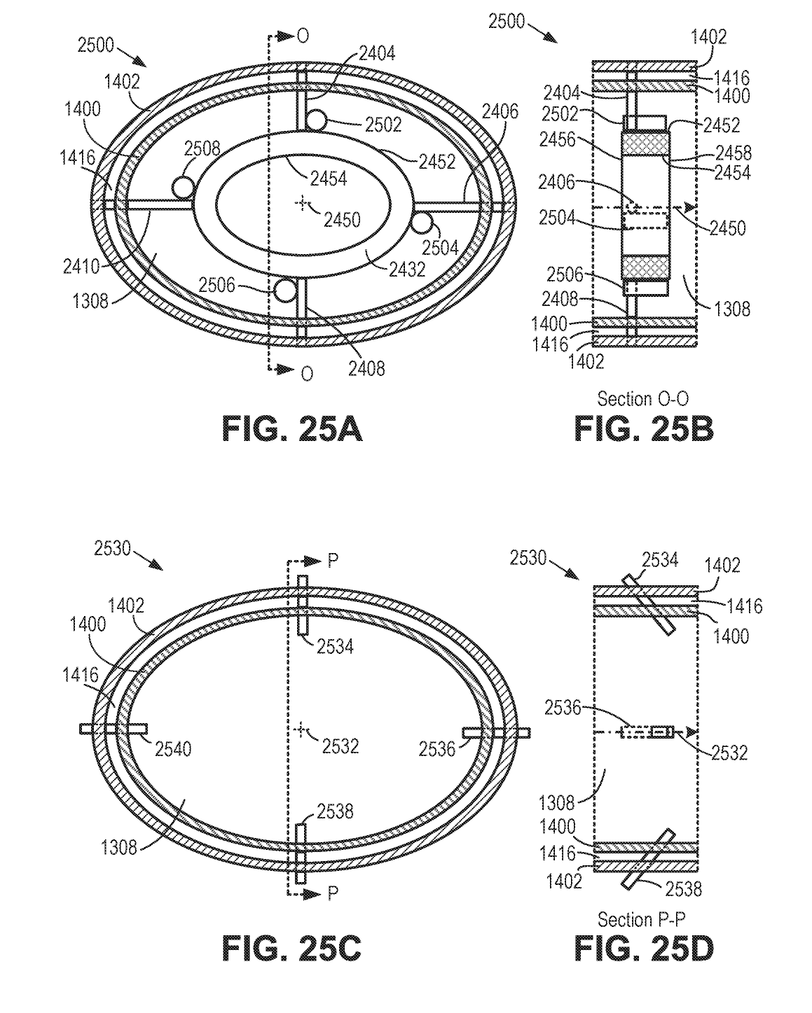

FIG. 25A is a cross-sectional view of a resonator section 2500 for an example implementation in which a shape of at least a portion of the afterburner duct 1400 is elliptical. At least a portion of the casing 1402 can, but need not necessarily, have an elliptical shape. The resonator section 2500 is one of many possible variations of the resonator section 2000 shown in FIG. 20. This variation includes the bracket 2432 and multiple resonators attached to the outer exterior surface 2452 and/or attached in proximity to the outer exterior surface 2452. FIG. 25A shows the cooling passage 1416, the afterburner channel 1308, and the longitudinal axis 2450. FIG. 25B is a cross-sectional view of the resonator section 2500.

The resonator section 2500 includes the bracket 2432, multiple struts, and a ring of resonators including multiple resonators. As shown in FIG. 25A, the ring of resonators within the resonator section 2500 includes resonators 2502, 2504, 2506, 2508. The multiple struts of the resonator section 2500 include struts 2404, 2406, 2408, 2410.

As shown in FIG. 25B, the resonators 2502, 2504, 2506 are attached to the outer exterior surface 2452 and/or in proximity to the outer exterior surface 2452. Likewise, the resonator 2508 can be attached to the outer exterior surface 2452 and/or in proximity to the outer exterior surface 2452. FIG. 25B shows the resonators 2502, 2504, 2506 disposed between the upstream end 2456 and the downstream end 2458. Similarly, the resonator 2508 can be disposed between the upstream end 2456 and the downstream end 2458.

FIG. 25A and/or FIG. 25B illustrate the resonators 2502, 2504, 2506, 2508 disposed such that a longitudinal axis of each of the resonators 2502, 2504, 2506, 2508 is parallel to the longitudinal axis 2450. In an alternative implementation, a longitudinal axis of at least one resonator 2502, 2504, 2506, 2508 is oblique to the longitudinal axis 2450.

FIG. 25C is a cross-sectional view of a resonator section 2530 for an example implementation in which a shape of at least a portion of the afterburner duct 1400 is elliptical. At least a portion of the casing 1402 can, but need not necessarily, have an elliptical shape. The resonator section 2530 is one of many possible variations of the resonator section 2000 shown in FIG. 20. This variation includes multiple resonators attached to the afterburner duct 1400. FIG. 25C shows the cooling passage 1416, the afterburner channel 1308, and a longitudinal axis 2532 of the afterburner channel 1308.

FIG. 25D is a cross-sectional view of the resonator section 2530. FIG. 25D shows the longitudinal axis 2532 as an arrow. A gas could flow through the afterburner channel 1308 and the cooling passage 1416 within the resonator section 2430 in a direction shown by that arrow.

The resonator section 2530 further includes a ring of resonators including multiple resonators arranged. As shown in FIG. 25C, the ring of resonators of the resonator section 2530 includes resonators 2534, 2536, 2538, 2540. The resonators 2534, 2536, 2538, 2540 are attached to the afterburner duct 1400. In an implementation, a resonator attached to the afterburner duct 1400 can have a portion of the resonator disposed within the afterburner duct 1400. Furthermore, a resonator attached to the afterburner duct 1400 can have a portion of the resonator disposed within the afterburner duct 1400 and another portion of the resonator disposed within the casing 1402. Furthermore still, a resonator attached to the afterburner duct 1400 can have a portion of the resonator disposed in the afterburner channel 1308, another portion of the resonator disposed in the afterburner duct 1400, and another portion disposed in the casing 1402. Furthermore still, a resonator attached to the afterburner duct 1400 can have a portion of the resonator disposed in the afterburner channel 1308, a portion of the resonator disposed in the afterburner duct 1400, a portion of the resonator disposed in the casing 1402, and a portion of the resonator disposed outside of the casing 1402. A portion of a resonator disposed within the afterburner duct 1400 can be disposed within a port in the afterburner duct 1400. Likewise, a portion of a resonator disposed within the casing 1402 can be disposed within a port in the casing 1402. In another implementation, a resonator attached to the afterburner duct 1400 can be disposed entirely within the afterburner channel 1308. As an example, one or more clamps and/or fasteners can be used to attach a resonator to the afterburner duct 1400.

In an implementation, electrical circuitry and/or a fuel supply line connectable to a resonator within a resonator section can be routed along the casing 1402 and connected to the resonator outside of the casing. In another implementation, electrical circuitry and/or a fuel supply line connectable to a resonator within a resonator section can be routed through a port in the casing 1402 and/or a port in the afterburner duct 1400 for routing to the resonator.

FIG. 25D illustrates the resonators 2534, 2536, 2538 are disposed such that a longitudinal axis of the resonators 2534, 2536, 2538 is oblique to the longitudinal axis 2532. A longitudinal axis of the resonator 2540 can also be oblique to the longitudinal axis 2532. In an alternative implementation, at least one resonator 2534, 2536, 2538, 2540 can be disposed such that a longitudinal axis of the resonator 2534, 2536, 2538, 2540 is parallel or perpendicular to the longitudinal axis 2532.

Furthermore, a resonator section arranged like the resonator section 2400, 2430, 2500 shown in FIG. 24A, FIG. 24C, FIG. 25A, respectively, can include at least one resonator attached to the afterburner duct 1400 as discussed with respect to FIG. 25C and/or FIG. 25D. In such implementations, the at least one resonator attached to the afterburner duct 1400 can, but need not necessarily, be disposed so as to not contact a strut within the resonator section. Furthermore still, for an implementation in which a shape of at least a portion of the afterburner duct 1400 is elliptical, a resonator section can include multiple resonators in contact with (i) the elliptical shaped portion of the afterburner duct 1400, and (ii) two adjacent resonators, such that the multiple resonators are arranged in an elliptical shape. Likewise, a resonator section that includes an elliptical shaped bracket, such as the bracket 2402, 2432, can include multiple resonators in contact with (i) the elliptical shaped bracket, and (ii) two adjacent resonators, such that the multiple resonators are arranged in an elliptical shape.

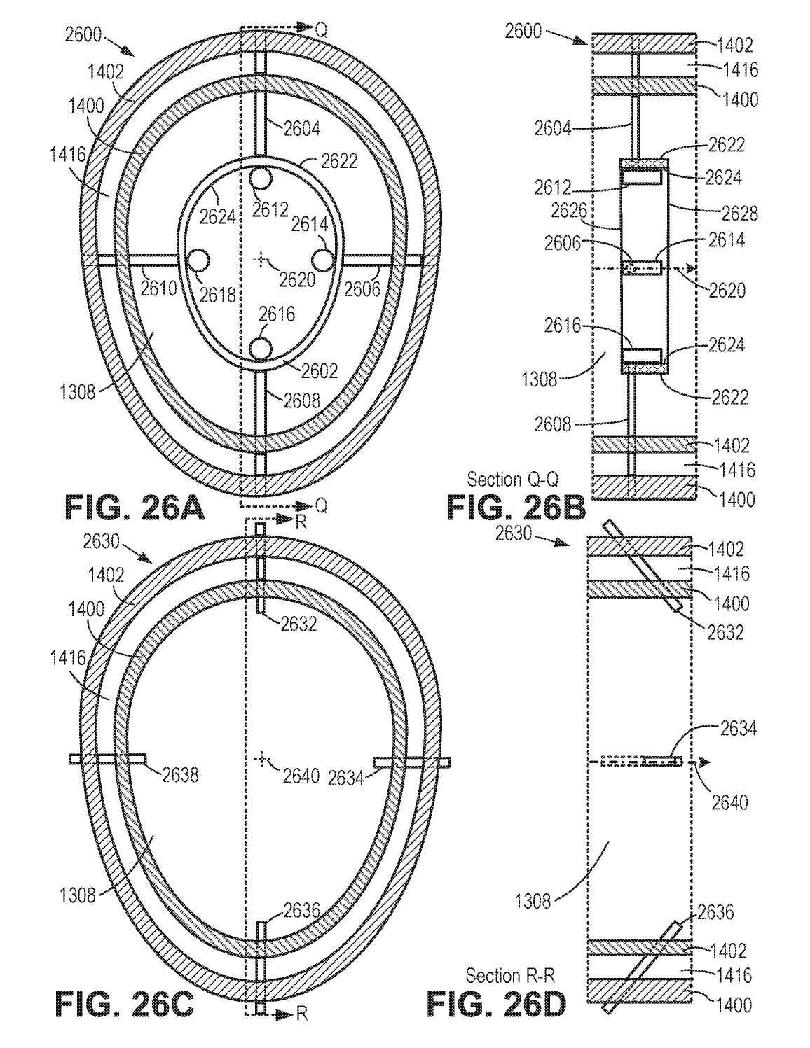

FIG. 26A is a cross-sectional view of a resonator section 2600 for an example implementation in which a shape of at least a portion of the afterburner duct 1400 is ovoid. At least a portion of the casing 1402 can, but need not necessarily, have an ovoid shape. The resonator section 2600 is one of many possible variations of the resonator section 2000 shown in FIG. 20. This variation includes a bracket 2602 having an outer exterior surface 2622, an inner exterior surface 2624, an upstream end 2626 (shown in FIG. 26B), a downstream end 2628 (shown in FIG. 26B), and multiple resonators.

In an implementation shown in FIG. 26A, the multiple resonators of the resonator section 2600 are attached to the inner exterior surface 2624 and/or attached in proximity to the inner exterior surface 2624. In another implementation, the multiple resonators of the resonator section 2600 can be attached to the outer exterior surface 2622 and/or attached in proximity to the outer exterior surface 2622. In yet another implementation, the multiple resonators of the resonator section 2600 can be disposed within the bracket 2602. FIG. 26A shows the cooling passage 1416, the afterburner channel 1308, and a longitudinal axis 2620 of the afterburner channel 1308.

FIG. 26B is a cross-sectional view of the resonator section 2600. FIG. 26B shows the longitudinal axis 2620 as an arrow. A gas could flow through the afterburner channel 1308 and the cooling passage 1416 within the resonator section 2600 in a direction shown by that arrow.

The resonator section 2600 includes the bracket 2602, multiple struts, and a ring of resonators including multiple resonators. As shown in FIG. 26A, the ring of resonators within the resonator section 2600 includes resonators 2612, 2614, 2616, 2618. The multiple struts of the resonator section 2600 include struts 2604, 2606, 2608, 2610. The bracket 2602 can, but need not necessarily, have an ovoid shape. The bracket 2602 is disposed in the afterburner channel 1308.

As shown in FIG. 26B, the resonators 2612, 2614, 2616 are disposed between the upstream end 2626 and the downstream end 2628. Similarly, the resonator 2618 can be disposed between the upstream end 2626 and the downstream end 2628.

FIG. 26A and/or FIG. 26B illustrate the resonators 2612, 2614, 2616, 2618 disposed such that a longitudinal axis of each of the resonators 2612, 2614, 2616, 2618 is parallel to the longitudinal axis 2620. In an alternative implementation, a longitudinal axis of at least one resonator 2612, 2614, 2616, 2618 is oblique to the longitudinal axis 2620.

FIG. 26C is a cross-sectional view of a resonator section 2630 for an example implementation in which a shape of at least a portion of the afterburner duct 1400 is ovoid. At least a portion of the casing 1402 can, but need not necessarily, have an ovoid shape. The resonator section 2630 is one of many possible variations of the resonator section 2000 shown in FIG. 20. This variation includes multiple resonators attached to the afterburner duct 1400. FIG. 26C shows the cooling passage 1416, the afterburner channel 1308, and a longitudinal axis 2640 of the afterburner channel 1308.

FIG. 26D is a cross-sectional view of the resonator section 2630. FIG. 26D shows the longitudinal axis 2640 as an arrow. A gas could flow through the afterburner channel 1308 and the cooling passage 1416 within the resonator section 2630 in a direction shown by that arrow.

The resonator section 2630 further includes a ring of resonators including multiple resonators. As shown in FIG. 26C, the ring of resonators of the resonator section 2630 includes resonators 2632, 2634, 2636, 2638. The resonators 2632, 2634, 2636, 2638 are attached to the afterburner duct 1400.

FIG. 26D illustrates the resonators 2632, 2634, 2636 are disposed such that a longitudinal axis of the resonators 2632, 2634, 2636 is oblique to the longitudinal axis 2640. A longitudinal axis of the resonator 2638 can also be oblique to the longitudinal axis 2640. In an alternative implementation, at least one resonator 2632, 2634, 2636, 2638 can be disposed such that a longitudinal axis of the resonator 2632, 2634, 2636, 2638 is parallel or perpendicular to the longitudinal axis 2640.

Furthermore, a resonator section arranged like the resonator section 2600 shown in FIG. 26A can include at least one resonator attached to the afterburner duct 1400 as discussed with respect to FIG. 26C and/or FIG. 26D. In such implementations, the at least one resonator attached to the afterburner duct 1400 can, but need not necessarily, be disposed so as to not contact a strut within the resonator section. Furthermore still, for an implementation in which a shape of at least a portion of the afterburner duct 1400 is ovoid, a resonator section can include multiple resonators in contact with (i) the ovoid shaped portion of the afterburner duct 1400, and (ii) two adjacent resonators, such that the multiple resonators are arranged in an ovoid shape. Likewise, a resonator section that includes n ovoid shaped bracket, such as the bracket 2602, can include multiple resonators in contact with (i) the ovoid shaped bracket, and (ii) two adjacent resonators, such that the multiple resonators are arranged in an ovoid shape.

In the fueling sections shown in FIG. 19A-D, the afterburner duct 1400 and the casing 1402 are shown as having the same shape, but in alternative implementations, the afterburner duct 1400 and the casing 1402 in a fueling section can have different shapes. For example the afterburner duct 1400 can have the shapes shown in FIGS. 19A-D, and the casing 1402 can have a different shape. Likewise, in the resonator sections shown in FIG. 20A to FIG. 27D, the afterburner duct 1400 and the casing 1402 are shown as having the same shape, but in alternative implementations, the afterburner duct 1400 and the casing 1402 in a resonator section can have different shapes. For example the afterburner duct 1400 can have the shapes shown in FIG. 20A to FIG. 27D, and the casing 1402 can have a different shape than shown in that same figure.

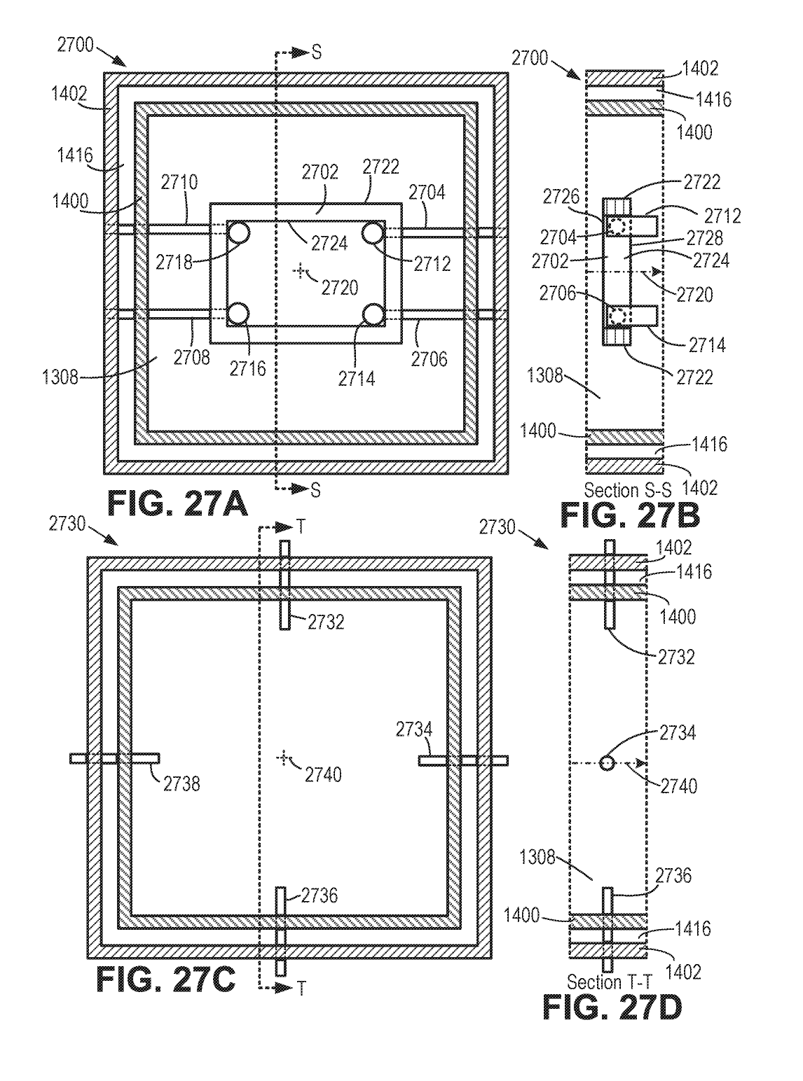

FIG. 27A is a cross-sectional view of a resonator section 2700 for an example implementation in which a shape of at least a portion of the afterburner duct 1400 is rectangular. The casing 1402 can, but need not necessarily, have a rectangular shape. The resonator section 2700 is one of many possible variations of the resonator section 2000 shown in FIG. 20. This variation includes a bracket 2702 having an outer exterior surface 2722, an inner exterior surface 2724, an upstream end 2726 (shown in FIG. 27B), a downstream end 2728 (shown in FIG. 27B), and multiple resonators.

In an implementation shown in FIG. 27A, the multiple of the resonator section 2700 are attached to the inner exterior surface 2724 and/or attached in proximity to the inner exterior surface 2724. In another implementation, the multiple resonators of the resonator section 2700 can be attached to the outer exterior surface 2722 and/or attached in proximity to the outer exterior surface 2722. In yet another implementation, the multiple resonators of the resonator section 2700 can be disposed within the bracket 2702. FIG. 27A shows the cooling passage 1416, the afterburner channel 1308, and a longitudinal axis 2720 of the afterburner channel 1308.

FIG. 27B shows the longitudinal axis 2720 as an arrow. A gas could flow through the afterburner channel 1308 and the cooling passage 1416 within the resonator section 2700 in a direction shown by that arrow.

The resonator section 2700 includes the bracket 2702, multiple struts, and a ring of resonators including multiple resonators. As shown in FIG. 27A, the ring of resonators within the resonator section 2700 includes resonators 2712, 2714, 2716, 2718. The multiple struts of the resonator section 2700 include struts 2704, 2706, 2708, 2710. The bracket 2702 can, but need not necessarily, have a rectangular shape. The bracket 2702 is disposed in the afterburner channel 1308. FIG. 27B shows portions of the resonators 2712, 2714 disposed between the upstream end 2726 and the downstream end 2728, and portions of the resonators 2712, 2714 extending downstream in the channel beyond the downstream end 2728.

FIG. 27A and/or FIG. 27B illustrate the resonators 2712, 2714, 2716, 2718 disposed such that a longitudinal axis of each of the resonators 2712, 2714, 2716, 2718 is parallel to the longitudinal axis 2720. In an alternative implementation, a longitudinal axis of at least one resonator 2712, 2714, 2716, 2718 is oblique to the longitudinal axis 2720.

FIG. 27C is a cross-sectional view of a resonator section 2730 for an example implementation in which a shape of at least a portion of the afterburner duct 1400 is rectangular. The casing 1402 can, but need not necessarily, have a rectangular shape. The resonator section 2730 is one of many possible variations of the resonator section 2000 shown in FIG. 20. This variation includes multiple resonators attached to the afterburner duct 1400. FIG. 27C shows the cooling passage 1416, the afterburner channel 1308, and a longitudinal axis 2640 of the afterburner channel 1308.

FIG. 27D is a cross-sectional view of the resonator section 2730. FIG. 27D shows the longitudinal axis 2740 as an arrow. A gas could flow through the afterburner channel 1308 and the cooling passage 1416 within the resonator section 2730 in a direction shown by that arrow.

The resonator section 2730 further includes a ring of resonators including multiple resonators. As shown in FIG. 27C, the ring of resonators of the resonator section 2730 includes resonators 2732, 2734, 2736, 2738. The resonators 2732, 2734, 2736, 2738 are attached to the afterburner duct 1400.

FIG. 27C and/or FIG. 27D illustrate the resonators 2732, 2734, 2736, 2738 disposed such that a longitudinal axis of each of the resonators 2732, 2734, 2736, 2738 is parallel or perpendicular to the longitudinal axis 2740. In an alternative implementation, a longitudinal axis of at least one resonator 2732, 2734, 2736, 2738 is oblique to the longitudinal axis 2740.

Furthermore, a resonator section arranged like the resonator section 2700 shown in FIG. 27A can include at least one resonator attached to the afterburner duct 1400 as discussed with respect to FIG. 27C and/or FIG. 27D. In such implementations, the at least one resonator attached to the afterburner duct 1400 can, but need not necessarily, be disposed so as to not contact a strut within the resonator section. Furthermore still, for an implementation in which a shape of at least a portion of the afterburner duct 1400 is rectangular, a resonator section can include multiple resonators in contact with (i) the rectangular shaped portion of the afterburner duct 1400, and (ii) two adjacent resonators, such that the multiple resonators are arranged in a rectangular shape. Likewise, a resonator section that includes a rectangular shaped bracket, such as the bracket 2702, can include multiple resonators in contact with (i) the rectangular shaped bracket, and (ii) two adjacent resonators, such that the multiple resonators are arranged in a rectangular shape.

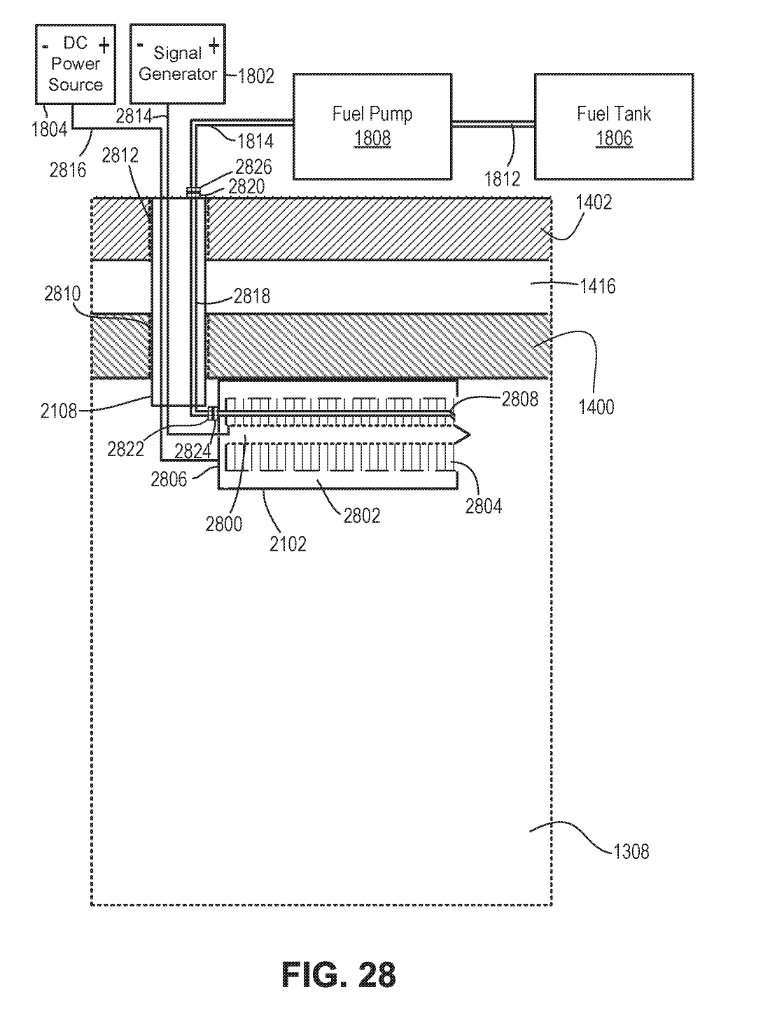

FIG. 28 is a cutaway side view of a portion of the resonator section 2100 shown in FIG. 21B. This view shows the resonator 2102 and the strut 2108, and portions of the afterburner duct 1400, the casing 1402, the afterburner channel 1308, and the cooling passage 1416. FIG. 28 also shows the signal generator 1802, the DC power source 1804, the fuel tank 1806, the fuel pump 1808, and the fuel supply lines 1812, 1814.

As shown in FIG. 28, the resonator 2102 includes a first conductor 2800, a second conductor 2802, and a dielectric 2804 disposed between the first conductor 2800 and the second conductor 2802. A base conductor 2806 is electrically coupled to the first conductor 2800 and the second conductor 2802. A fuel conduit 2808 is disposed proximate to the dielectric 2804. The configuration of the resonator 2102 shown in FIG. 28 is provided by way of example and is not meant to be limiting. The resonator 2102 may be configured in accordance with any of the resonators discussed in this description.

As further shown in FIG. 28, the afterburner duct 1400 includes a port 2810 and the casing 1402 includes a port 2812. A portion of the strut 2108 is disposed in the port 2810 and another portion of the strut 2108 is disposed in the port 2812. Furthermore, FIG. 28 shows the signal generator 1802 is connected to electrical circuitry 2814, and the DC power source 1804 is connected to electrical circuitry 2816. Furthermore still, FIG. 28 shows the fuel supply line 1814 is connected to a fuel supply line 2818, and the fuel supply line 2818 is connected to the fuel conduit 2808.

The fuel supply line 2818 can include connectors 2820, 2822. The resonator 2102 can include a connector 2824 to connect the fuel conduit 2808 to the fuel supply line 2818. Likewise, the fuel supply line 1814 can include a connector 2826 that is connectable to the connector 2820. FIG. 28 shows the connector 2824 outside of the base conductor 2806. In another implementation, at least a portion of the connector 2824 can be disposed within the base conductor 2806 or another portion of the resonator 2102.

As discussed above, a strut can include multiple passages. The strut 2108 includes at least one passage for the fuel supply line 2818 and the electrical circuitry 2814, 2816 to pass through the casing 1402 and the afterburner duct 1400.

As discussed above, the afterburner 1300, the fueling section 1422, and/or the resonator section 1426 can include at least one strut. In example implementation, a portion of such a strut can be, for example, a solid bar. Moreover, as discussed previously, a strut can include one or more passages. A passage within a strut can provide a passage for routing fuel and/or electrical circuitry. In implementations with a strut having multiple passages, electrical circuitry could be disposed within at least one of the multiple passages. Two electrical circuits could be shielded from each other by routing one of the electrical circuits within one of the multiple passages and routing another one of the electrical circuits within another one of the multiple passages. In some implementations with a strut having multiple passages, fuel could be routed within one of the multiple passages and at least one electrical circuit could be routed in another one of the multiple passages. A strut passage configured for carrying fuel can be open and one end of the strut, plugged as an opposite end of the strut, and could have one or more fuel outlets fluidly coupled to the passage configured for carrying fuel.

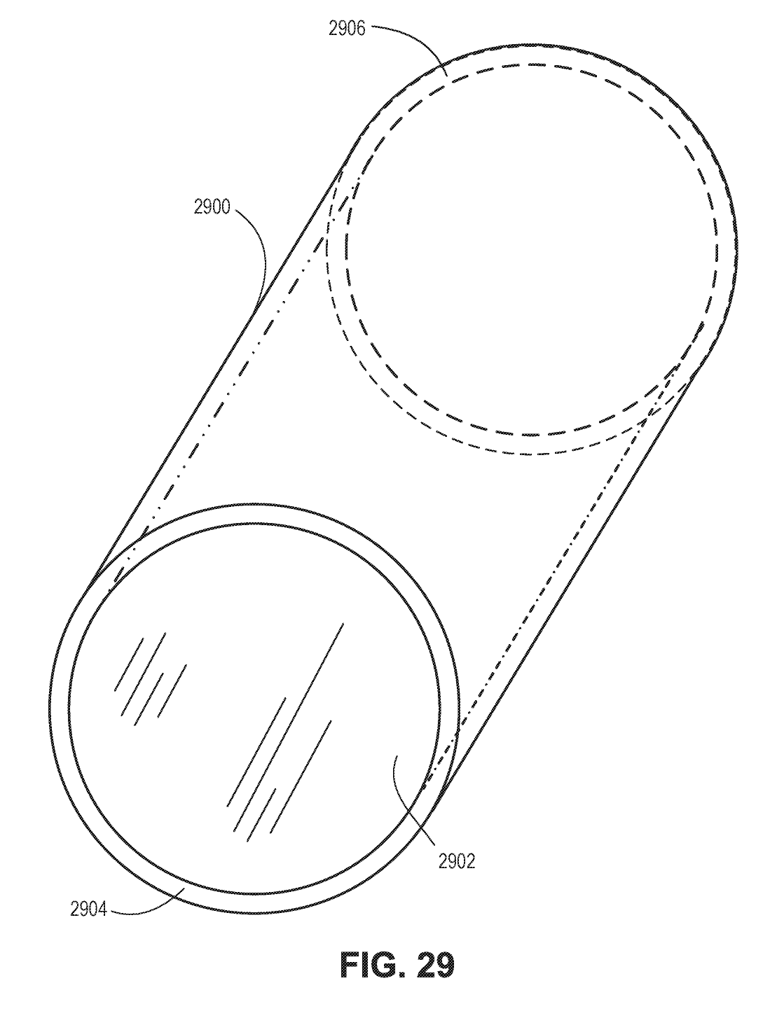

FIG. 29 illustrates at least a portion of an example strut 2900. The strut 2900 can be disposed in the afterburner channel 1308 to support a bracket and/or a resonator within a resonator section, such as the resonator section 2400. The strut 2900 includes a strut passage 2902 and strut ends 2904, 2906. The strut passage 2902 can extend from the strut end 2904 to the strut end 2906, and can extend through the strut ends 2904, 2906. In an example implementation, a portion of the strut 2900 proximate to the strut end 2904 can be disposed within ports in the afterburner duct 1400 and the casing 1402, and a portion of the strut 2900 proximate to the strut end 2906 can be disposed and/or attached to a bracket and/or a resonator within a resonator section, such as the resonator section 2400. In an example implementation, a portion of electrical circuitry connectable to (i) a resonator within a resonator section, and (ii) the signal generator 1802 and/or the DC power source 1804, can be disposed within the strut passage 2902. In an example implementation, the strut 2900 can be made of a metal, such as steel or aluminum.

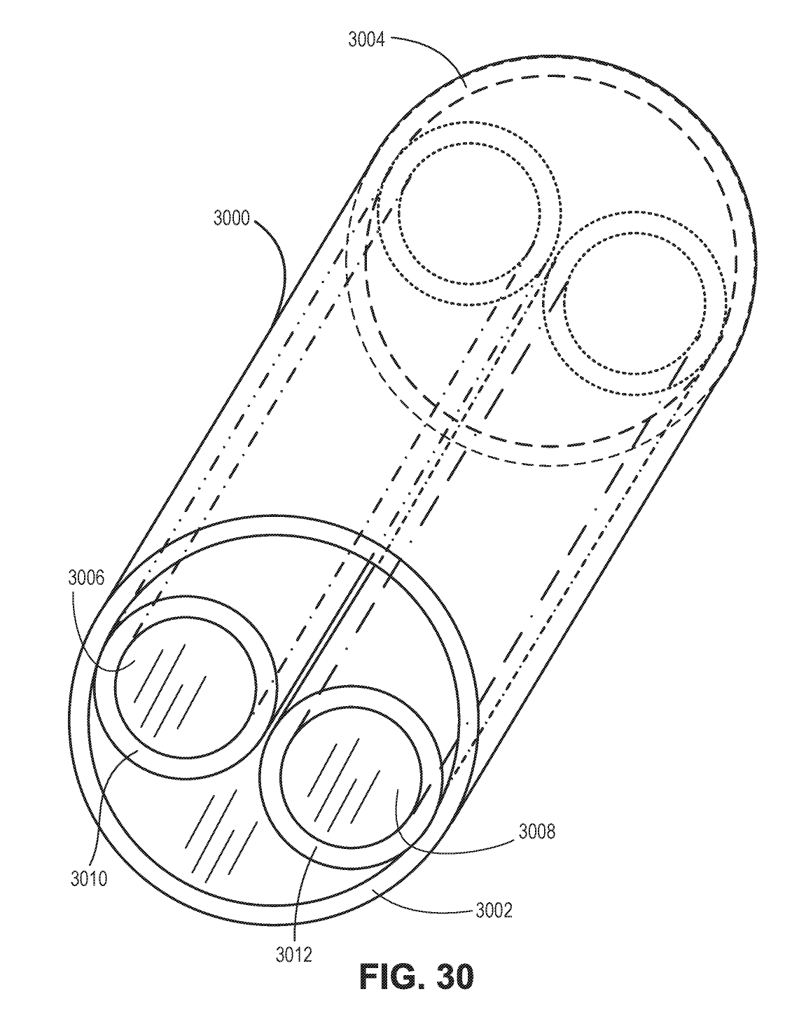

FIG. 30 illustrates at least a portion of an example strut 3000. The strut 3000 is one of many possible variations of the strut 2900 shown in FIG. 29. This variation includes multiple strut passages. As shown in FIG. 30, the strut 3000 includes tubes 3010, 3012, strut passages 3006, 3008, and strut ends 3002, 3004. The strut passages 3006, 3008 can extend within the tubes 3010, 3012 from the strut end 3002 to the strut end 3004. The strut passages 3006, 3008 can extend through the strut ends 3002, 3004. In an example implementation, a portion of the strut 3000 proximate to the strut end 3002 can be disposed within ports in the afterburner duct 1400 and the casing 1402, and a portion of the strut 3000 proximate to the strut end 3004 can be disposed and/or attached to a bracket and/or a resonator within a resonator section, such as the resonator section 2400. In an example implementation, a portion of electrical circuitry connectable to (i) a resonator within a resonator section, and (ii) the signal generator 1802 and/or the DC power source 1804, can be disposed within the strut passage 3006, and a fuel supply line, such as the fuel supply line 1814, can connect to and/or include the tube 3012. The strut passage 3008 can carry fuel to a fuel conduit within a resonator in the afterburner channel 1308 and/or to a fuel supply line connected to the tube 3012. In an example implementation, the strut 3000 and/or the tubes 3010, 3012 can be made of a metal, such as steel or aluminum.

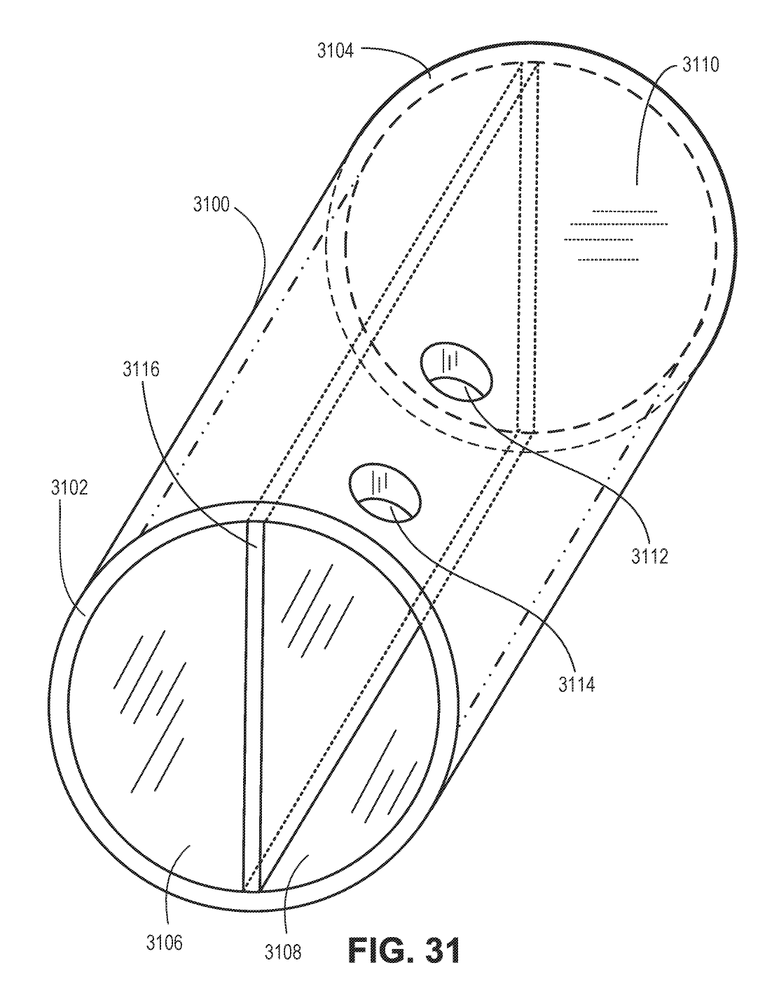

FIG. 31 illustrates at least a portion of an example strut 3100. The strut 3100 is one of many possible variations of the strut 2900 shown in FIG. 29. This variation includes multiple strut passages and multiple fuel outlets. As shown in FIG. 31, the strut 3100 includes a strut divider 3116, strut passages 3106, 3108, strut ends 3102, 3104, and fuel outlets 3112, 3114. The strut divider 3116 can separate multiple strut passages in the strut 3100. As shown in FIG. 31, the strut divider 3116 separates the strut passages 3106, 3108.

In an example implementation, a portion of the strut 3100 proximate to the strut end 3102 can be disposed within ports in the afterburner duct 1400 and the casing 1402, and a portion of the strut 3100 proximate to the strut end 3104 can be disposed and/or attached to a bracket and/or a resonator within a resonator section, such as the resonator section 2400.

The strut passage 3106 can extend from the strut end 3102 to the strut end 3104, and can extend through the strut ends 3102, 3104. In an example implementation, a portion of electrical circuitry connectable to (i) a resonator within the afterburner 1300, and (ii) the signal generator 1802 and/or the DC power source 1804, can be disposed within the strut passage 3106.

The strut passage 3108 can extend just partially through the strut 3100. For instance, the strut end 3104 can include a strut wall 3110 so that the strut passage 3108 extends just partially through the strut 3100.

In an example implementation, a fuel supply line, such as the fuel supply line 1814, can connect to and/or include the strut 3100 for providing fuel into the strut passage 3108. The fuel provided to the strut passage 3108 can be output through the fuel outlets 3112, 3114. The fuel output by the fuel outlets 3112, 3114 can mix with a gas in the afterburner channel 1308. The strut 3100 can include fewer or more than two fuel outlets. In an example implementation, the strut 3100, the strut wall 3110, and/or the strut divider 3116 can be made of a metal, such as steel or aluminum.

A strut, such as the strut 2900, 3000, 3100 or a strut used in a resonator section or a fueling section discussed in this disclosure can include threads, such as internal threads or external threads, for fastening the strut to a threaded portion on a bracket and/or a threaded portion on the afterburner duct 1400 and/or the casing 1402. Additionally or alternatively, a strut can be fastened to a bracket, the afterburner duct 1400, and/or the casing 1402 using a clamp or some other fastening device(s).

As noted above, in an implementation providing an example system, the system has an afterburner including an afterburner duct that defines an afterburner channel. The afterburner is configured to receive input gas from a turbine of a jet engine into the afterburner channel and to output an exhaust gas resulting from combustion of fuel within the afterburner channel. The system includes a plurality of resonators configured to be electromagnetically coupled to at least one radio-frequency power source. Each resonator has a resonant wavelength and includes: (i) a first conductor, (ii) a second conductor, and (iii) a dielectric between the first conductor of that resonator and the second conductor of that resonator. Furthermore, each resonator is configured such that, when that resonator is excited by the at least one radio-frequency power source with a signal having a wavelength proximate to an odd-integer multiple of one-quarter (¼) of the resonant wavelength of that resonator, that resonator provides within the afterburner at least one of electromagnetic waves or a plasma corona proximate to that resonator. Furthermore still, a first resonator of the plurality of resonators further includes a fuel conduit having (1) a first fuel outlet that is configured to output fuel for mixing with the input gas from the turbine of the jet engine, and (2) at least a portion of the fuel conduit arranged proximate to the dielectric.

In some implementations of the example system, the plurality of resonators is arranged as at least one ring of resonators including a first ring of resonators. As an example, the first ring of resonators includes multiple resonators attached to (i) the afterburner duct, (ii) a bracket, or (iii) the afterburner duct and the bracket. As another example, the afterburner duct includes a plurality of ports, each port having at least a portion of a respective resonator of the first ring of resonators disposed within. As yet another example, each resonator of the first ring of resonators is disposed entirely within the afterburner channel.

In some implementations of the example system, the plurality of resonators are arranged as multiple rings of resonators, the multiple rings of resonators including at least a first ring of resonators and a second ring of resonators.

In some implementations of the example system, at least the portion of the fuel conduit is arranged along the dielectric. In some implementations of the example system, at least the portion of the fuel conduit is arranged within the dielectric. As an example, at least the portion of the fuel conduit includes a glass tube, a sapphire tube, a quartz tube, an aliphatic polyamide tube, or a non-porous ceramic tube. In some implementations, at least the portion of the fuel conduit is defined by a shape of the dielectric.

In some implementations of the example system, the dielectric includes a porous material into which the first fuel outlet outputs the fuel, through which the fuel is moved, and out of which the fuel is expelled towards a distal end of the resonator.

In some implementations of the example system, the dielectric includes a first dielectric section and a second dielectric section, into at least one of which the first fuel outlet outputs the fuel, and through each of which the fuel is moved. As an example, the first dielectric section includes a dielectric material and the second dielectric section includes air and does not include dielectric material. As another example, at least the portion of the fuel conduit is arranged within at least one of the first dielectric section or the second dielectric section, and wherein the first fuel outlet is included in the first dielectric section and/or the second dielectric section.

In some implementations of the example system, the at least one radio-frequency power source includes at least a first radio-frequency power source and a second radio-frequency power source. Moreover, the plurality of resonators includes at least (i) a first resonator set having at least one resonator configured to be electromagnetically coupled to at least the first radio-frequency power source, and (ii) a second resonator set having at least one resonator configured to be electromagnetically coupled to at least the second radio-frequency power source. Furthermore, each first radio-frequency power source is configured to provide the signal to at least one resonator of the first resonator set. Likewise, each second radio-frequency power source is configured to provide the signal to at least one resonator of the second resonator set. Furthermore still, at least a portion of each resonator of the first resonator set is disposed within a fuel supply line fluidly coupled to the fuel outlet, and at least a portion of each resonator of the second resonator set is disposed within the afterburner channel. Furthermore still, the system can also include a controller configured to cause at least (i) the first radio-frequency power source to provide the signal to at least one resonator of the first resonator set, or (ii) the second radio-frequency power source to provide the signal to at least one resonator of the second resonator set.

In some implementations of the example system, the plurality of resonators includes at least a first resonator and at least a second resonator. Moreover, the resonant wavelength of at least the first resonator can be a first resonant wavelength and the resonant wavelength of at least the second resonator can be a second resonant wavelength different than the first resonant wavelength.

In some implementations of the example system, each resonator that provides the plasma corona proximate to that resonator includes an electrode coupled to the first conductor of that resonator.

In some implementations of the example system, the fuel conduit includes (i) a first branch that leads to the first fuel outlet, and (ii) a second branch that leads to a second fuel outlet configured to output fuel for mixing with the input gas from the turbine of the jet engine.

In some implementations of the example system, the system further comprises a fuel pump configured to move the fuel through the fuel conduit; and a controller configured to carry out operations. As an example, the operations include causing the radio-frequency power source to excite the resonator with the signal so as to provide the electromagnetic waves. As another example, the operations include causing the fuel pump to move the fuel from a fuel source through the fuel conduit such that the fuel (a) is output from the first outlet and the second outlet, (b) moves through the dielectric, and (c) is exposed to the electromagnetic waves while moving through the dielectric.

In some implementations of the example system, the fuel conduit includes at least one other fuel outlet that is configured to output fuel into the afterburner channel for mixing with the input gas from the turbine of the jet engine.

In some implementations of the example system, the system further includes at least one other fuel conduit configured to output fuel for mixing with the input gas from the turbine of the jet engine.

In some implementations of the example system, at least one resonator includes an electrode coupled to the first conductor of that resonator and disposed within the afterburner. Furthermore, a concentrator of the electrode can be disposed within the afterburner channel so that the plasma corona is provided within the afterburner channel.

The resonators in a ring of resonators can include a fuel conduit (i) configured to fluidly couple to a fuel supply line for receiving fuel from a fuel source, and (ii) having a fuel outlet for outputting fuel. As an example, the fuel outlet can output the fuel into a combustion area, such as the afterburner channel 1308 or the torch igniter channel 1704, or a treatment chamber, such as the treatment chamber 1822.

A portion of a fuel conduit can be arranged proximate to a dielectric of a resonator in a ring of resonators or otherwise in the afterburner 1300. As discussed above, the fuel conduit being proximate to the dielectric can include the fuel conduit being defined by the dielectric, the fuel conduit being arranged within the dielectric, and/or the fuel conduit being arranged along the dielectric. Still further, the fuel outlet of the fuel conduit can be disposed within the dielectric. In some implementations of the example system, the fuel outlet can be arranged so as to output fuel toward the distal end of the resonator including the fuel conduit.

Further in line with the discussion above, the fuel conduit can include multiple fuel outlets for outputting fuel in the combustion zone area and/or the treatment chamber. The multiple fuel outlets can be configured to output the fuel in a radial pattern.

As also discussed above, the dielectric can include an area of porous material into which the fuel outlet of the fuel conduit expels the fuel such that fuel passes through the area of porous material and enters the combustion area and/or the treatment chamber.

### XI. Example Methods

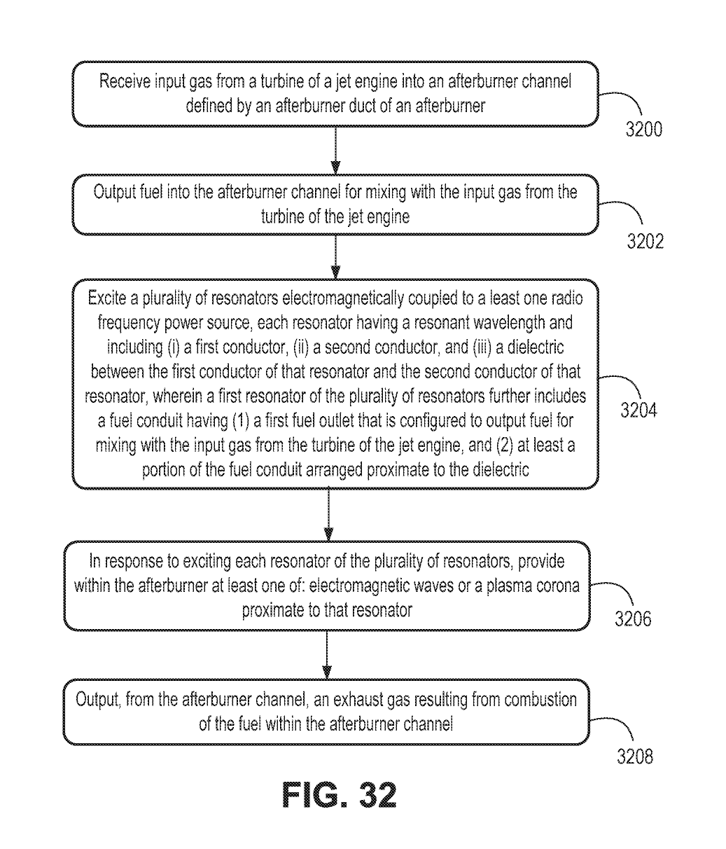

FIG. 32 is a flow chart depicting operations of a representative method for combusting fuel in an afterburner. Two or more operations and/or portions of two more operations may, but need not necessarily, be performed at the same time.

At block 3200, the method includes receiving input gas from a turbine of a jet engine into an afterburner channel defined by an afterburner duct of an afterburner.

At block 3202, the method includes outputting fuel into the afterburner channel for mixing with the input gas from the turbine of the jet engine. In some implementations, the fuel can be output by a fuel outlet in a fuel conduit in a resonator, multiple fuel outlets in a fuel conduit in a resonator, a respective fuel outlet in multiple fuel conduits in at least one resonator, or multiple fuel outlets in multiple fuel conduits in at least one resonator. In some implementation, outputting at least some of the fuel can include outputting fuel through at least one fuel outlet in at least one strut. Outputting fuel by a fuel outlet into the afterburner channel can be considered inputting fuel into the afterburner channel.

At block 3204, the method includes exciting a plurality of resonators electromagnetically coupled to at least one radio-frequency power source. Each resonator has a resonant wavelength. Furthermore, each resonator includes a first conductor, a second conductor, and a dielectric between the first conductor of that resonator and the second conductor of that resonator. Furthermore still, a first resonator of the plurality of resonators additionally includes a fuel conduit having (1) a first fuel outlet that is configured to output fuel for mixing with the input gas from the turbine of the jet engine, and (2) at least a portion of the fuel conduit arranged proximate to the dielectric.

At block 3206, the method includes, in response to exciting each resonator of the plurality of resonators, providing within the afterburner at least one of electromagnetic waves or a plasma corona proximate to that resonator.

At block 3208, the method includes outputting, from the afterburner channel, an exhaust gas resulting from combustion of the fuel within the afterburner channel.

In some implementations, the plurality of resonators is arranged as at least one ring of resonators. As an example, the first ring of resonators includes multiple resonators attached to (i) the afterburner duct, (ii) an annular shaped bracket, or (iii) the afterburner duct and the annular shaped bracket. As another example, the first ring of resonators includes multiple resonators attached to (i) the afterburner duct, (ii) an elliptical shaped bracket, or (iii) the afterburner duct and the elliptical shaped bracket. As another example, the first ring of resonators includes multiple resonators attached to (i) the afterburner duct, (ii) an oval shaped bracket, or (iii) the afterburner duct and the oval shaped bracket. As yet another example, the first ring of resonators includes multiple resonators attached to (i) the afterburner duct, (ii) a rectangular shaped bracket, or (iii) the afterburner duct and the rectangular shaped bracket.

In some other implementations, at least one mounting bracket supports a set of resonators of the first ring of resonators within the afterburner channel. As an example, the at least one mounting bracket includes an annular mounting bracket supported by the afterburner duct. As another example, the at least one mounting bracket includes multiple mounting brackets supported by the afterburner duct and configured for supporting at least one resonator of the set of resonators.

In some implementations, the afterburner duct includes a plurality of ports, each port having at least a portion of a respective resonator of the first ring of resonators disposed within. As an example, at least one port of the plurality of ports is configured so that a resonator at least partially disposed within that port has a longitudinal axis that is perpendicular to a longitudinal axis of the afterburner channel. As another example, at least one port of the plurality of ports is configured so that a resonator at least partially disposed within that port has a longitudinal axis that is oblique to a longitudinal axis of the afterburner channel.

In some implementations, at least one other resonator of the plurality of resonators also includes a fuel conduit having (1) a first fuel outlet that is configured to output fuel for mixing with the input gas from the turbine of the jet engine, and (2) at least a portion of the fuel conduit arranged proximate to the dielectric.

In some implementations, each resonator of the first ring of resonators is disposed entirely within the afterburner channel. Furthermore, a portion of an electrical circuit connected to at least one resonator of the first ring of resonators is disposed within a port in the afterburner duct. Furthermore still, a longitudinal axis of at least one resonator of the first ring of resonators can be parallel to a longitudinal axis of the afterburner channel and/or a longitudinal axis of at least one resonator of the first ring of resonators is oblique to a longitudinal axis of the afterburner channel. Furthermore still, a proximal end of each resonator of the first ring of resonators can be disposed in the afterburner channel upstream of the electrode of that resonator.

In some implementations, the plurality of resonators are arranged as multiple rings of resonators, the multiple rings of resonators including at least a first ring of resonators and a second ring of resonators. Furthermore, at least a portion of each resonator of the first ring of resonators can be at least partially disposed in the afterburner channel upstream or downstream of the second ring of resonators.

In some implementations, the method further comprises providing, by at least one fuel pump, fuel from the fuel source through a fuel supply line fluidly coupled to the fuel conduit.

In some implementations, providing at least one of the plasma corona or the electromagnetic waves includes providing the electromagnetic waves by exciting the resonator with the signal such that, as the fuel moves through the dielectric, the fuel is exposed to the electromagnetic waves.

In some implementations, providing at least one of the plasma corona or the electromagnetic waves includes providing the plasma corona proximate to a distal end of the first conductor by exciting the resonator with the signal, and wherein outputting the fuel from the first fuel outlet of the fuel conduit includes outputting the fuel from the first fuel outlet of the fuel conduit toward the plasma corona.

In some implementations, at least the portion of the fuel conduit is arranged along the dielectric.

In some implementations, at least the portion of the fuel conduit is arranged within the dielectric.

In some implementations, at least the portion of the fuel conduit is defined by a shape of the dielectric.

In some implementations, the method further comprises providing, by at least one direct-current power source, a respective bias signal between the first conductor and the second conductor of at least one resonator from the first resonator set, at least one resonator from the second resonator set, or a least one resonator from both the first resonator set and the second resonator set.

In some implementations, exciting the plurality of resonators comprises exciting the plurality of resonators simultaneously so that each resonator of the plurality of resonators provides at least one of the electromagnetic waves or the plasma corona simultaneously. As an example, the plurality of resonators can be excited simultaneously so that each resonator of the plurality of resonators provides the electromagnetic waves simultaneously. As an example, the plurality of resonators can be excited simultaneously so that each resonator of the plurality of resonators provides the plasma corona simultaneously. As yet another example, the plurality of resonators can be excited simultaneously so that some of the resonators provide the electromagnetic waves, but not the plasma corona, while the other resonators are providing the plasma corona, but not the electromagnetic waves.

In some implementations, the at least one radio-frequency power source includes at least a first radio-frequency power source and a second radio-frequency power source.

In some implementations, exciting the plurality of resonators comprises exciting some of the plurality of resonators to provide at least one of the electromagnetic waves or the plasma corona while at least some of the plurality of resonators are not being excited to provide at least one of the electromagnetic waves or the plasma corona. In those implementations, the plurality of resonators include at least (i) a first resonator set having at least one resonator configured to be electromagnetically coupled to at least the first radio-frequency power source, and (ii) a second resonator set having at least one resonator configured to be electromagnetically coupled to at least the second radio-frequency power source. Moreover, each first radio-frequency power source can be configured to provide the signal to at least one resonator of the first resonator set. Likewise, each second radio-frequency power source can be configured to provide the signal to at least one resonator of the second resonator set. Furthermore, at least one direct-current power source can be configured to provide a respective bias signal between the first conductor and the second conductor of at least one resonator from the first resonator set, at least one resonator from the second resonator set, or a least one resonator from both the first resonator set and the second resonator set. Furthermore still, a controller can be configured to control (i) at least the first radio-frequency power source to provide the signal to the first resonator set, and/or (ii) at least the second radio-frequency power source to provide the signal to the second resonator set. In some implementations, at least a portion of each resonator of the first resonator set is disposed within a fuel supply line fluidly coupled to the fuel outlet, and a least a portion of each resonator of the second resonator set is disposed within the afterburner channel.

In some implementations, a controller is configured to cause fuel to be pumped through the fuel outlet into the afterburner channel for mixing with the input gas from the turbine of the jet engine.

In some implementations, the plurality of resonators includes at least a first resonator and at least a second resonator. In those implementations, the resonant wavelength of at least the first resonator can be a first resonant wavelength and the resonant wavelength of at least the second resonator can be a second resonant wavelength different than the first resonant wavelength.

In some implementations, each resonator of the plurality of resonators is selected from the group consisting of: a coaxial-cavity resonator, a dielectric resonator, a crystal resonator, a ceramic resonator, a surface-acoustic-wave resonator, an yttrium-iron-garnet resonator, a rectangular-waveguide cavity resonator, a parallel-plate resonator, and a gap-coupled microstrip resonator.

In some implementations, each resonator that provides the plasma corona proximate to that resonator includes an electrode coupled to the first conductor of that resonator.

The particular arrangements shown in the figures should not be viewed as limiting. It should be understood that other implementations can include more or less of each element shown in a given figure. Further, some of the illustrated elements can be combined or omitted. Yet further, an illustrative implementation can include elements that are not illustrated in the figures.

A step or block that represents a processing of information can correspond to circuitry that can be configured to perform the specific logical functions of a method or technique as presently disclosed. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk, hard drive, or other storage medium.

The computer-readable medium can also include non-transitory computer-readable media such as computer-readable media that store data for short periods of time like register memory, processor cache, and random access memory (RAM). The computer-readable media can also include non-transitory computer-readable media that store program code and/or data for longer periods of time. Thus, the computer-readable media can include secondary or persistent long term storage, like read only memory (ROM), optical or magnetic disks, compact-disc read only memory (CD-ROM), for example. The computer-readable media can also be any other volatile or non-volatile storage systems. A computer-readable medium can be considered a computer-readable storage medium, for example, or a tangible storage device.

While various examples and implementations have been disclosed, other examples and implementations will be apparent to those skilled in the art. The various disclosed examples and implementations are for purposes of illustration and are not intended to be limiting, with the true scope being indicated by the claims.

What is claimed is:

1. A system comprising:
an afterburner including an afterburner duct that defines an afterburner channel, the afterburner being configured to receive input gas from a turbine of a jet engine into the afterburner channel and to output an exhaust gas resulting from combustion of fuel within the afterburner channel;
a plurality of resonators configured to be electromagnetically coupled to at least one radio-frequency power source, each resonator having a resonant wavelength and including:
a first conductor,
a second conductor, and
a dielectric between the first conductor of that resonator and the second conductor of that resonator,
wherein each resonator is configured such that, when that resonator is excited by the at least one radio-frequency power source with a signal having a wavelength proximate to an odd-integer multiple of one-quarter (¼) of the resonant wavelength of that resonator, that resonator provides within the afterburner at least one of electromagnetic waves or a plasma corona proximate to that resonator, and
wherein a first resonator of the plurality of resonators further includes a fuel conduit having (1) a first fuel outlet that is configured to output fuel for mixing with the input gas from the turbine of the jet engine, and (2) at least a portion of the fuel conduit arranged proximate to the dielectric.

2. The system of claim 1, wherein the plurality of resonators is arranged as at least one ring of resonators including a first ring of resonators.

3. The system of claim 2, wherein the first ring of resonators includes multiple resonators attached to (i) the afterburner duct, (ii) a bracket, or (iii) the afterburner duct and the bracket.

4. The system of claim 2, wherein the afterburner duct includes a plurality of ports, each port having at least a portion of a respective resonator of the first ring of resonators disposed within.

5. The system of claim 2, wherein each resonator of the first ring of resonators is disposed entirely within the afterburner channel.

6. The system of claim 1, wherein the plurality of resonators are arranged as multiple rings of resonators, the multiple rings of resonators including at least a first ring of resonators and a second ring of resonators.

7. The system of claim 1, wherein at least the portion of the fuel conduit is arranged along the dielectric.

8. The system of claim 1, wherein at least the portion of the fuel conduit is arranged within the dielectric.

9. The system of claim 8, wherein at least the portion of the fuel conduit includes a glass tube, a sapphire tube, a quartz tube, an aliphatic polyamide tube, or a non-porous ceramic tube.

10. The system of claim 1, wherein at least the portion of the fuel conduit is defined by a shape of the dielectric.

11. The system of claim 1, wherein the dielectric includes a porous material into which the first fuel outlet outputs the fuel, through which the fuel is moved, and out of which the fuel is expelled towards a distal end of the resonator.

12. The system of claim 1, wherein the dielectric includes a first dielectric section and a second dielectric section, into at least one of which the first fuel outlet outputs the fuel, and through each of which the fuel is moved.

13. The system of claim 12, wherein the first dielectric section includes a dielectric material and the second dielectric section includes air and does not include dielectric material.

14. The system of claim 12, wherein at least the portion of the fuel conduit is arranged within at least one of the first dielectric section or the second dielectric section, and wherein the first fuel outlet is included in at least one of: the first dielectric section or the second dielectric section.

15. The system of claim 1,
wherein the at least one radio-frequency power source includes at least a first radio-frequency power source and a second radio-frequency power source,
wherein the plurality of resonators includes at least (i) a first resonator set having at least one resonator configured to be electromagnetically coupled to at least the first radio-frequency power source, and (ii) a second resonator set having at least one resonator configured to be electromagnetically coupled to at least the second radio-frequency power source,
wherein each first radio-frequency power source is configured to provide the signal to at least one resonator of the first resonator set, and
wherein each second radio-frequency power source is configured to provide the signal to at least one resonator of the second resonator set.

16. The system of claim 15, further comprising:
at least one direct-current power source configured to provide a respective bias signal between the first conductor and the second conductor of at least one resonator from the first resonator set, at least one resonator from the second resonator set, or a least one resonator from both the first resonator set and the second resonator set.

17. The system of claim 15, further comprising:
a controller configured to cause at least (i) the first radio-frequency power source to provide the signal to at least one resonator of the first resonator set, or (ii) the second radio-frequency power source to provide the signal to at least one resonator of the second resonator set.

18. The system of claim 15, wherein at least a portion of each resonator of the first resonator set is disposed within a fuel supply line fluidly coupled to the first fuel outlet, and at least a portion of each resonator of the second resonator set is disposed within the afterburner channel.

19. The system of claim 1, further comprising:
the jet engine,
wherein the afterburner is removably attached to the jet engine.

20. The system of claim 1, wherein each resonator of the plurality of resonators is selected from the group consisting of: a coaxial-cavity resonator, a dielectric resonator, a crystal resonator, a ceramic resonator, a surface-acoustic-wave resonator, an yttrium-iron-garnet resonator, a rectangular-waveguide cavity resonator, a parallel-plate resonator, and a gap-coupled microstrip resonator.

21. The system of claim 1,
wherein the plurality of resonators includes at least a first resonator and at least a second resonator, and
wherein the resonant wavelength of at least the first resonator is a first resonant wavelength and the resonant wavelength of at least the second resonator is a second resonant wavelength different than the first resonant wavelength.

22. The system of claim 1, wherein each resonator that provides the plasma corona proximate to that resonator includes an electrode coupled to the first conductor of that resonator.

23. The system of claim 1, wherein the fuel conduit includes (i) a first branch that leads to the first fuel outlet, and (ii) a second branch that leads to a second fuel outlet configured to output fuel for mixing with the input gas from the turbine of the jet engine.

24. The system of claim 23, further comprising:
a fuel pump configured to move the fuel through the fuel conduit; and
a controller configured to carry out operations, the operations including:
causing the radio-frequency power source to excite the resonator with the signal so as to provide the electromagnetic waves; and
causing the fuel pump to move the fuel from a fuel source through the fuel conduit such that the fuel (a) is output from the first fuel outlet and the second fuel outlet, (b) moves through the dielectric, and (c) is exposed to the electromagnetic waves while moving through the dielectric.

25. The system of claim 1, wherein the fuel conduit includes at least one other fuel outlet that is configured to output fuel into the afterburner channel for mixing with the input gas from the turbine of the jet engine.

26. The system of claim 1, further comprising at least one other fuel conduit configured to output fuel for mixing with the input gas from the turbine of the jet engine.

27. The system of claim 1, wherein at least one resonator includes an electrode coupled to the first conductor of that resonator and disposed within the afterburner.

28. The system of claim 27, wherein a concentrator of the electrode is disposed within the afterburner channel so that the plasma corona is provided within the afterburner channel.

29. A method comprising:
receiving input gas from a turbine of a jet engine into an afterburner channel defined by an afterburner duct of an afterburner;
outputting fuel into the afterburner channel for mixing with the input gas from the turbine of the jet engine;
exciting a plurality of resonators electromagnetically coupled to at least one radio-frequency power source, each resonator having a resonant wavelength and including:
a first conductor,
a second conductor, and
a dielectric between the first conductor of that resonator and the second conductor of that resonator,
wherein a first resonator of the plurality of resonators further includes a fuel conduit having (1) a first fuel outlet that is configured to output fuel for mixing with the input gas from the turbine of the jet engine, and (2) at least a portion of the fuel conduit arranged proximate to the dielectric, and
in response to exciting each resonator of the plurality of resonators, providing within the afterburner at least one of electromagnetic waves or a plasma corona proximate to that resonator; and
outputting, from the afterburner channel, an exhaust gas resulting from combustion of the fuel within the afterburner channel.

30. The method of claim 29, wherein the plurality of resonators is arranged as at least one ring of resonators including a first ring of resonators.

31. The method of claim 29, further comprising:
providing, by at least one fuel pump, fuel from a fuel source through a fuel supply line fluidly coupled to the fuel conduit.

32. The method of claim 29, wherein providing at least one of the plasma corona or the electromagnetic waves includes providing the electromagnetic waves by exciting the resonator with a signal such that, as the fuel moves through the dielectric, the fuel is exposed to the electromagnetic waves.

33. The method of claim 29, wherein providing at least one of the plasma corona or the electromagnetic waves includes providing the plasma corona proximate to a distal end of the first conductor by exciting the resonator with a signal, and wherein outputting the fuel from the first fuel outlet of the fuel conduit includes outputting the fuel from the first fuel outlet of the fuel conduit toward the plasma corona.

34. The method of claim 29, wherein at least the portion of the fuel conduit is arranged along the dielectric.

35. The method of claim 29, wherein at least the portion of the fuel conduit is arranged within the dielectric.

36. The method of claim 29, wherein at least the portion of the fuel conduit is defined by a shape of the dielectric.

37. The method of claim 29, further comprising:
providing, by at least one direct-current power source, a respective bias signal between the first conductor and the second conductor of at least one resonator from a first resonator set, at least one resonator from a second resonator set, or a least one resonator from both the first resonator set and the second resonator set.

38. The method of claim 29, wherein exciting the plurality of resonators comprises exciting the plurality of resonators simultaneously so that each resonator of the plurality of resonators provides at least one of the electromagnetic waves or the plasma corona simultaneously.
